(19) United States
(12) Patent Application Publication
(10) Pub. No.: US 2024/0037322 A1
(43) Pub. Date: Feb. 1, 2024

(54) CUSTOMIZABLE DATA MANAGEMENT FORM BUILDER METHOD AND DEVICES

(71) Applicant: BINYAMIN TSABBA, ELYACHIN (IL)

(72) Inventor: BINYAMIN TSABBA, ELYACHIN (IL)

(21) Appl. No.: 18/379,580

(22) Filed: Oct. 12, 2023

Related U.S. Application Data
(63) Continuation-in-part of application No. 17/726,501, filed on Apr. 21, 2022.
Application No. 17/726,501 is a continuation of application No. 16/214,045, filed on Dec. 8, 2018, now abandoned.
(60) Provisional application No. 62/741,489, filed on Oct. 4, 2018.

(51) Int. Cl. G06F 40/14; G06F 3/0486; G06F 3/16; G10L 17/00

(52) U.S. Cl. CPC G06F 40/14; G06F 3/0486; G06F 3/167; G10L 17/00

(57) ABSTRACT

The embodiments disclose a method including providing a website interface within the customizable application builder with no code visualization tools for an application creation user, including a form builder for creating at least one form with at least one form element for receiving form input from an end user, each associated with a conditional rule builder, an auto portable document format mapping tool, a manual portable document format mapping tool and at least two dynamic portable document format mapping tools, wherein upon submission of the form, the auto portable document format mapping tool automatically generates a portable document format of the entire form, including the at least one form element and the form input from the end user and wherein the end user can interactively integrate the entire auto portable document format mapping tool automatically generated portable document format form into at least one 3rd party application platform and access data from all of the user's 3rd party application platform using the portable document format mapped elements.

### CROSS-REFERENCE TO RELATED APPLICATIONS

This patent application is a Continuation-in-part and claims priority to United States patent application entitled: “CUSTOMIZED CUSTOMER RELATIONSHIP MANAGEMENT PLATFORM METHOD AND DEVICES”, U.S. Ser. No. 17/726,501 filed on Apr. 21, 2022 filed by Binyamin Tsabba, which is continuation and claims priority to United States patent application entitled: “CUSTOMIZED CUSTOMER RELATIONSHIP MANAGEMENT PLATFORM METHOD AND DEVICES”, U.S. Ser. No. 16/214,045 filed on Dec. 8, 2018 filed by Binyamin Tsabba, the U.S. patent application being incorporated herein by reference, which is based on U.S. Provisional Patent Application Ser. No. 62/741,489 filed Oct. 4, 2018, entitled “CUSTOMIZED CUSTOMER RELATIONSHIP MANAGEMENT PLATFORM METHOD AND DEVICES”, by Binyamin Tsabba, the U.S. patent application being incorporated herein by reference.

### BACKGROUND

Methods and devices to create forms have been around for a while. Paper forms only provide a rudimentary way to gather data that must be manually processed into a useful management and personnel tool. The advent of the computer has elevated the manual task associated with form-gathered data to one or more automated systems. But what has been lacking is truly user-friendly systems that automate not just the data recovery and organization, but also expand the ease with which a user can interface with the devices and automated system to not only create a form but to gain more information from the form creation and responses that exist deeper in the content and context. The integration with other systems will assist a user in not having to duplicate the form creation task broaden the market for gathering data and reduce the time and effort to analyze the data into useful tools for management and customer relations.

### BRIEF DESCRIPTION OF THE DRAWINGS

FIG. 1 shows a block diagram of an overview of a customized customer relationship management platform method and devices of one embodiment.

FIG. 2 shows a block diagram of an overview flow chart of a customized customer relationship management platform method and devices of one embodiment.

FIG. 3 shows for illustrative purposes only an example of the flow of data in a customized customer relationship management platform method and devices of one embodiment.

FIG. 4 shows for illustrative purposes only an example of a form builder feature of one embodiment.

FIG. 5 shows for illustrative purposes only an example of a form builder uploading a user's existing portable document format form of one embodiment.

FIG. 6 shows for illustrative purposes only an example of drag and drop of the form builder elements over information locations on an existing user-scanned paper form of one embodiment.

FIG. 7 shows for illustrative purposes only an example of a form builder portable document format mapping menu of one embodiment.

FIG. 8 shows for illustrative purposes only an example of a form builder portable document format mapping dynamic mode basic elements of one embodiment.

FIG. 9 shows for illustrative purposes only an example of a form builder portable document format mapping dynamic mode basic text element of one embodiment.

FIG. 10 shows for illustrative purposes only an example of a form builder portable document format mapping dynamic mode basic input element of one embodiment.

FIG. 11 shows for illustrative purposes only an example of a form builder portable document format mapping dynamic mode basic multiple input of one embodiment.

FIG. 12 shows for illustrative purposes only an example of a form builder portable document format mapping dynamic mode contact of one embodiment.

FIG. 13 shows for illustrative purposes only an example of a form builder portable document format mapping dynamic mode date and time of one embodiment.

FIG. 14 shows for illustrative purposes only an example of a form builder portable document format mapping the dynamic mode range of one embodiment.

FIG. 15 shows for illustrative purposes only an example of a form builder portable document format mapping dynamic mode video of one embodiment.

FIG. 16 shows for illustrative purposes only an example of a form builder portable document format mapping dynamic mode privacy of one embodiment.

FIG. 17 shows for illustrative purposes only an example of a form builder portable document format mapping dynamic mode image group of one embodiment.

FIG. 18 shows a block diagram of an overview of a form builder portable document format mapping dynamic mode settings of one embodiment.

FIG. 19 shows a block diagram of an overview of a form builder portable document format mapping the dynamic mode of one embodiment.

FIG. 20 shows a block diagram of an overview of the integration of a form builder portable document format mapping CRM of one embodiment.

FIG. 21 shows a block diagram of an overview of the integration of a form builder file upload—allow accept of one embodiment.

FIG. 22 shows for illustrative purposes only an example of CRM push integration form builder portable document format mapping of one embodiment.

FIG. 23 shows for illustrative purposes only an example of a push settings tab of one embodiment.

FIG. 24 shows for illustrative purposes only an example of a push authentication list and status of one embodiment.

FIG. 25 shows for illustrative purposes only an example of push logs of one embodiment.

FIG. 26 shows for illustrative purposes only an example of a personalized preventive care and wellness plan of one embodiment.

FIG. 27 shows for illustrative purposes only an example of HIPAA, GDPR, and other compliances are supported of one embodiment.

FIG. 28 shows for illustrative purposes only an example of a portable document format mapping settings of one embodiment.

FIG. 29 shows for illustrative purposes only an example of a portable document format mapping settings general of one embodiment.

FIG. 30 shows for illustrative purposes only an example of a portable document format mapping settings buttons and labels of one embodiment.

FIG. 31 shows for illustrative purposes only an example of a portable document format mapping settings email of one embodiment.

FIG. 32 shows for illustrative purposes only an example of a portable document format mapping settings condition of one embodiment.

FIG. 33 shows for illustrative purposes only an example of a form builder optimization features of one embodiment.

FIG. 34 shows for illustrative purposes only an example of a form builder features characteristics of one embodiment.

FIG. 35 shows a block diagram of an overview of other user applications of one embodiment.

FIG. 36 shows a block diagram of an overview of other user applications enterprise environment of one embodiment.

FIG. 37A shows for illustrative purposes only an example of bi-directional voice command and interactive form-building elements of one embodiment.

FIG. 37B shows for illustrative purposes only an example of bi-directional voice command and interactive form-building data of one embodiment.

FIG. 38 shows for illustrative purposes only an example of bi-directional voice command and interactive information from forms of one embodiment.

FIG. 39 shows a block diagram of an overview of integration examples with CRM of one embodiment.

FIG. 40 shows for illustrative purposes only an example of integration CRM object settings of one embodiment.

FIG. 41 shows for illustrative purposes only an example of integration setting the CRM section of one embodiment.

FIG. 42 shows for illustrative purposes only an example of integration setting CRM fields of one embodiment.

FIG. 43A shows for illustrative purposes only an example of integration from CRM of one embodiment.

FIG. 43B shows for illustrative purposes only an example of integration map CRM fields of one embodiment.

FIG. 44 shows for illustrative purposes only an example of integration map CRM object settings of one embodiment.

FIG. 45 shows for illustrative purposes only an example of the integration CRM condition of one embodiment.

FIG. 46 shows for illustrative purposes only an example of integration CRM mapping corresponding fields of one embodiment.

FIG. 47 shows for illustrative purposes only an example of integration CRM mapping contact of one embodiment.

FIG. 48 shows for illustrative purposes only an example of integration CRM gets a contact of one embodiment.

FIG. 49 shows for illustrative purposes only an example of integration CRM email of one embodiment.

FIG. 50 shows for illustrative purposes only an example of a portable document format block condition elements of one embodiment.

FIG. 51 shows for illustrative purposes only an example of a portable document format block condition dynamic mode of one embodiment.

FIG. 52 shows for illustrative purposes only an example of a portable document format block condition portable document format settings of one embodiment.

FIG. 53 shows for illustrative purposes only an example of portable document format block condition mapping fields with all elements of one embodiment.

FIG. 54 shows for illustrative purposes only an example of a portable document format block condition mapping fields table of one embodiment.

FIG. 55 shows for illustrative purposes only an example of a portable document format block condition starting mapping fields of one embodiment.

FIG. 56 shows for illustrative purposes only an example of a portable document format block condition mapping field name of one embodiment.

FIG. 57 shows for illustrative purposes only an example of a portable document format block condition mapping fields of one embodiment.

FIG. 58 shows for illustrative purposes only an example of portable document format block condition mapping field selections of one embodiment.

FIG. 59 shows for illustrative purposes only an example of a portable document format block rule condition selection of one embodiment.

FIG. 60 shows for illustrative purposes only an example of portable document format block condition mapping field dynamic mode settings of one embodiment.

FIG. 61 shows for illustrative purposes only an example of a sentiment analysis feature of one embodiment.

FIG. 62 shows for illustrative purposes only an example of a heat map integration of one embodiment.

FIG. 63A shows for illustrative purposes only an example of integrating a form platform into a form builder of one embodiment.

FIG. 63B shows for illustrative purposes only an example of authenticating a form platform of one embodiment.

FIG. 63C shows for illustrative purposes only an example of choosing form fields data to push to form a platform of one embodiment.

FIG. 64 shows for illustrative purposes only an example of an event calendar feature of one embodiment.

FIG. 65 shows for illustrative purposes only an example of a publish form feature of one embodiment.

FIG. 66 shows for illustrative purposes only an example of a voice interactive calendar and geo locator of one embodiment.

FIG. 67 shows for illustrative purposes only an example of CRM lookup of one embodiment.

FIG. 68 shows for illustrative purposes only an example of an advanced table of one embodiment.

FIG. 69 shows for illustrative purposes only an example of mapping the CRM fields to a table element of one embodiment.

FIG. 70 shows for illustrative purposes only an example of adding the Smart V to a form of one embodiment.

FIG. 71 shows for illustrative purposes only an example of pushing the data to CRM using a custom button of one embodiment.

FIG. 72 shows for illustrative purposes only an example of setting CRM action for a custom button of one embodiment.

FIG. 73 shows for illustrative purposes only an example of an HL7 EHR cross-platform application of one embodiment.

FIG. 74 shows for illustrative purposes only an example of a dropdown2 form settings element of one embodiment.

### DETAILED DESCRIPTION OF THE INVENTION

In a following description, reference is made to the accompanying drawings, which form a part hereof, and in which are shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of customized customer relationship management platform method and devices are described for illustrative purposes and the underlying system can apply to any number and multiple types of application uses. In one embodiment of the present invention, the customized customer relationship management platform method and devices can be configured using a user's existing portable document format form to overlay interactive portable document format mapping elements to create an HTML, interactive portable document format form. The customized customer relationship management platform method and devices can be configured to include creating a new HTML interactive portable document format form using a dynamic portable document format mapping device and can be configured to include creating an HTML form using an auto portable document format mapping device. The customized customer relationship management platform method and devices can be configured to include integration of the HTML interactive portable document format form created with third-party customer relationship management and other types of platforms using the present invention.

“Customized customer relationship management platform method and devices”, “Customized customer relationship management platform”, “Customized customer relationship management”, and “Customized CRM platform” are terms used herein and can additionally be expressed without any change in meaning.

The phrase “form filler” herein means a user filling out entries in a customized customer relationship management form builder created form.

The present customized customer relationship management platform method and devices create a powerful cloud-based platform for creating online forms, applications, landing pages, and portals designed for any type of business ranging from small nonprofits to large enterprises. The customized customer relationship management platform method and devices offer smart integrations, conditional logic, document generation, payments, lead generation, and surveys as well as innovative bidirectional CRM and dynamic CRM integrations. Smart integrations, bidirectional CRM, and dynamic CRM integrations also include settings including auto-save/push, auto-pull, auto-translate, custom translate, and phone survey.

Auto save/push and auto pull selections, for example, when selected in the settings will automatically save the data entered in the customized form but also simultaneously in the CRM integrated system, for example, CRM without the user having to enter any additional commands. The auto function feature of push and pull will enter, delete, and edit any added or edited data automatically without the user having to enter any additional commands on both forms in both the present invention and the CRM integrated system including CRM using the bidirectional feature.

Auto translate and custom translate settings will allow the user to build the user's form in a selected language and an online form that needs to be displayed in several languages, can use the Auto Translate optimization to easily have it presented to foreign users in the user's native language. In some cases, a user may find the automatic translation insufficient or not precise enough for technical terms, or even simple words with multiple meanings and need to translate things manually. When using custom translate settings a user can control all the labels, captions, user tips, and button text in a form, and can create different translations to as many languages as desired. Other features used in translation include Custom Translation allowing Paragraph manual translation, and Translation for Table mandatory message—added to captions. HIPAA, GDPR, and other compliances are supported as well of one embodiment.

The phone survey feature allows a user to use account phone numbers from a simple table they have created that includes account phone numbers, for example, to map, for example, CRM country and State picklists of the account phone numbers. The mapped account phone numbers can then be used to conduct a phone survey on a user-selected service or product to determine the picklist accounts sentiments and opinions of the selected service or product of one embodiment.

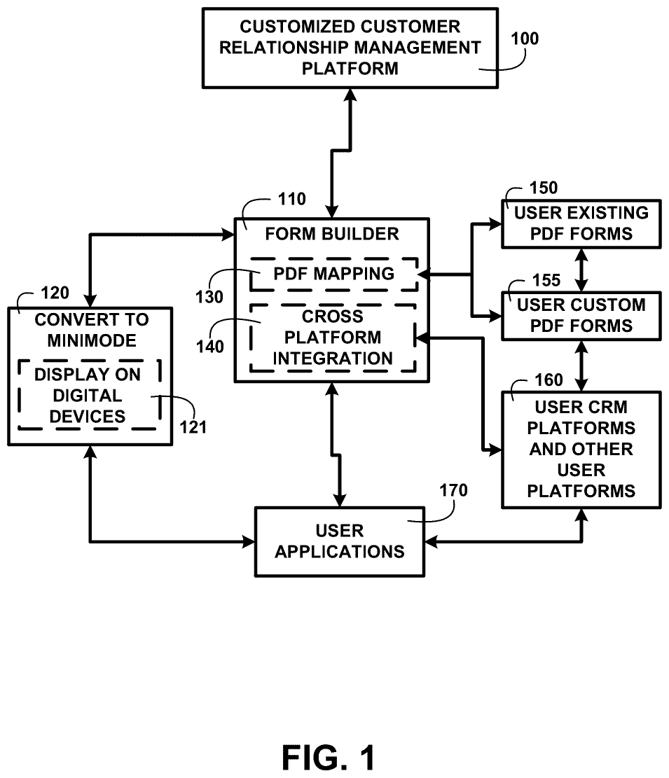

FIG. 1 shows a block diagram of an overview of a customized customer relationship management platform method and devices of one embodiment. FIG. 1 shows a customized customer relationship management platform 100. The customized customer relationship management platform method and devices is a user interface to create interactive portable document format forms for use with user applications 170. The interactive portable document format forms are created by a user without the use of coding using the features and elements of the customized customer relationship management platform method and devices to build forms that user clients and others can readily use to enter data that is accessible to the user.

Customized customer relationship management platform method and devices can integrate other platforms including customer relationship management (CRM) and other types of platforms to populate the other platforms with the customized customer relationship management platform method and devices created portable document format forms quickly and productively for applications. The customized customer relationship management platform 100 consists of features including a form builder 110 with portable document format mapping 130 and cross-platform integration 140. The customized customer relationship management platform 100 includes a digital process to convert to minimode 120 to display on digital devices 121. The customized customer relationship management platform 100 provides processes for a user to create interactive portable document format forms from the user's existing portable document format forms 150, create interactive user custom portable document format forms 155, and integrate user CRM platforms and other user platforms 160 into the customized customer relationship management platform 100 to facilitate the use for user applications 170 of one embodiment.

Access to the customized customer relationship management platform 100 can be customized to display without losing any functionality to a display on digital devices a user chooses with a feature to convert to minimode 120. The minimode feature is used to convert the function access to a size that fits the screen size of the user's digital device. The customized customer relationship management platform 100 includes several different types of forms or user activities that can be configured into a form format that can be created for use on a wide range of user applications 170.

The customized customer relationship management platform 100 includes several features including the Form Builder 100, Account features, Form optimization, Push Integrations, Form design, Data Collection, Data analysis, and others. The customized customer relationship management platform 100 includes function products, for example, for business including, portable document format Mapping 130, Targeting and Workflow, functions for Optimization including CRO, AB Testing, Auto Translate for multi-lingual conversions, and Online Chat and functions for customer relationship management (CRM) including, for example, CRM, Dynamic 365 and others. A user can use the Online Chat to get assistance and other help functions including Q&A for asking us questions is the fastest and most effective way to get assistance, FAQ for answers to commonly asked questions, TOPICS including a complete index of the Present invention's topics organized by categories, FEATURES for greater detail in the topics directory to find the feature being sought for and simply send in an inquiry of one embodiment.

FIG. 1 shows a customized customer relationship management platform 100. The customized customer relationship management platform 100 provides a website interface within the customizable application builder with no code visualization tools for an application creation user. The customized customer relationship management platform 100 website interface includes a form builder 110 feature for an application creation user to use for creating at least one form. The form builder 110 feature is one component of the no-code visualization tools forming the customized customer relationship management platform 100. The form builder 110 feature component with at least one form element for receiving form input from an end user, each associated with a conditional rule builder, an auto portable document format mapping tool, a manual portable document format mapping tool, and at least two dynamic portable document format mapping tools. Upon submission of the form by the end user, the auto portable document format mapping tool automatically generates a portable document format of the entire form, including the form element and the form input from the end user of one embodiment.

The manual portable document format mapping tool includes no code visualization tools that allow the application creation user to drag and drop form elements onto a predetermined portable document format template file, wherein upon submission of the form, the manual portable document format mapping tool automatically generates a customizable portable document format of the form that includes the customizable form elements with the form input from the end user. The dynamic portable document format mapping tool includes no code visualization tools that allow the application creation user to drag and drop form elements onto a blank HTML, template or edit the HTML of the blank HTML template. Upon submission of the form, the dynamic portable document format mapping tool dynamically generates a customizable portable document format of the form that includes the customizable form elements with the form input from the end user of one embodiment.

### Overview Flow Chart:

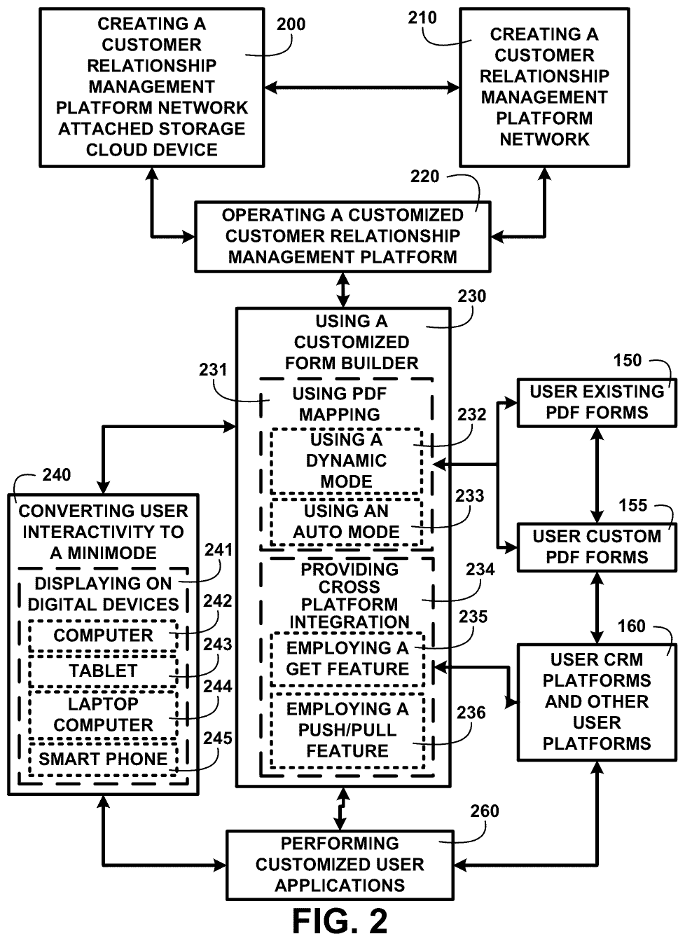

FIG. 2 shows a block diagram of an overview flow chart of a customized customer relationship management platform method and devices of one embodiment. FIG. 2 shows creating a customer relationship management platform network 210 and creating a customer relationship management platform network attached storage cloud device 200. Operating a customized customer relationship management platform 220 includes using a customized form builder 230 with features for using portable document format mapping 231, using a dynamic mode 232, and using an auto mode 233. Using a customized form builder 230 includes providing cross-platform integration 234 employing a get feature 235 and employing a push/pull feature 236. Converting user interactivity to a minimode 240 for displaying on digital devices 241 including a computer 242, a tablet 243, a laptop computer 244, and a smartphone 245. Using a customized form builder 230 includes creating interactive portable document format forms from user-existing portable document format forms 150 and user-custom portable document format forms 155. Using a customized form builder 230 includes integrating user CRM platforms and other user platforms 160 for performing customized user applications 260 of one embodiment.

FIG. 2 shows creating a customized customer relationship management platform network and creating a customized customer relationship management platform network attached storage cloud device. Operating a customized customer relationship management platform providing an interactive interface with the customized customer relationship management platform network and customized customer relationship management platform network attached storage cloud device.

Operating a customized customer relationship management platform includes using a customized form builder for using portable document format mapping to create custom responsive portable document format forms using a dynamic mode, using an auto mode, and converting a user's scanned existing paper form into a responsive portable document format form. The customized customer relationship management platform provides cross-platform integration employing a get feature and employing a push/pull feature to apply the form builder created forms on a user CRM platforms and other third-party platforms.

Operating a customized customer relationship management platform, a user may use many types of digital devices. The display screen for a computer is much larger than a screen on a smartphone. The customized customer relationship management platform includes a minimode feature for converting user interactivity to a minimode for displaying on digital devices including a computer, tablet, laptop computer, smartphone, or another digital device for users performing customized user applications conveniently. The customized customer relationship management platform network includes WI-FI and internet connectivity devices for communicating with various user digital devices. The customized customer relationship management platform network includes digital processors, digital servers, digital computers, digital sensors, digital analyzers, and other digitally controlled devices including wireless digital devices.

Other features of the Get elements include Category in Get Integration: Group by for aggregation, Option to Ignore Empty Conditions in Action Button—Get, property in Get—load pick list, and Show Get Integration errors in logs and other features including Sending integration log errors to an additional email, Add group label in Table Add/Edit/View modal windows, Custom labels for Lookup/Table reference, Integration Logs update, and Providing one month of Error log history of one embodiment.

### The Flow of Data in a Customized Customer Relationship Management Platform Method and Devices:

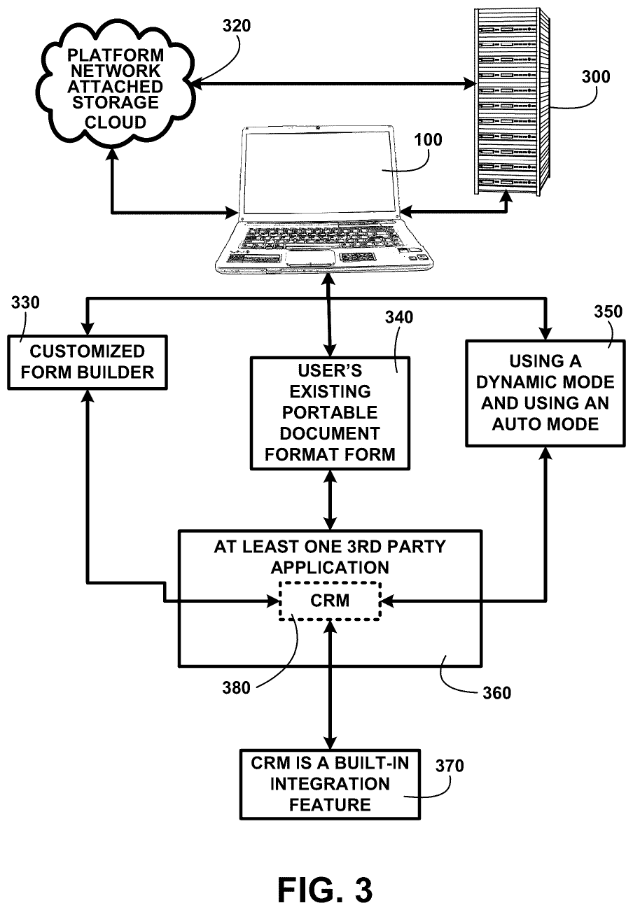

FIG. 3 shows for illustrative purposes only an example of the flow of data in a customized customer relationship management platform method and devices of one embodiment. FIG. 3 shows a customized customer relationship management platform network 300 including a network server. The customized customer relationship management platform 100 digital devices are interactively coupled to the customized customer relationship management platform network 300 network server and a platform network attached storage cloud 320 is also interactively coupled to the customized customer relationship management platform network 300 network server. The customized customer relationship management platform 100 digital device is used for operating a customized form builder 330 including portable document format mapping to convert existing paper forms into responsive digital portable document format forms 340 and creating new portable document format forms using a dynamic mode and using an auto mode 350. The customized form builder 330 includes at least one feature including a push data feature for cross-platform integration with at least one 3rd party application 360. At least one 3rd party application 360 includes customer relationship management (CRM) 380 integration with CRM get and CRM push wherein CRM is a built-in integration feature 370 of the customized form builder 330 of one embodiment.

FIG. 3 shows using a customized customer relationship management platform network to pass data between a customized customer relationship management platform network attached storage cloud device and a customized customer relationship management platform. Using the customized customer relationship management platform network attached storage cloud device for storing user-generated forms and customized integration and other feature data. Using the customized customer relationship management platform for interfacing with users and the customized customer relationship management platform network for using a customized form builder. The customized form builder is used by users for using portable document format mapping to convert existing paper forms into responsive digital portable document format forms, creating new forms using a dynamic mode and an auto mode. The customized customer relationship management platform also provides a push data feature for cross-platform integration with at least one 3rd party application a user may be already or planning to use. The customized customer relationship management platform provides a single source of form creation and gathering the response data from the responsive form they have created. A user can integrate Form Builder-created forms with a broad range of 3rd party applications including CRM 380 and others of one embodiment.

The customized customer relationship management platform consists of features that include elements. Those features include Form Builder with Main Operations, Form Elements including Basic Elements, Advanced Elements, Widgets Elements, and Element Settings; Form Properties with Settings and Style; Report Builder feature with Report main operations, Report elements including Basic Elements, Advanced Elements, and Widgets Elements; and Report settings. A My Submissions feature includes Main operations. Other features include My Forms, My Account, Account Billing, Security, and Sign in, working with the form builder and Form Embed. CRM is a built-in integration feature for this 3^{rd} party application and consists of elements including CRM Integration with CRM Get and CRM Push of one embodiment.

### Form Builder Feature:

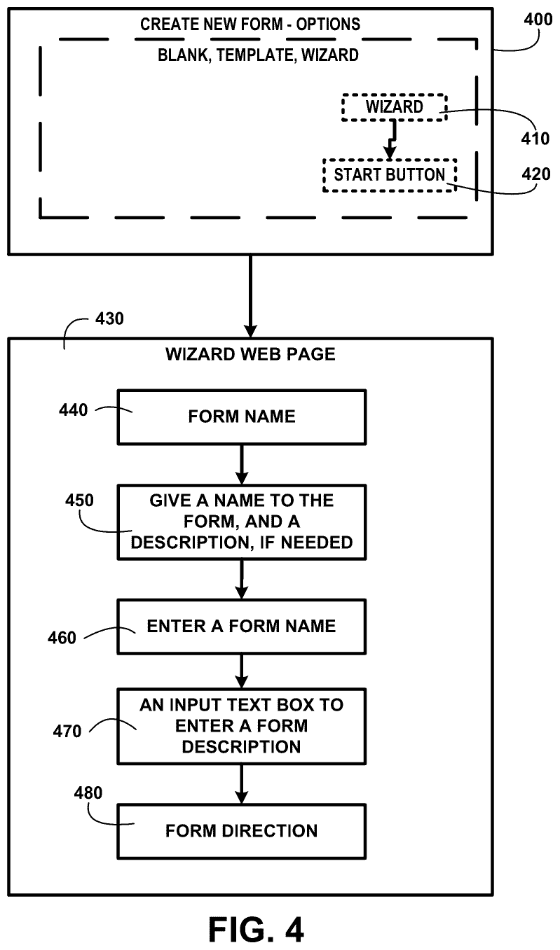

FIG. 4 shows for illustrative purposes only an example of a form builder feature of one embodiment. FIG. 4 shows a form builder feature to create a new form—options web page 400. FIG. 4 shows a blank, template, wizard 410, CRM, and from URL. The wizard is used to create a form in 4 easy steps 410 including 1. Form name, 2. Add Elements, 3. On Submit, and 4. Choose Theme. The wizard steps begin with a start button 420. Pressing the start button 420 takes the user to the form wizard web page 430. Step 1 enter a form name 440 includes an instruction to give a name to the form, and a description, if needed 450. The input text box to enter a form name 460 is displayed and the user can enter the form name they assign. An input text box to enter a form description 470 is an optional field. This description will appear under the form name as a descriptive introduction. A form direction check box for right to left 480 can be selected for languages that read from right to left of one embodiment.

FIG. 4 shows how, for example, to upload an image of a scanned paper form and place the submitted form values above it. This feature is available using basic portable document format mapping. A user can create an HTML layout and embed the field values in it. This option is also available using the dynamic portable document format mode. Creating a portable document format to look like a screenshot of the filled-in form can be done using an Auto-portable document format feature. Form Builder is a feature that allows a user to easily create powerful forms including elements and sub-features including Field types including Drag and Drop, Responsive, Form wizard, Form Import from URL, Field validations, Unique submissions, Form limits, Mandatory indications, Post submit Redirects, Automatic and custom emails, Element and form Conditional Logic, Save and Resume, Social Autofill, CAPTCHA, Security Seal, Digital Signature, Custom “Thank You” message, portable document format Mapping, Multi-page Form, Valid/Error Indicators, Image Masking Backgrounds, Value Rules, Repeated Section, Field Mask, Advanced Values including in a calculated string mode, DropDown with Hierarchy, Workflow Editor CRM Form in one click, Payment Integration, Multiple Selection DropDown, Export the form to another account, Custom Translation, Value Rule with REGEX Validation, Bi-Directional CRM Integration, Resubmitting entries back to CRM and other 3rd party integrations, Form Rules, CRM Table Element, CRM Visual Composer Targeting, Allow later editing, Calculated Field, CDN Cache, The Section Element, Collapsible Section, Effected by, Using the Dynamic portable document format Mapping, Ignore Mandatory Validation, Address Validation, Auto Submit The Form, Base a Google map on an address, Version Control feature, portable document format Re Generation, Custom mail server, Geo Localization, On Completion Script in Button, Auto portable document format, adding a widget to a form, the CRM chart, File Upload—Allow Capture, File Upload—Allow Accept, portable document format Conditions, Section Repeat with mapped data, portable document format Mapping Conditions, portable document format Page conditions, portable document format Block condition, and Voice Control of one embodiment.

Other conditions and conditional rules include conditional results for the HREF element: set value and set value from, Set a CSS class to an element by condition, Allow/Disable condition result options for Checkbox and Radio button, filter in condition window, Adding conditions to portable document format mapping, Filtering data in Get condition based on an integer, Friendly condition, Friendly condition and brackets added to value rule, Functions added to Field condition results, Is empty condition added in Numeric and Price, condition result options: Read-only and Read Write, Opposite rule in condition, Optimization for loading times, loading times, CDN cache, conditional logic engine, portable document format conditions—If block, Reset radio option in condition results, Show/Hide section tabs via condition, Supporting Boolean conditions, and Supporting special characters in condition of one embodiment.

Other features include feature: voice control, features to Advanced Tools, features to Google Sheets Export, feature for multi-page forms: Progress indicator, feature: Auto Submit, Version Control feature, Lock elements in form builder, Hotkeys in form builder for Mac, and Showing validation indicators on form builder canvas of one embodiment.

The present invention offers all the elements to create a landing page or online form: Input elements, graphic elements, special elements, and widgets. They are all located in the left “Elements” panel and divided into 3 categories: Basic, Advanced, and Widgets. Basic elements include Section, Image, Button, Line, Label, Paragraph, HREF, Heading, Bullet, Textbox, Numeric, Text area, Email, URL, File Upload, Dropdown, Radio, and Checkbox. Advanced elements include Address, Full Name, Date and time, Date, Time, Phone, Price, Star Rating, and Likert. Widgets are elements that include YouTube, Vimeo, Seal, Privacy, Signature, Social Filler, ImageBlock, ImageSlider, HTML, Google Map, Calculated, Hidden, and Page Break of one embodiment.

### Form Builder Uploading a User's Existing Portable Document Format Form:

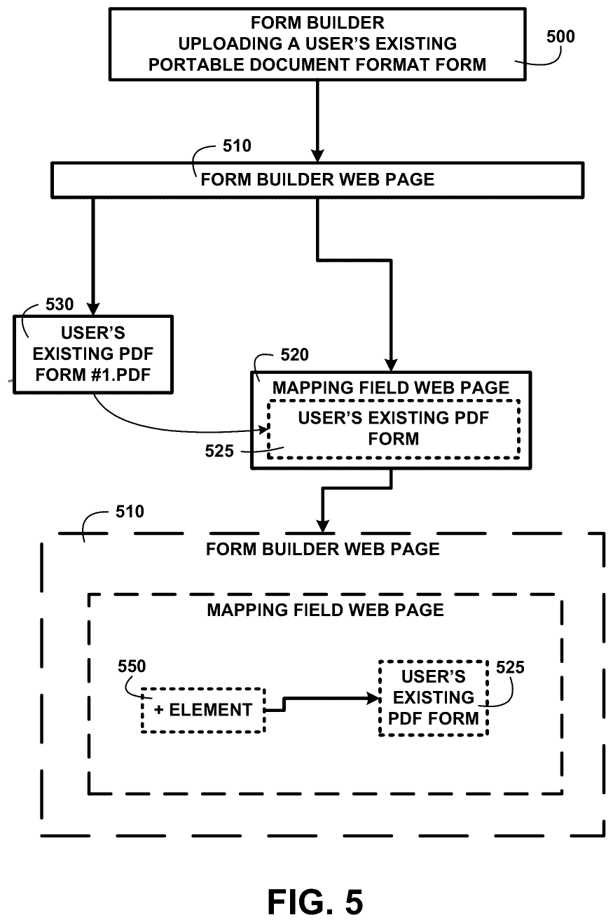

FIG. 5 shows for illustrative purposes only an example of a form builder uploading a user's existing portable document format form of one embodiment. FIG. 5 shows the form builder uploading a user's existing portable document format form 500. A listing of user-existing portable document format forms is displayed for the selection of an existing portable document format form. The user selects the user's existing portable document format form #1. portable document format 530 from the listing. The uploaded user's existing portable document format form 525 is displayed on a form builder web page 510 that includes in a header section a mapping field web page 520. The user can then open an Elements 550 tab to make element selections to integrate into the user's existing portable document format form 525 of one embodiment.

FIG. 5 shows how to easily convert a paper form into a responsive form and automatically output online form entries into the paper form. Many financial, insurance, and legal services still rely on paper forms, which must be downloaded, printed, manually filled in, and sent back via fax. This is an inefficient, inconvenient, time-consuming process that leads to negative customer impressions and consequently also to low conversion. The present invention allows a user to bypass these shortcomings by collecting the data using an online form, and still receiving it as a portable document format in the original layout.

### Drag and Drop the Form Builder Elements Over Info Locations on an Existing User-Scanned Paper Form:

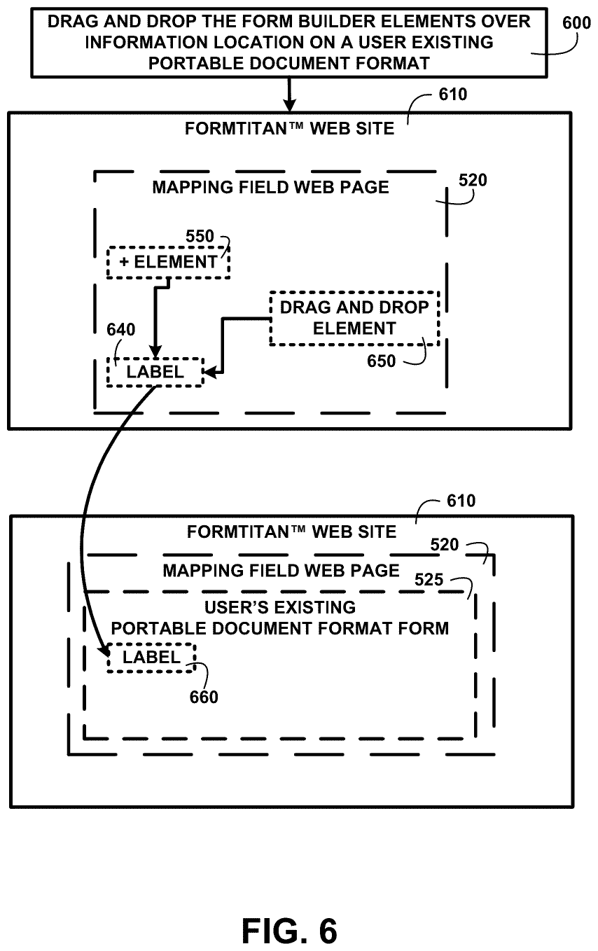

FIG. 6 shows for illustrative purposes only an example of drag-and-drop form builder elements over information locations on an existing user-scanned paper form of one embodiment. FIG. 6 shows the drag and drop of the form builder elements over information location on a user's existing portable document format 600. The mapping field web page 520 is displayed from a website 610. The Elements 550 includes a drop-down elements menu including a label selection. A user drags the label element to the user's existing portable document format form 525. A drag-and-drop element 650, for example, a label element 660, is positioned on a user's existing portable document format form and is entered in the mapping fields web page 520 of one embodiment.

FIG. 6 shows how to build an online version of a scanned form using the form builder. Portable document format Mapping allows a user to 1—upload a portable document format and use it as the background to an online portable document format form. 2—Select the form fields from the Element Dropdown (one by one) and place them where the value appears.

The drag & drop feature “involves moving the cursor over an object, selecting it, and moving it to a new location”. The form builder is a WYSIWYG tool, and it is easy to use. It allows a user to create landing pages and forms intuitively by dragging elements from the “Elements” panel on the left and dropping them on the canvas. The elements may be placed anywhere since the layout is completely flexible. DropDown with Hierarchy. The present invention provides a “Dropdown” element a user can add to the user form. With this element, the form filler can input data in a form by choosing from a list of options. Customized CRM platform, however, provides two types of dropdowns: a regular Dropdown called “simple”, and a dropdown with a few levels called “Tree” (which is a Dropdown with Hierarchy).

### A Form Builder Portable Document Format Mapping Menu:

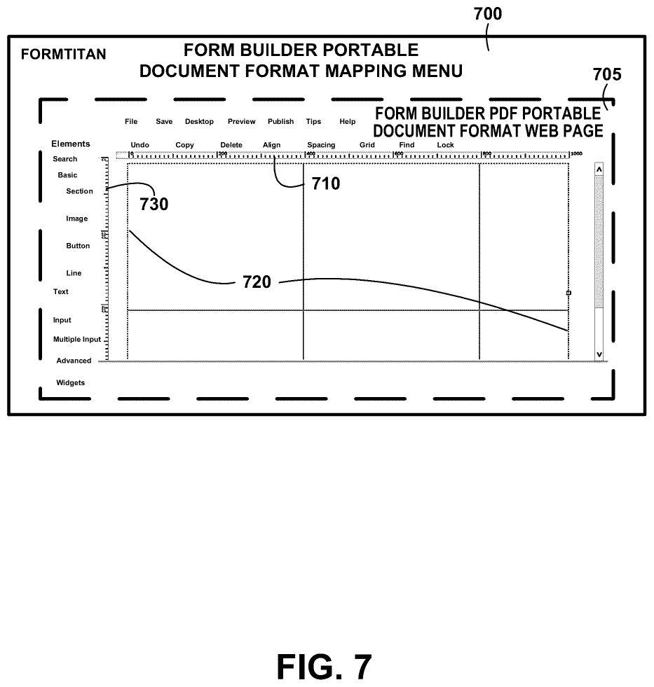

FIG. 7 shows for illustrative purposes only an example of a form builder portable document format mapping menu of one embodiment. FIG. 7 shows a form builder portable document format mapping menu 700 on a form builder portable document format web page 705. The portable document format mapping menu 700 includes a form builder portable document format grid layout page 720 that includes a horizontal ruler 710 and a vertical ruler 730 of one embodiment.

FIG. 7 shows a form builder portable document format mapping menu including a file dropdown, save, desktop dropdown, preview, publish, tips, and help. Using the Dynamic portable document format Mapping starts by using the advanced portable document format Mode. Paper forms have been around for a long time. Today many forms have gone online, however, there are still services that rely on paper forms (like law offices, insurance companies, etc.). The problem with paper forms is that they slow things down, they require downloading, printing, filling in manually, and sending by fax. This becomes a hassle since many users do not have a printer or a fax. In addition, filling in forms by hand can get tiresome when required to fill in the same fields repeatedly (like name or signature).

Furthermore, companies that need to digitally store the data that was collected with paper forms now must deal with a heavier workload that includes scanning the forms, typing in the data, etc. This is exactly why The present invention developed this feature: portable document format mapping. A portable document format (Paper Form) Mapping feature allows a user to collect the user data using a responsive online form, and then have a portable document format document generated based on the entry, with the data in it. This portable document format can be sent to the Form Builder creator user, the form owner, to the assigned form fillers and it can be pushed to, for example, CRM. This is a win-win situation where the data is entered and stored digitally as well as generated into a portable document format document in the traditional old way.

The present invention provides 3 types of portable document format mapping: 1—A basic portable document format mapping where a user uploads a background, and places form elements above it, for example, using basic portable document format Mapping. 2—A Dynamic portable document format where the user creates the layout using an editor and HTML code. 3—An auto-portable document format where the system creates the portable document format by capturing an image of the filled-in form (for example, a screenshot) of one embodiment.

Other mapping features include Conditional Logic in the portable document format Mapping, Mapping only reference fields in a user created Table, portable document format Mapping: Auto portable document format, portable document format Mapping Additions, portable document format Mapping file name and barcode, Removing auto margin in Dynamic portable document format Mapping, Vertical Align Added to Elements in portable document format Mapping, Adding conditions to portable document format mapping, Push mapping Condition, Conditional mapping in Repeated and Files, Else added to the Conditional mapping, My submissions filter by portable document format mapping, portable document format mapping—categories, portable document format mapping generated after custom Push, Submission ID in mapping of nested child, and Using the Short State name in Address mapping of one embodiment.

### Advanced Portable Document Format Mapping Dynamic Mode:

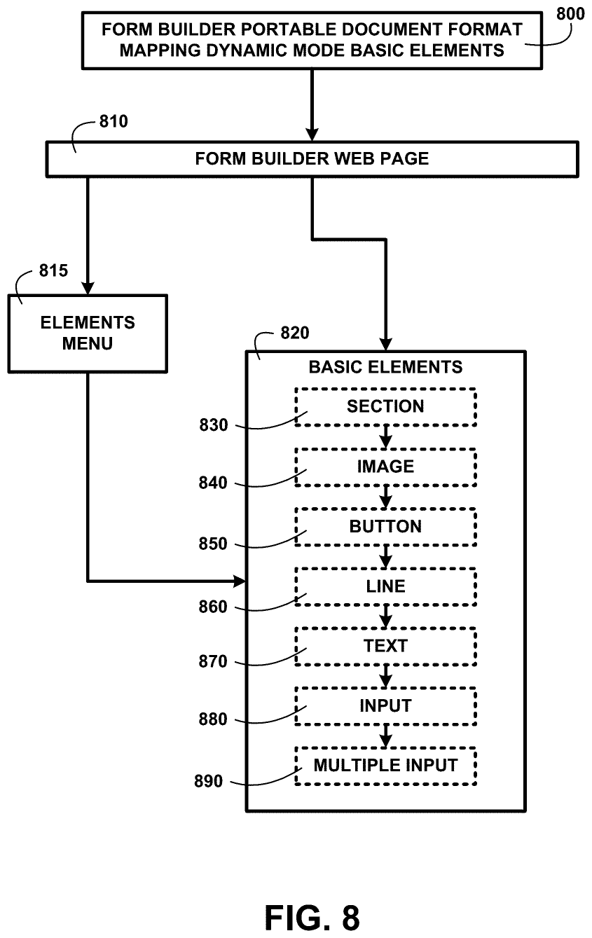

FIGS. 8-19 show features of the Advanced portable document format mapping Dynamic mode including elements. FIG. 8 shows for illustrative purposes only an example of a form builder portable document format mapping dynamic mode basic elements of one embodiment. FIG. 8 shows form builder portable document format mapping dynamic mode basic elements 800 on a form builder portable document format mapping dynamic mode basic elements menu and grid layout web page 810. An elements menu 815 includes basic elements 820. The basic elements 820 menu includes section 830, image 840, button 850, line 860, text 870, input 880, and multiple input 890 of one embodiment.

FIG. 8 shows when adding portable document format Mapping to a form the standard editor opens, allowing a user to easily create a portable document format by uploading a user document, and then placing form fields above it. It is really simple to do. However, for users who do not want to create a portable document format this way a Dynamic Mode is available. In Dynamic Mode the editor will change, allowing a user to insert HTML code, adjust styling, and even use a table element for displaying repeated section items dynamically. For example: 1—Create a new blank form; 2—Move the submit button down—so it is located after the section; 3—Drag a few elements onto the canvas. Other Dynamic mode features include Dynamic portable document format Mode, Dynamic portable document format Background image, Page order in Dynamic portable document format, Remove auto margin in Dynamic portable document format Mapping, and Setting a Dynamic reply to of one embodiment.

### Form Builder Portable Document Format Mapping Dynamic Mode Basic Text Element:

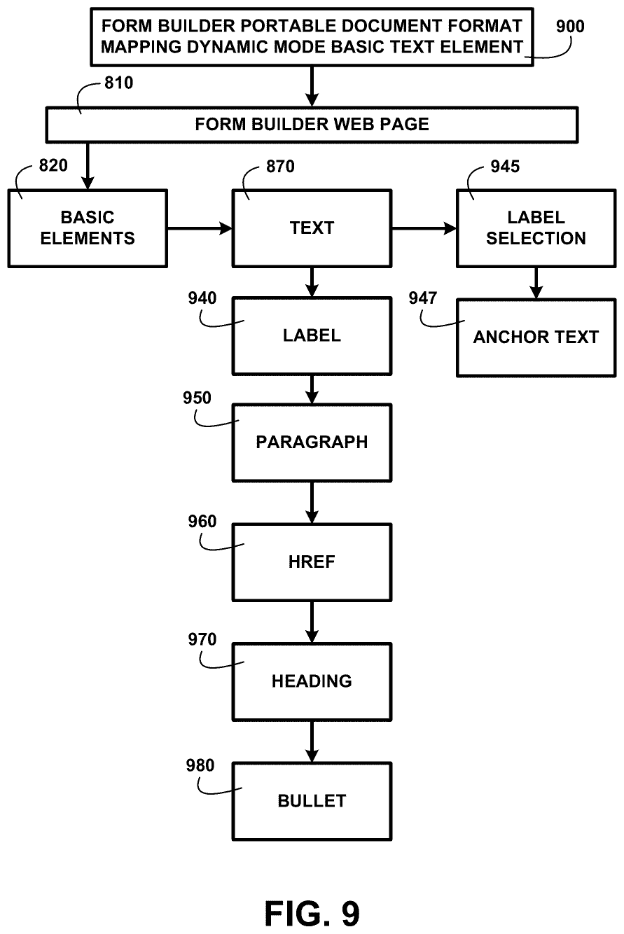

FIG. 9 shows for illustrative purposes only an example of a form builder portable document format mapping dynamic mode basic text element of one embodiment. FIG. 9 shows, for example, a form builder portable document format mapping dynamic mode basic text element 900 for the selection of a sub-element to be positioned on the form builder portable document format mapping dynamic mode basic elements menu and grid layout web page 810. A user makes a selection from the basic elements 820 in this example text 870. The text 870 includes a sub-menu that includes Label 940, Paragraph 950, HREF 960, Heading 970, and Bullet 980. In this example, a user makes a label selection 945 to position the label text box as an anchor text 947 on the grid layout of one embodiment.

### Form Builder Portable Document Format Mapping Dynamic Mode Basic Input Element:

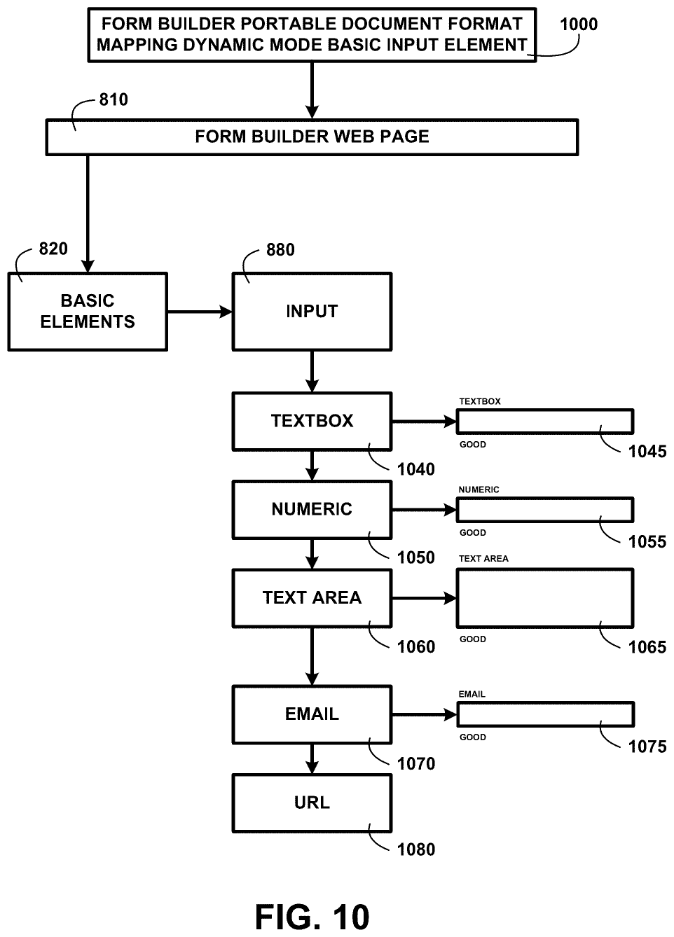

FIG. 10 shows for illustrative purposes only an example of a form builder portable document format mapping dynamic mode basic input element of one embodiment. FIG. 10 shows a form builder portable document format mapping dynamic mode basic input element 1000 on the form builder portable document format mapping dynamic mode basic elements menu and grid layout web page 810 basic elements 820 menu. The input 880 menu selection by the user displays a sub-menu that includes selections that contain a Textbox 1040, Numeric 1050, Text Area 1060, Email 1070, and URL 1080. The user can, for example, make selections and place them on the grid layout including a positioned textbox 1045, positioned numeric box 1055, positioned text area box 1065, and positioned email box 1075 of one embodiment.

Other elements include label to Section element, default state of the element to Disabled, Custom subject in the Email element, Hover and Selected effects in elements, Infinite scroll in the Section element, element for CRM: Chart, element: HTML Editor, target options in the HREF element, Positioning elements with Intelligent Drop, Set Value From—added to radio and dropdown elements, Size per page in page break element, and Styles for buttons in Table element including alignment of one embodiment.

### Form Builder Portable Document Format Mapping Dynamic Mode Basic Multiple Input:

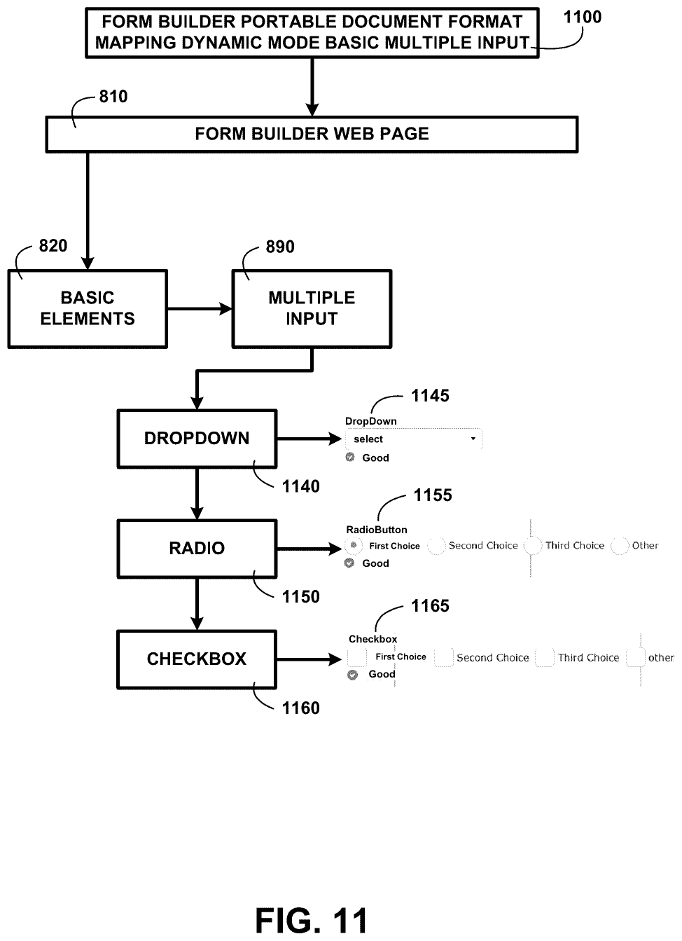

FIG. 11 shows for illustrative purposes only an example of a form builder portable document format mapping dynamic mode basic multiple input of one embodiment. FIG. 11 shows a form builder portable document format mapping dynamic mode basic multiple input 1100 displayed on the form builder portable document format mapping dynamic mode basic elements menu and grid layout web page 810. The user can select from the basic elements 820 menu the multiple input 890. The multiple input 890 selection displays a sub-menu that includes a dropdown 1140, radio 1150, and checkbox 1160 selection. A user can, for example, place a positioned dropdown selection box 1145 on the grid layout. The user can, for example, place a positioned radio button including first choice, second choice, third choice, and other 1155 on the grid layout. The user can, for example, place a positioned checkbox including first choice, second choice, third choice, and other 1165. FIG. 11 shows 4-Select the section and go to: “Properties” panel>“Element” tab>“Settings” option>“Basic” category of one embodiment. FIG. 11 shows for illustrative purposes only an example of a form builder portable document format mapping dynamic mode basic multiple input of one embodiment. FIG. 11 shows turn on the “Repeated” option. This will allow the form filler to add a button and enter multiple items instead of just one. Save the form of one embodiment.

### Form Builder Portable Document Format Mapping Dynamic Mode Contact:

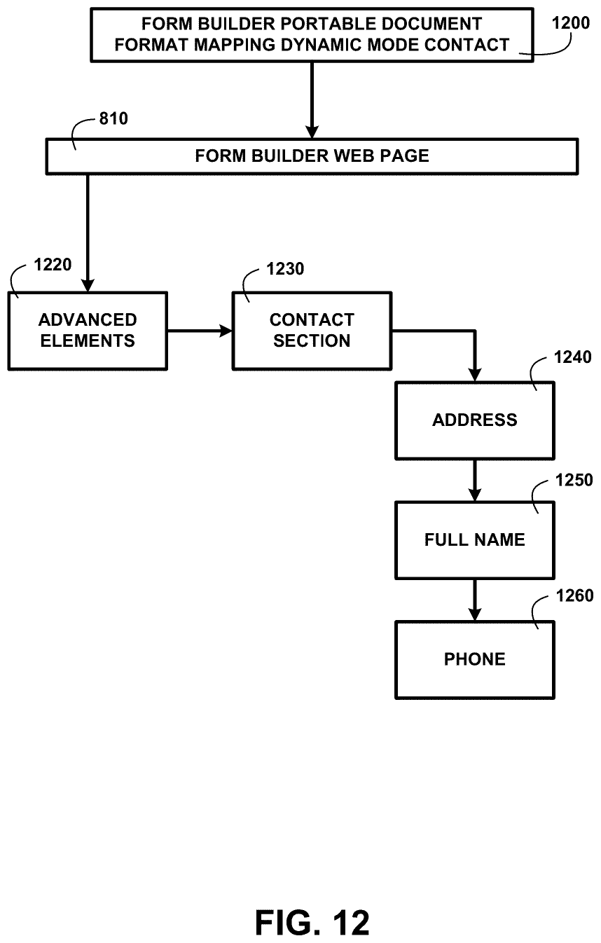

FIG. 12 shows for illustrative purposes only an example of a form builder portable document format mapping dynamic mode contact of one embodiment. FIG. 12 shows a form builder portable document format mapping dynamic mode advanced contact 1200 selection for the user to incorporate into the custom portable document format form. The form builder portable document format mapping dynamic mode an advanced elements menu and grid layout web page 810 includes advanced 1220 elements for a user to create a contact 1230 section. The contact 1230 section sub-menu includes address 1240, full name 1250, and phone 1260 selections of one embodiment.

### Form Builder Portable Document Format Mapping Dynamic Mode Date and Time:

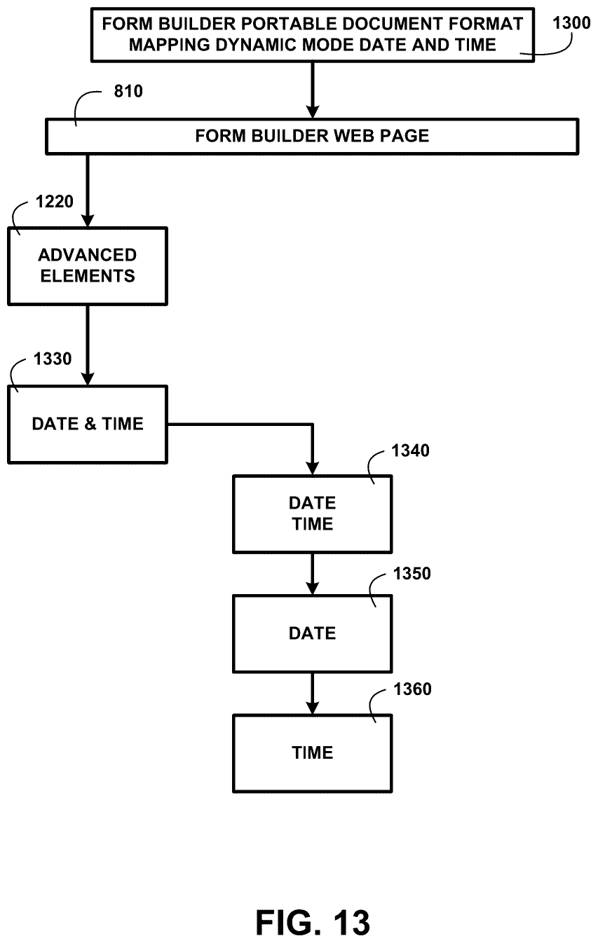

FIG. 13 shows for illustrative purposes only an example of a form builder portable document format mapping dynamic mode date and time of one embodiment. FIG. 13 shows a form builder portable document format mapping dynamic mode advanced date and time 1300 selection for the user to incorporate into the custom portable document format form. The form builder portable document format mapping dynamic mode an advanced elements menu and grid layout web page 810 includes advanced 1220 elements for a user to create a date & time 1330 section. The date & time 1330 selection includes sub-menu selections including datetime 1340, date 1350, and time 1360 of one embodiment.

### Form Builder Portable Document Format Mapping Dynamic Mode Range:

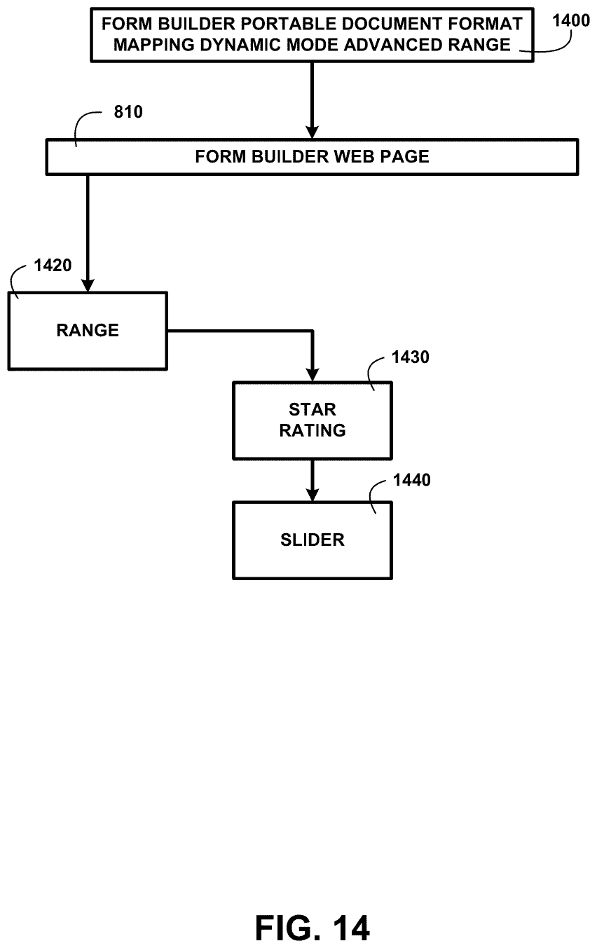

FIG. 14 shows for illustrative purposes only an example of a form builder portable document format mapping the dynamic mode range of one embodiment. FIG. 14 shows the form builder portable document format mapping dynamic mode advanced range 1400 section on the form builder portable document format mapping dynamic mode advanced elements menu and grid layout web page 810. The range 1420 selection includes a sub-menu including a star rating 1430 and a slider 1440 elements of one embodiment.

### Form Builder Portable Document Format Mapping Dynamic Mode Video:

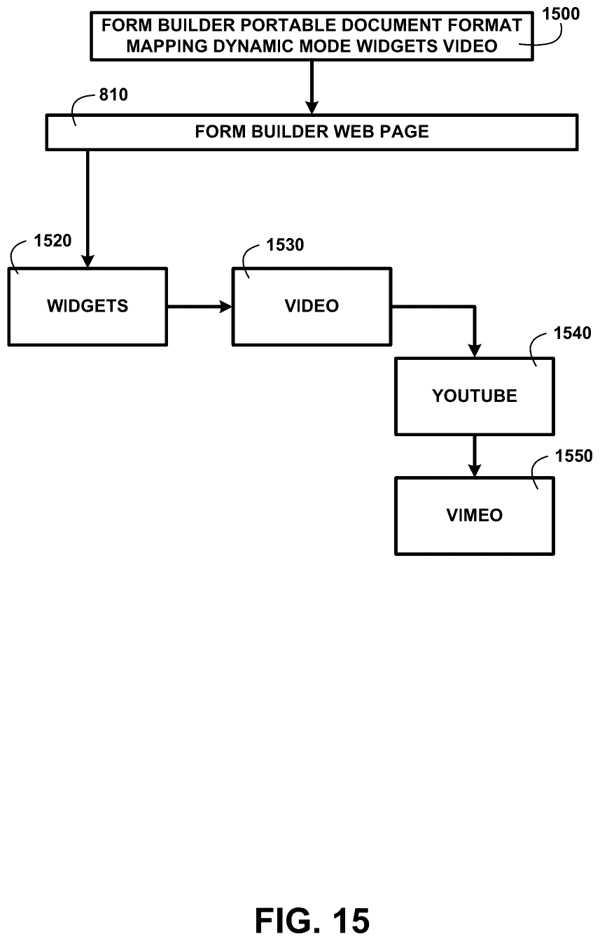

FIG. 15 shows for illustrative purposes only an example of a form builder portable document format mapping dynamic mode video of one embodiment. FIG. 15 shows the form builder portable document format mapping dynamic mode widgets video 1500 elements menu and grid layout web page 810. The form builder portable document format mapping dynamic mode widgets elements menu includes a video 1500 section. The widgets 1520 video 1530 selection includes a sub-menu including YouTube 1540 and Vimeo 1550 of one embodiment.

### Form Builder Portable Document Format Mapping Dynamic Mode Privacy:

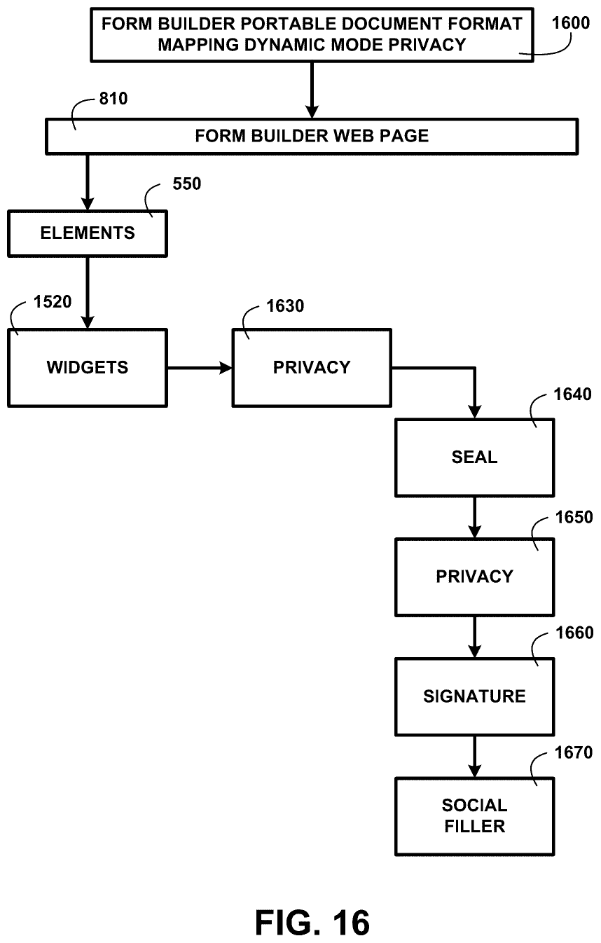

FIG. 16 shows for illustrative purposes only an example of a form builder portable document format mapping dynamic mode privacy of one embodiment. FIG. 16 shows the form builder portable document format mapping dynamic mode privacy 1600 elements menu and grid layout web page 810. The Elements 550 includes in the widgets 1520 a privacy 1630 selection. The privacy 1630 selection includes a sub-menu Seal 1640, Privacy 1650, Signature 1660, and Social Filler 1670 selections of one embodiment.

### Form Builder Portable Document Format Mapping Dynamic Mode Image Group:

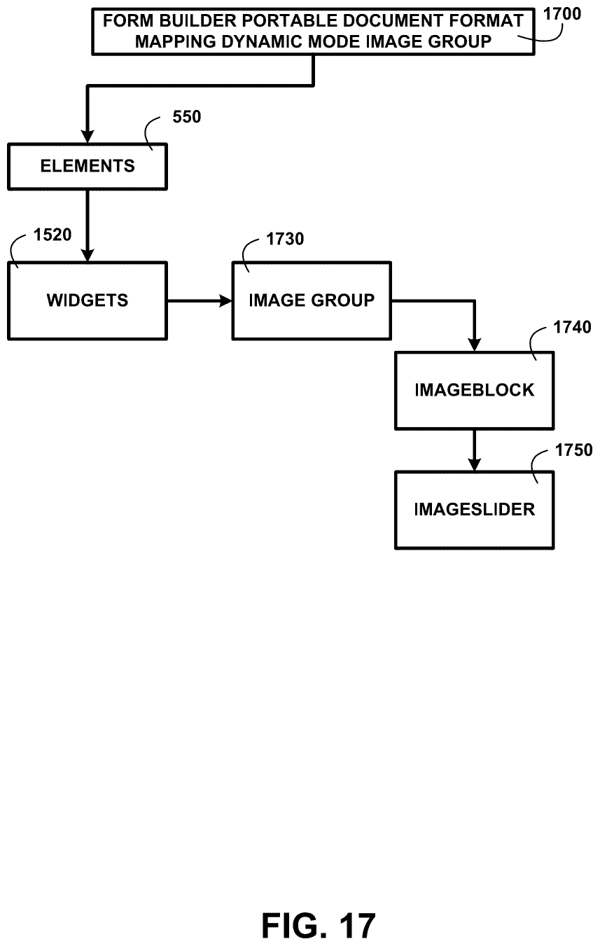

FIG. 17 shows for illustrative purposes only an example of a form builder portable document format mapping dynamic mode image group of one embodiment. FIG. 17 shows a form builder portable document format mapping dynamic mode image group 1700. In the elements 550 widgets 1520 selections is an image group 1730 that includes in a sub-menu an Imageblock 1740 and Imageslider 1750 for selection by a user of one embodiment.

### Form Builder Portable Document Format Mapping Dynamic Mode Settings:

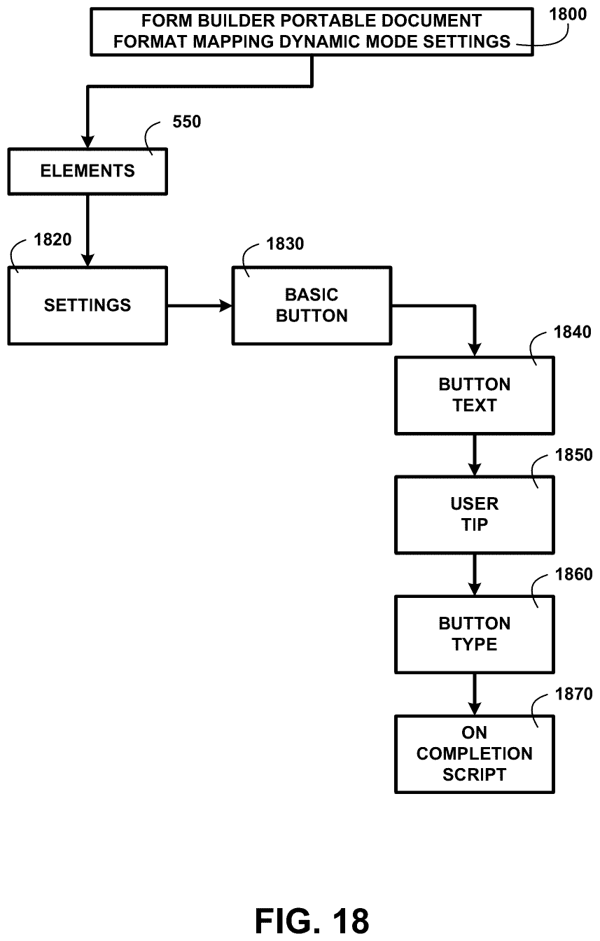

FIG. 18 shows a block diagram of an overview of a form builder portable document format mapping dynamic mode settings of one embodiment. FIG. 18 shows form builder portable document format mapping dynamic mode settings 1800 elements 550. Under settings (fld1) 1820 is a basic (button) 1830 selection that includes user selections including button text: 1840, user tip: 1850, button type 1860, and on completion script 1870 selections of one embodiment.

Other features are used for portable document format mapping and handling including Adding pages to dynamic portable document format, Charts in Auto portable document format, Conditional Logic in the portable document format Mapping, Generate portable document format for all entries in my submission, Maximizing the portable document format preview window, Merge attachment and files from CRM into portable document format, My submissions filter by portable document format mapping, page break inside new portable document format, portable document format Auto preview, portable document format generated upon payment, portable document format generated upon payment, portable document format Interactive mode, portable document format kerning works with Interactive mode, portable document format mapping—categories, portable document format Mapping Additions, portable document format Mapping file name and barcode, portable document format mapping generated after custom Push, portable document format Mapping: Auto portable document format, portable document format sent to email upon payment, portable document format supports letter format, Private content in portable document format—Do not include in preview, Processing message for download portable document format/auto portable document format/file upload in my submissions, Push Signature to CRM as attachment without portable document format Mapping, CRM action Override mode for auto portable document format, Vertical Align Added to Elements in portable document format Mapping, and View manual/auto portable document format information of one embodiment.

### Form Builder Portable Document Format Mapping Dynamic Mode:

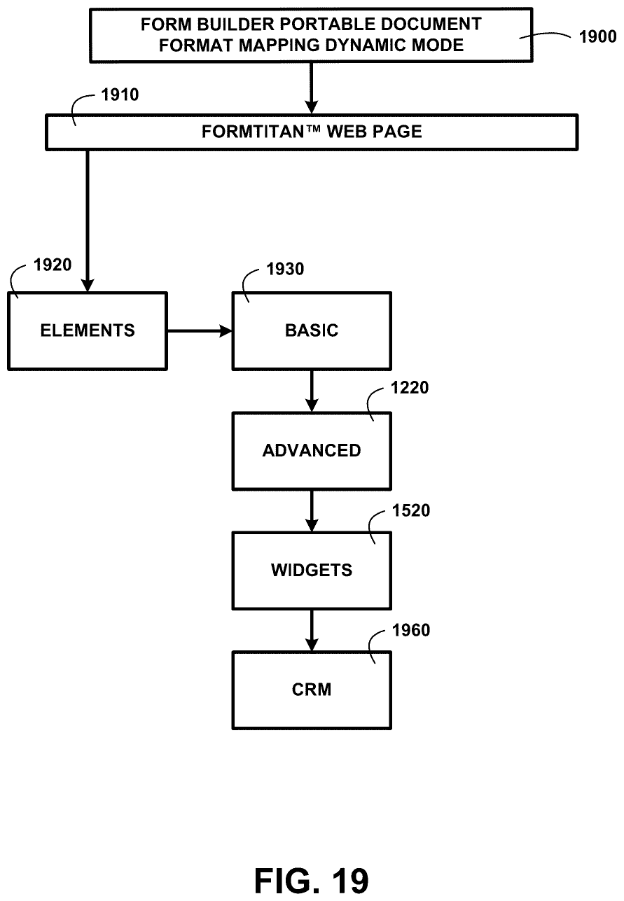

FIG. 19 shows a block diagram of an overview of a form builder portable document format mapping the dynamic mode of one embodiment. FIG. 19 shows a form builder portable document format mapping dynamic mode 1900 on a webpage 1910 that includes an elements selection menu 1920 including basic 1930, advanced 1220, widgets 1520, and CRM 1960 of one embodiment.

The portable document format will have default margins on all sides, if a user wants to remove them the user can turn on the ‘Remove auto margin’ checkbox. If a user wants to add customized margins, the user can do this in the HTML source of the portable document format. Dynamic portable document format Mode is designed for users who are using or intend on using the portable document format Mapping. Dynamic portable document format Mode is a portable document format Mapping feature that allows a user to use HTML code to create a user-portable document format, work with styles, and add a dynamic table that is populated from a repeated section in the form. The dynamic portable document format mode provides an editor for creating a portable document format. Enter the user text or insert existing user HTML code. The user can then use the editor options to set the styles and the user can now insert a table to this portable document format and map it to a repeated section.

Page Break Inside Dynamic portable document format, the dynamic portable document format has an editor that allows a user to create a portable document format using HTML, styles, etc., including creating a multi-page portable document format. A multi-page portable document format can be created in both the regular portable document format mode and the Dynamic mode. A user can insert a page break into a portable document format in the editor. Each time a Page break is inserted it will display horizontal lines where the break should be.

Adding a widget to a form. A user can add a widget/chart or any kind of external logic into a form. An external widget can interact with form fields, whether the form is filled manually by users or populated from CRM. The “Digital Signature” is an element a user can add to an online form when the user needs a form filler to sign for identification and Consent, for example: in a legal document, agreements, order forms, etc. The form owner may not want the form filler to enter data in the form. The form owner wants to auto-populate the fields and have the form automatically submitted. To do this the form user can select an “Auto Submit” feature.

### Integration Form Builder Portable Document Format Mapping CRM:

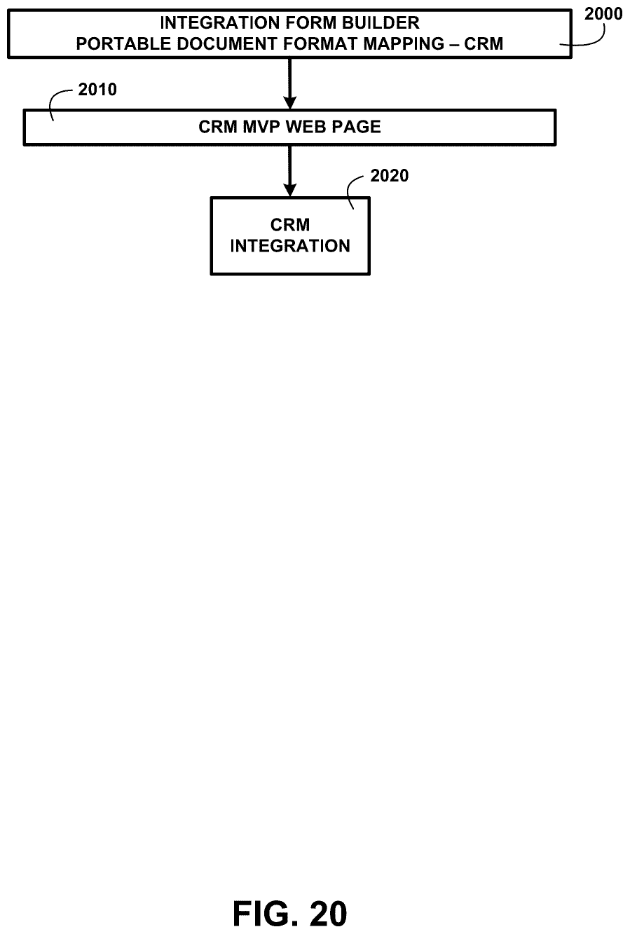

FIG. 20 shows a block diagram of an overview of integration form builder portable document format mapping CRM of one embodiment. FIG. 20 shows an integration form builder portable document format mapping—CRM 2000. Integration is made in the CRM MVP web page 2010. The integration form builder portable document format mapping is used for CRM integration 2020 into a user's forms. Each Get action performed on a CRM object will be represented in one integration line, so if a user wants multiple objects being read the user will need to create an integration line for each. The first time a user opens this window—the form will have no lines and a user will need to press the “Add object” button to create the first integration line.

### Integration Form Builder File Upload—Allow Accept:

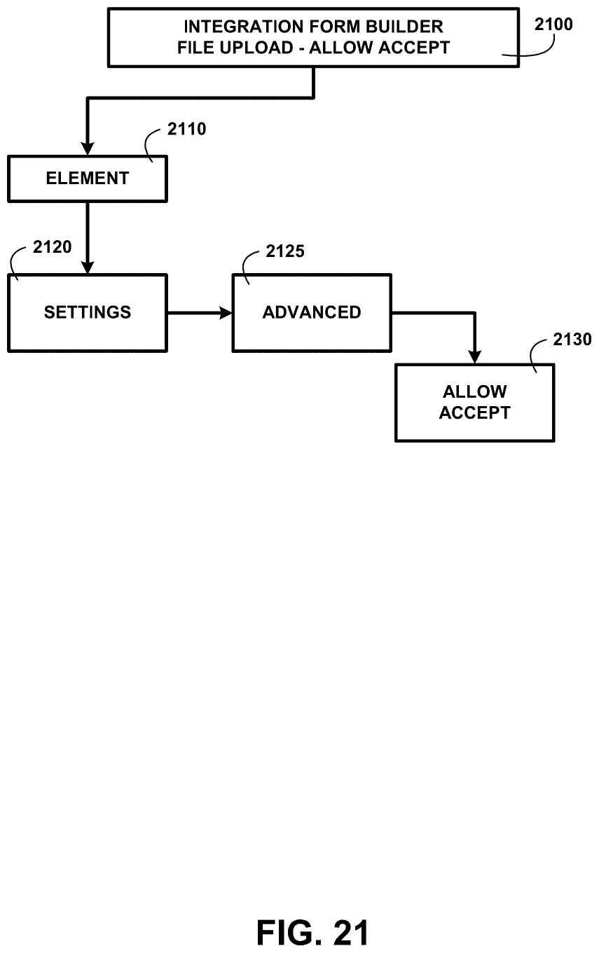

FIG. 21 shows a block diagram of an overview of integration form builder file upload—allow accept of one embodiment. FIG. 21 shows an integration form builder file upload—allow accept 2100 element 2110 for settings (fld2) 2120. The advanced 2125 element includes the allow accept 2130 of a file upload by a user of one embodiment.

### Box Push Integration Form Builder Portable Document Format Mapping:

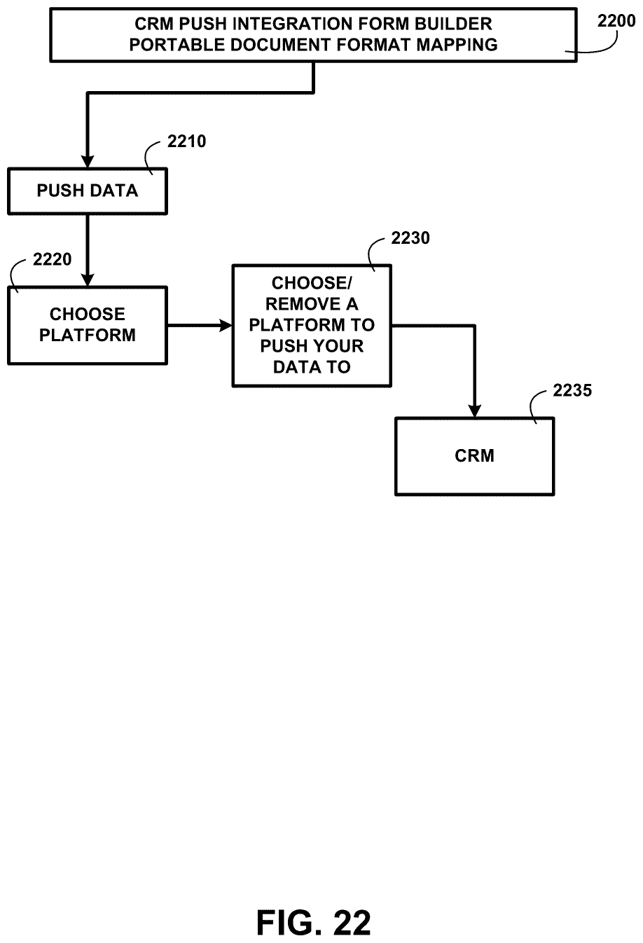

FIG. 22 shows for illustrative purposes only an example of CRM push integration form builder portable document format mapping of one embodiment. FIG. 22 shows CRM push integration form builder portable document format mapping 2200 to push data 2210 to an integrated platform. Step 1—choose platform 2220 allows a user to choose/remove a platform to push data to: 2230. For example, the user may choose an application platform by clicking on the input box to place an “X” 2235 for the choice selection of one embodiment.

FIG. 22 shows the application platform push integration form builder portable document format mapping. The application platform offers secure content management and collaboration for individuals, teams, and businesses, allowing secure file sharing and access to the user's files online. By using the customized customer relationship management platform method and devices the Push option can automatically update the application platform account.

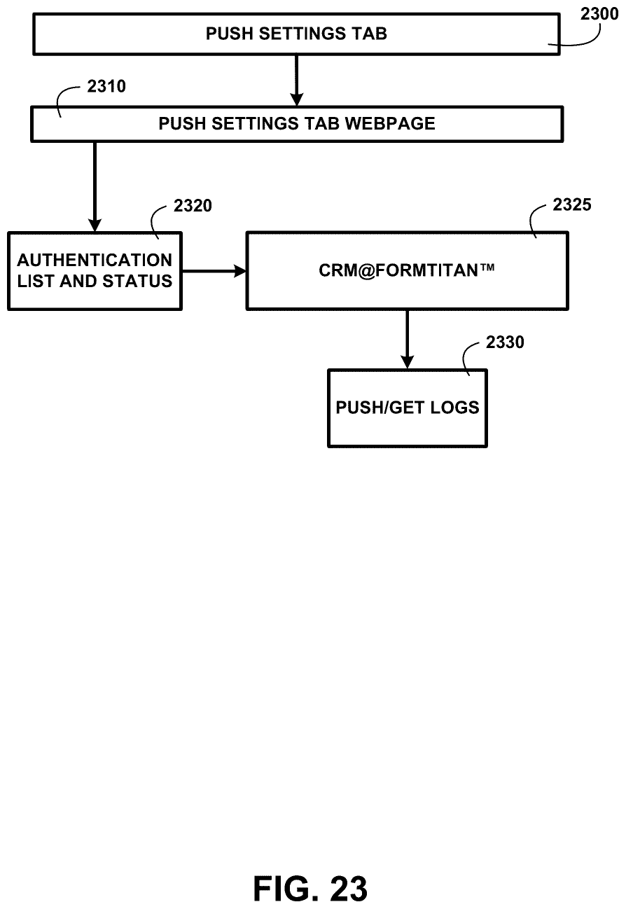

FIG. 23 shows for illustrative purposes only an example of the push settings tab of one embodiment. FIG. 23 shows a push settings tab 2300 on a push settings tab webpage 2310. The user makes selections for an authentication list & status 2320 of a platform for example CRM . . . CRM @ A form 2325 to receive automatically Push/Get Logs 2330 from the integrated CRM platform.

Other push features include error messages for skip in push, Map fields in get—made wide like in push, No override of empty fields in push, Redirect only after push is complete, All options added to Push Update, error message in Push logs: FT Request Limit, filter in Push Logs, Form Name in Push Logs, Ignore mandatory and validations in Custom Push, Push logs available in my submissions, Push mapping Condition, Redirect in Custom Push and Get, integration—Push to VoIP services, and Values of Hidden fields now shown after custom Push of one embodiment.

FIG. 23 shows the Push Settings Tab wherein “My Account” gives a user quick access to settings and tools for managing the user's customized customer relationship management platform method and devices account. It is divided into nine tabs and the “Push Settings” tab is the eighth.

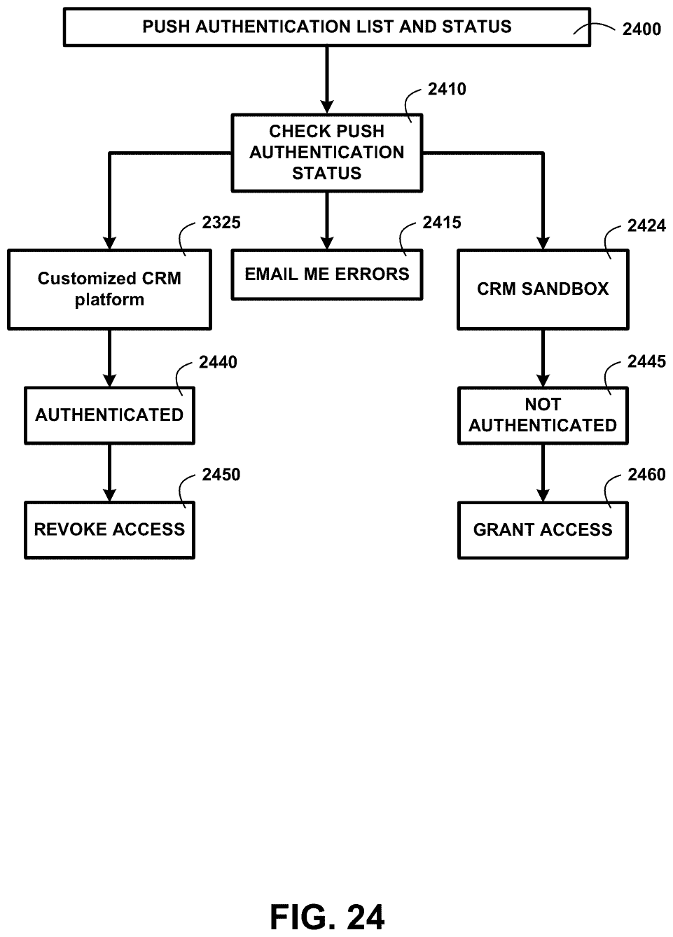

FIG. 24 shows for illustrative purposes only an example of a push authentication list and status of one embodiment. FIG. 24 shows a push authentication list and status 2400 with which a user can check the push authentication status 2410 of various platforms they may have chosen. The platforms can include, for example, CRM . . . CRM @ A form 2325, and CRM Sandbox 2424. The push authentication status 2410 provides a user with a selection to email me errors 2415. The push authentication list and status 2400 provide information and selections for a user showing the status of platforms including not authenticated 2445 or authenticated 2440. The user can select features to revoke access 2450 or grant access 2460 to a platform of one embodiment.

FIG. 24 shows a Push Authentication List & Status including a list of all the 3rd party integrations That the present invention provides, also called “Push integrations” (because a user can “push” the data out). Push integrations can include, for example, CRM and other application platforms. In the list, a user can see the 3rd parties currently authenticated. A user using the list features can authenticate or revoke access from an application platform. Additionally, an “Email me errors” checkbox is shown, which is turned on by default. This makes sure that if errors occur while users submit a form that is integrated the user will receive an email containing this error of one embodiment.

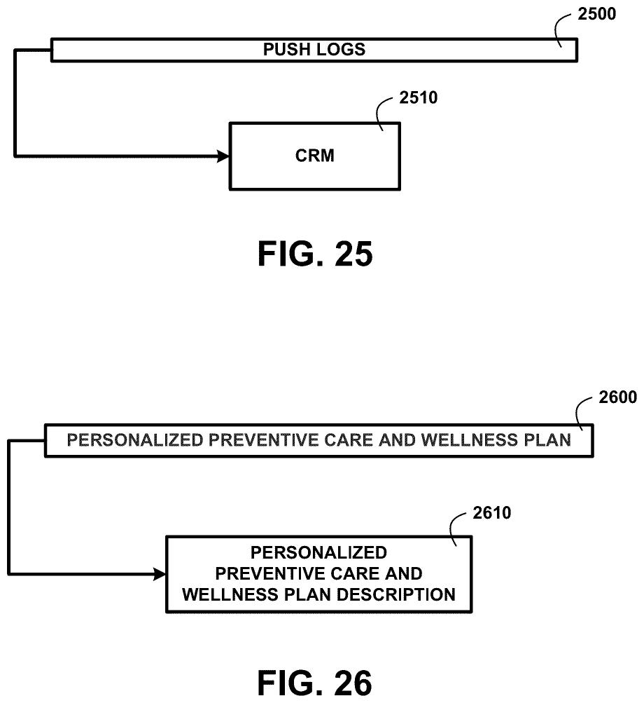

FIG. 25 shows for illustrative purposes only an example of push logs of one embodiment. FIG. 25 shows push logs 2500 a user can select to check the data pushed. The push logs 2500 can provide a user with a listing of data pushed to, for example, CRM 2510 of one embodiment.

FIG. 25 shows Push Logs. The table is called a ‘Push/Get log’. It contains all the integration action rows for both a user's push and get integrations. Each time an action is taken—either get or push—an action row is created in the log containing: Form Id: what form the action belongs to, Date time: Date of the action, IP: the form filler IP, Submission ID: the submission Id the action belongs to. This is also a link that displays the submission on the “My submissions” page. Other integration action rows include Method: Integration party. For example: CRM, Status code: Success or error, Message: Each message contains: the object used in the action (for example ‘Account’ or ‘Contact’), the action that was taken (Create/Update/Delete . . . ), and the error description including a link to the object in CRM/or another 3rd party, Resubmit: When an action fails and there is an error—then data is not synced with the 3rd party like it should. The information is not lost and after a user makes the required fix in the form—the user can press this “Resubmit” link and have the missing data added.

### Personalized Preventive Care and Wellness Plan:

FIG. 26 shows for illustrative purposes only an example of a personalized preventive care and wellness plan of one embodiment. FIG. 26 shows a personalized preventive care and wellness plan 2600. A user can, for example, open a personalized preventive care and wellness plan description 2610 to review and revise as they see fit of one embodiment.

The customized customer relationship management platform can be used in healthcare user applications. The healthcare industry uses many forms from initial patient intake, exams, lab tests, diagnostics, and so forth. The customized customer relationship management platform form builder can reduce workloads by automating data collection using form builder responsive forms that gather the data directly rather than have manual entry of the data. Many healthcare companies have multiple locations and even nationally distributed locations. Some of those same locations may use a different 3rd party application which further complicates data collection. In addition, the federal requirements for maintaining electronic health records need standardization within a company to prevent non-compliance issues. The customized customer relationship management platform functionality and integration capability can allow a company to standardize data collection while maintaining different 3^{rd} party applications thereby saving the replacement cost of the applications.

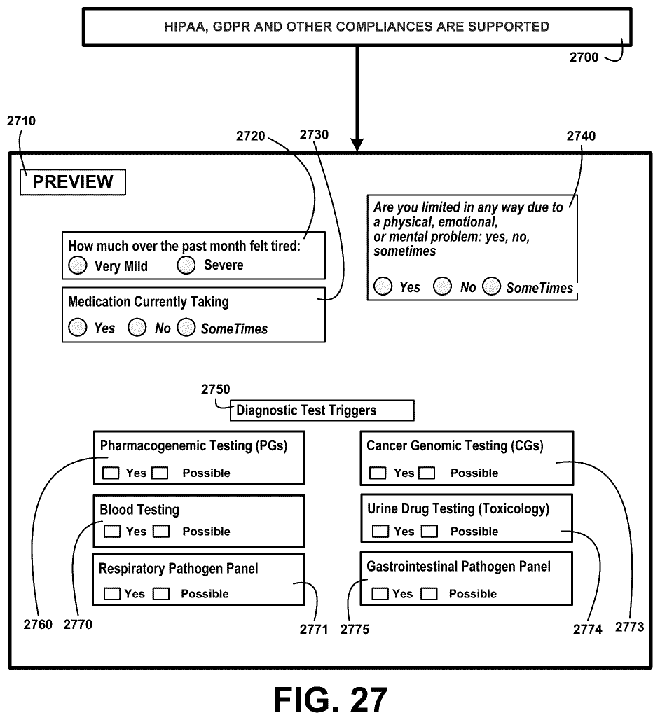

FIG. 27 shows for illustrative purposes only an example of HIPAA, GDPR, and other compliances are supported of one embodiment. FIG. 27 shows HIPAA, GDPR, and other compliances are supported 2700 in the customized customer relationship management platform method and devices. A preview 2710 of potential health issues is provided to allow a user to comply with regulations and suggested health care programs described in the Health Insurance Portability and Accountability Act (HIPAA) and General Data Protection Regulation (GDPR) to keep patient information private. The preview 2710 includes, for example, a series of questions the user can answer, for example, how much over the past month felt tired: very mild, severe 2720; medication currently taking yes, no, sometimes 2730 and are you limited in any way due to a physical, emotional, or mental problem: yes, no, sometimes 2740 of one embodiment. Questions are also asked about Diagnostic Test Triggers 2750 including Pharmacogenomic Testing (PGs) yes, possible 2760, Blood Testing yes, possible 2770, Respiratory Pathogen Panel yes, possible 2771, Cancer Genomic Testing (CGs) yes, possible 2773, Urine Drug Testing (Toxicology) yes, possible 2774, and Gastrointestinal Pathogen Panel yes, possible 2775.

HIPAA, GDPR, and other compliances support allow healthcare companies to comply with the myriad of compliance regulations using a single source product for form creation or conversion, not have to change existing hardware and software and standardize user operations across multiple facilities regardless of location using the customized customer relationship management platform functionality and integration capability.

### Portable Document Format Mapping Settings:

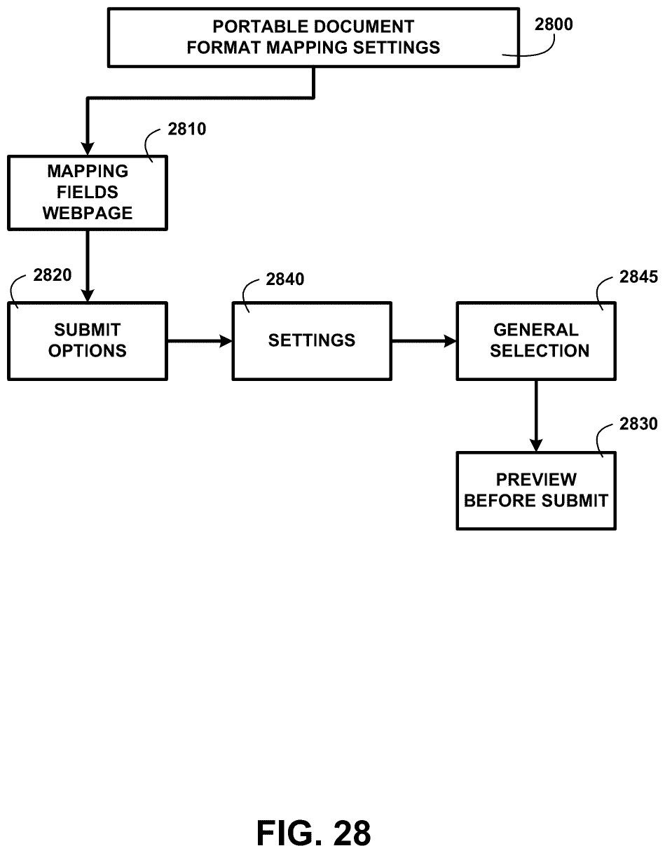

FIGS. 28-32 show for illustrative purposes only an example of portable document format mapping settings of one embodiment. FIG. 28 shows for illustrative purposes only an example of portable document format mapping settings of one embodiment. FIG. 28 shows portable document format mapping settings 2800 on a mapping field 2810 webpage. The mapping fields 2810 webpage includes a selection to submit options 2820 for settings 2840 including, for example, a general 2845 selection to preview before submit 2830 of one embodiment.

### Portable Document Format Mapping Settings General:

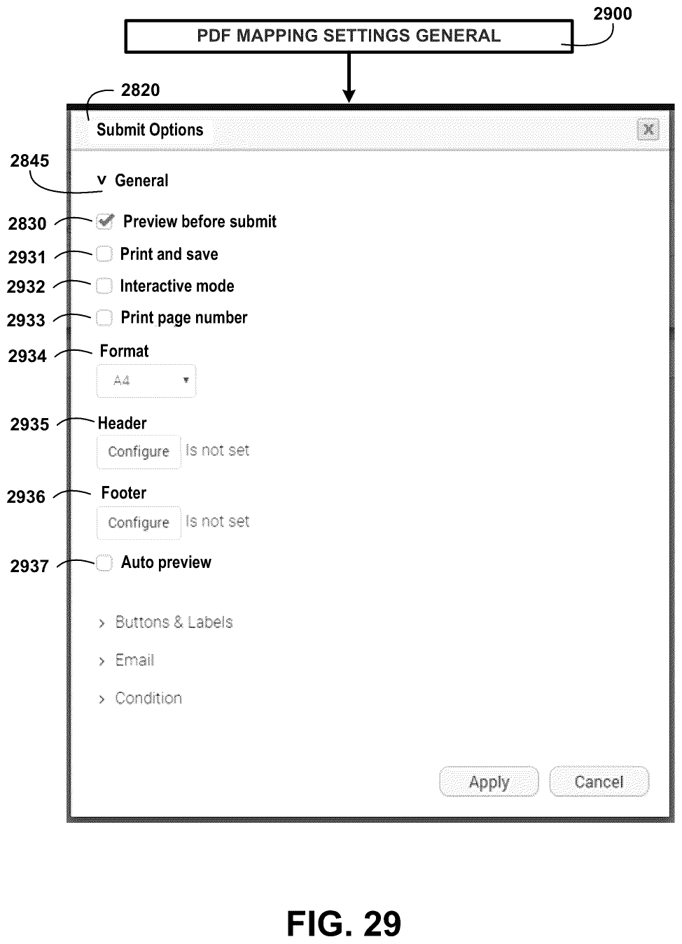

FIG. 29 shows for illustrative purposes only an example of portable document format mapping settings general of one embodiment. FIG. 29 shows portable document format mapping settings general 2900 including submit options 2820 of the general 2845 features including preview before submit 2830, print and save 2931, interactive mode 2932, print page number 2933, format 2934, for example, A4, header 2935 with an instruction to configure . . . is not set showing, it has not been configured, footer 2936 with an instruction to configure . . . is not set showing, it has not been configured, and auto preview 2937 of one embodiment.

### Portable Document Format Mapping Settings Buttons and Labels:

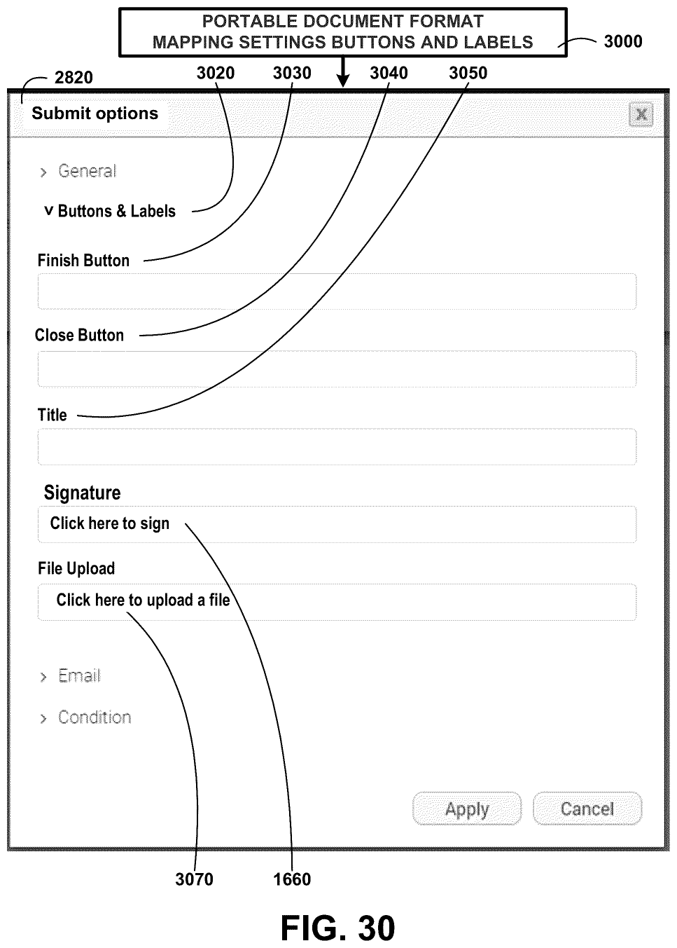

FIG. 30 shows for illustrative purposes only an example of portable document format mapping settings buttons and labels of one embodiment. FIG. 30 shows a portable document format mapping settings buttons and labels 3000 feature including the submit options 2820 and a selection menu for buttons & labels 3020. The buttons & labels 3020 selection menu includes finish button 3030, close button 3040, title 3050, signature 1660 with an instruction to click here to sign, and file upload 3070 with an instruction to click here to upload a file of one embodiment.

Additional settings buttons include features containing Add and remove buttons in repeated section, Add script after button completes its task, Allow/Disable condition result options for Checkbox and Radio button, Condition button type allows to manipulate section tabs, Confirmation Mode on button, Disallow items of Picklists in Dropdown, Radio button, Checkbox/Multiple dropdown, Draft button—Hide confirmation, Excess buttons removed from repeated section, Move to a specific page using the CRM Action button, button type: Redirect, Page break with flexible next/prev buttons, Repeated section—Show remove button for last, Styles for buttons in Table element including alignment, Text direction buttons in HTML editors, Button—Reset Signature, Option to Ignore Empty Conditions in Action Button—Get, Go to page Button based on Hidden, Button Type: Condition, On click event added to Button, Add and remove buttons in repeated section, Button—Reset Signature, Button Type: Condition, button type: Redirect, On click event added to Button, Repeated section—Show remove button for last, Condition button type allows to manipulate section tabs, Confirmation Mode on button, and Text direction buttons in HTML editors of one embodiment.

### Portable Document Format Mapping Settings Email:

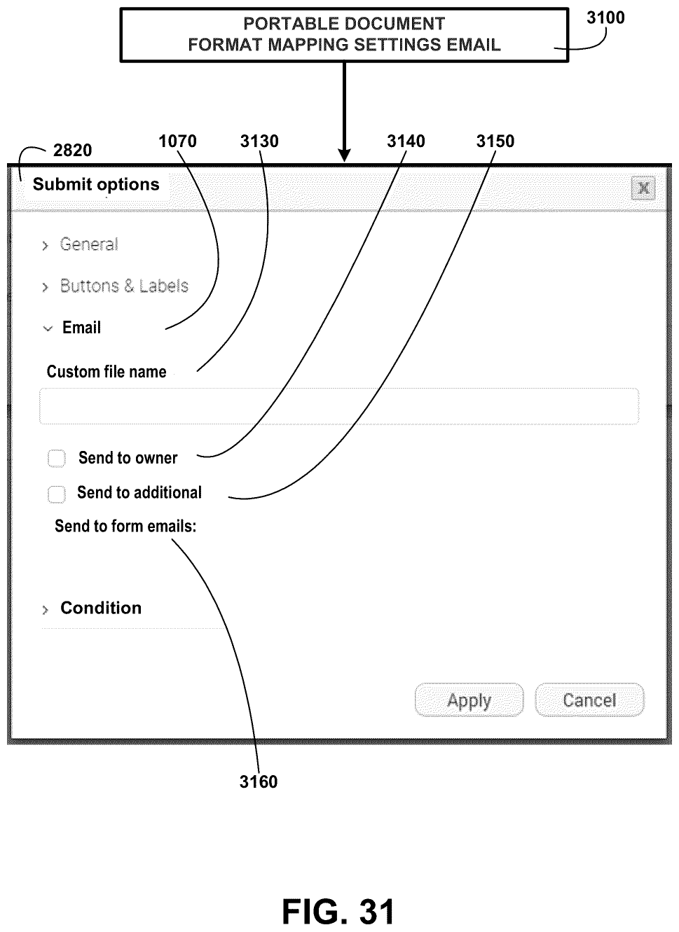

FIG. 31 shows for illustrative purposes only an example of a portable document format mapping settings email of one embodiment. FIG. 31 shows a portable document format mapping settings email 3100 feature that includes the submit options 2820 selection. The portable document format mapping settings feature email 1070 including a custom file name 3130, send to owner 3140, send to additional 3150, and send to form emails 3160 of one embodiment.

### Portable Document Format Mapping Settings Condition:

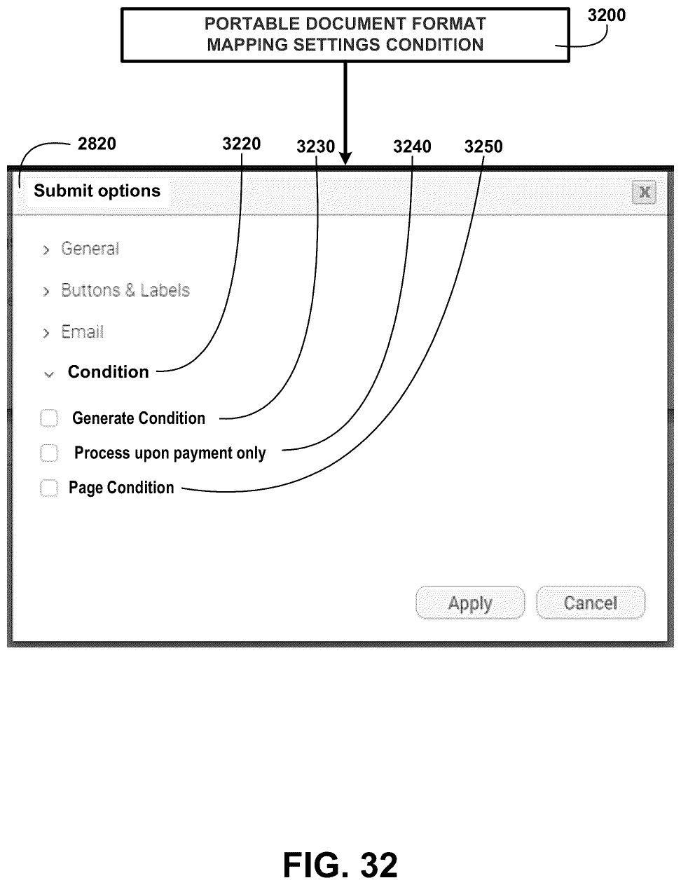

FIG. 32 shows for illustrative purposes only an example of portable document format mapping settings condition of one embodiment. FIG. 32 shows a portable document format mapping settings condition 3200 feature including the submit options 2820 selection. A condition 3220 features menu selections to generate condition 3230, process upon payment only 3240, and a page condition 3250 of one embodiment.

Portable document format Mapping: settings. Configuring portable document format Settings. No matter what type of portable document format a user adds to a form (Basic, Dynamic, or Auto-portable document format)—the user will need to configure its settings. While the Basic and Dynamic portable document format settings are the same, the auto-portable document format has a slightly different set of properties. The Basic/Dynamic portable document format Settings 1—Press on the “Settings” icon to configure the portable document format settings. A Modal window will open then containing the settings, organized in 4 categories:—General—Buttons and Labels-Email-Condition. Please note that the first category will be open by default.

General properties:—Preview before submission: turning on this checkbox will allow a user to present the form filler with a preview of a soon-to-be-generated portable document format. It will display the template the user created and the data the form filler entered in it. So, when the form filler hits the submit button a pop-up window will open, containing this preview. Only after the form filler presses on the “Finish” button in the preview window will it submit the form. The portable document format preview window contains 4 icons in the top right corner to help the form filler: Plus (for zooming in), minus (for zooming out), clear (for clearing the zoom), and Print (for printing the portable document format).

Print and save: turning on this checkbox will add a saving functionality to the print icon. In this case, pressing on the Print icon will open a dialog for print, and once the printing is approved—it will also submit the form. —Interactive mode: This option will only be available when the ‘preview before submit’ checkbox is turned on. The interactive mode will allow form fillers to add or edit data inside the portable document format preview window. Once this checkbox is turned on a user will be able to choose the fields to make the fields selected to be interactive. Print page number. If the portable document format has more than one page a user can turn on this option to add a number at the bottom of each page. Format: The default portable document format is A4, however, a user can choose to change it to Letter. Header: This option can allow the user to add a header to the portable document format using the editor and HTML. Footer: This option can allow a user to add a footer to the portable document format using the editor and HTML. Auto preview: This option will automatically open the preview window after the form loads, so the form filler will be able to “skip” filling in the form.

Buttons & Labels properties: —Finish/Close button text: if a user decides to turn on the ‘preview before submit’ option, the user can change the text on the buttons at the bottom of it. Title: If a user decides to turn on the ‘preview before submit’ option, the user can add a title text to this window. Signature: When a Signature field is added to the portable document format and made interactive (by turning on the ‘interactive mode’ and adding the signature field to the list of interactive fields), it will have a label below it, containing the default text: “Click here to sign”. A user can enter a different text in this input box to replace it. File upload: When a File upload field is added to the portable document format and made interactive (by turning on the ‘interactive mode’ and adding the File Upload field to the list of interactive fields), it will have a label below it, containing the default text: “Click here to upload a file”. A user can enter a different text in this input box to replace it.

Email properties: Custom file name—a user can enter a name for the portable document format being created. This will be the file name of the portable document format attached to the email. Send to owner/Send to additional/Send to form emails: Checkboxes that determine where this paper form will be sent. Condition Properties: Generate Condition: if a user decides to turn on this Checkbox the user will be allowed to add a condition by which this portable document format will be generated. Only if the condition terms are met then the portable document format will be generated. Process upon payment only: turning on this checkbox will make sure that the portable document format will be generated only if the payment is executed. Page Condition: By turning on this option a user can set a condition that will make portable document format pages hide/show based on the form filler's input. Portable document format Mapping Form Settings. This Category holds the configuration of the portable document format Mapping feature. 1—Map Fields by pressing on the “Map Fields” button” a user can map the online form onto a paper form scan. Once the window opens a user will need to place the online form fields above a paper form, in the right places.

### Form Builder Optimization Features:

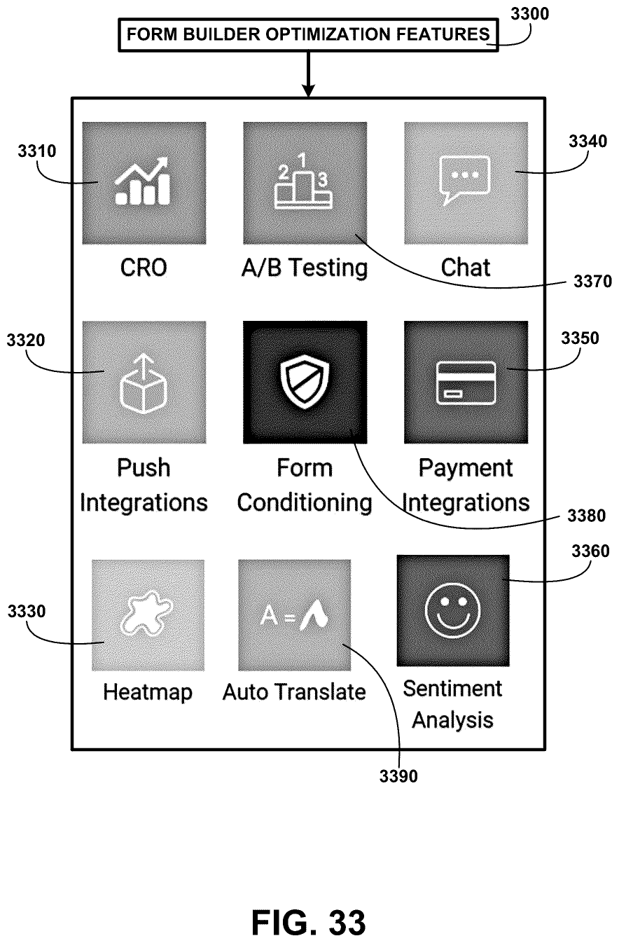

FIG. 33 shows for illustrative purposes only an example of form builder optimization features of one embodiment. FIG. 33 shows form builder optimization features 3300 including CRO 3310, Push Integrations 3320, Heatmap 3330, Chat 3340, Payment Integrations 3350, Sentiment Analysis 3360, AB Testing 3370, Form Conditioning 3380, and Auto Translate 3390 of one embodiment.

### Form Builder Features Characteristics:

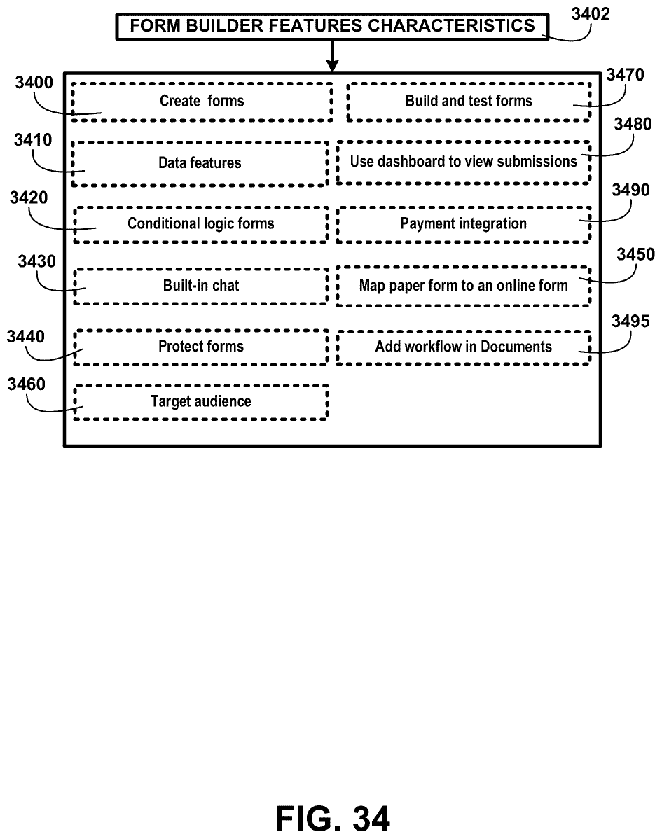

FIG. 34 shows for illustrative purposes only an example of form builder features characteristics of one embodiment. FIG. 34 shows the customized customer relationship management platform method and devices form builder features characteristics 3402 brief descriptions of the characteristics of the features and elements.

For example, the Customized CRM platform includes Create forms 3400, Data features 3410, Conditional logic forms 3420, Built-in chat 3430, Protect forms 3440, Map paper form to an online form 3450, Target audience 3460, Build and test forms 3470, Use dashboard to view submissions 3480, Payment integration 3490, and Add workflow in Documents 3495 of one embodiment. Each of the form builder features and elements serves a functional purpose.

### Other User Applications:

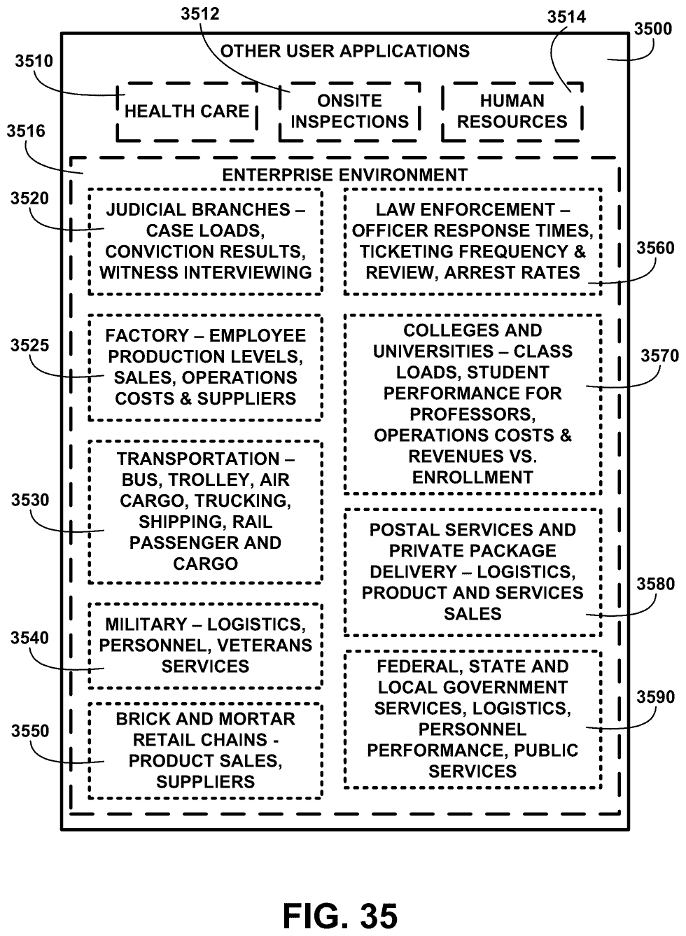

FIG. 35 shows a block diagram of an overview of other user applications of one embodiment. FIG. 35 shows other user applications 3500 including health care 3510, onsite inspections 3512, and human resources 3514. Additional applications in an enterprise environment 3516 include judicial branches—caseloads, conviction results, witness interviewing 3520, factory—employee production levels, sales, operations costs & suppliers 3525, transportation—bus, trolley, air cargo, trucking, shipping, rail passenger and cargo 3530, military—logistics, personnel, veterans services 3540, brick and mortar retail chains—product sales, suppliers 3550, law enforcement—officer response times, ticketing frequency & review, arrest rates 3560, colleges and universities—class loads, student performance for professors, operations costs & revenues vs. enrollment 3570, postal services and private package delivery—logistics, product and services sales 3580, and federal, state and local government services, logistics, personnel performance, public services 3590 of one embodiment.

### Other User Applications Enterprise Environment:

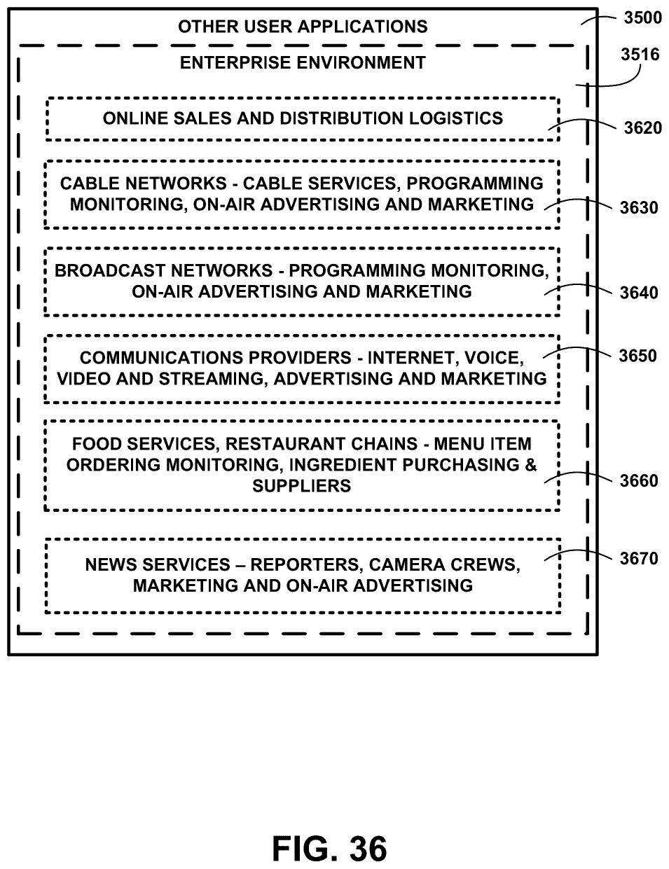

FIG. 36 shows a block diagram of an overview of other user applications enterprise environment of one embodiment. FIG. 36 shows other user applications 3500 in an enterprise environment 3516 including online sales and distribution logistics 3620, cable networks—cable services, programming monitoring, on-air advertising and marketing 3630, broadcast networks—programming monitoring, on-air advertising and marketing 3640, and communications providers—internet, voice, video and streaming, advertising and marketing 3650 of one embodiment.

FIG. 36 shows additional other user applications in an Enterprise Environment including Online Sales and Distribution Logistics; Cable Networks—Cable Services, Programming Monitoring, On-Air Advertising and Marketing; Broadcast Networks—Programming Monitoring, On-Air Advertising and Marketing; Communications Providers—Internet, Voice, Video and Streaming, Advertising and Marketing; Food Services, Restaurant Chains—Menu Item Ordering Monitoring, Ingredient Purchasing & Suppliers 3660; and News Services—Reporters, Camera Crews, Marketing and On-Air Advertising 3670.

### Bi-Directional Voice Command and Interactive Form-Building Elements:

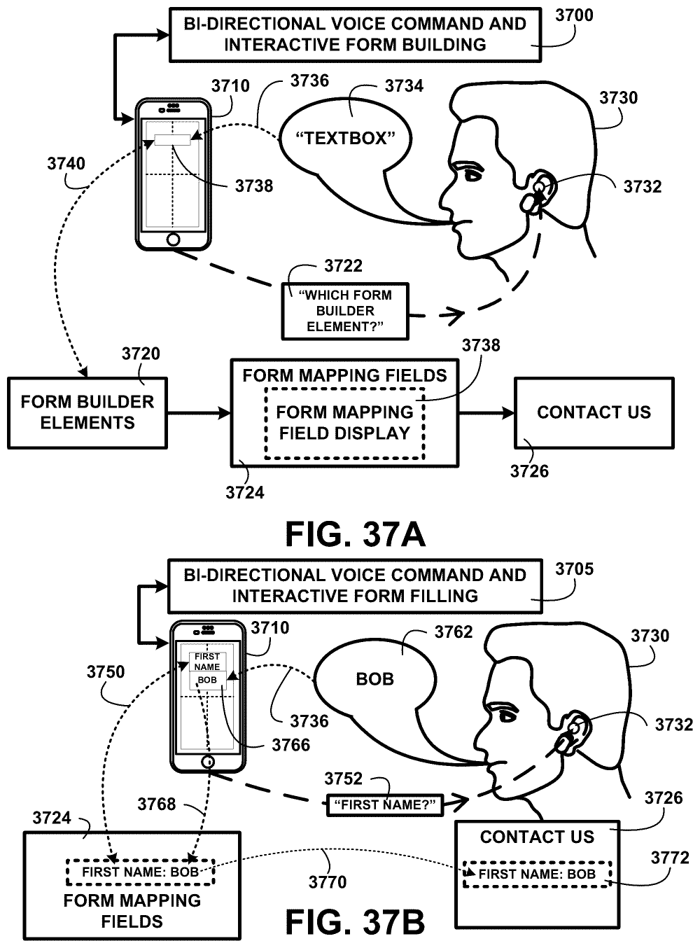

FIG. 37A shows for illustrative purposes only an example of bi-directional voice command and interactive form-building elements of one embodiment. FIG. 37A shows bi-directional voice command and interactive form building 3700. The customized customer relationship management platform method and devices are accessible through a user smartphone 3710 internet connection to the customized customer relationship management platform method and devices digital servers using a digital application installed on a user digital device including the user smartphone 3710. In this example, the user opens form builder elements 3720 while creating the interactive user's existing portable document format form mapping fields 3724. The digital application includes an audio text reader to transmit an audible question “which form builder element?” 3722 to the user 3730 through a hands-free earpiece 3732. In response to the audible question regarding the contact Us 3726 mapping fields selection the user 3730 conveys the user's verbal response as “text box” 3734. The user's verbal response is received by the smartphone 3736 digital application. The application enters a textbox onto the user's existing portable document format form mapping field display 3738. The application selects a textbox from the form builder elements per the user's verbal command 3740 of one embodiment.

FIG. 37B shows for illustrative purposes only an example of bi-directional voice command and interactive form-building data of one embodiment. FIG. 37B shows bi-directional voice command and interactive form filling 3705 using the user's smartphone 3710 to fill in the user's existing portable document format form mapping fields 3724 contact us 3726 data. The user 3730 hears through the hands-free earpiece 3732 a Form application process to the next data entry, for example, first name 3750. The form digital application an audio text reader transmits an audible question “First name?” 3752. A user's verbal response is “Bob” 3762. The user's verbal response is received by the smartphone 3736 and the application enters “Bob” in the textbox 3766. Additionally, the application shows “Bob” in the user's existing portable document format form mapping fields display 3768. The application automatically displays the first name entry 3770. The contact form shows the first name “Bob” on the Contact Us form 3772 in the first name text box of one embodiment.

Bi-Directional Voice Command and Interactive Information from Forms:

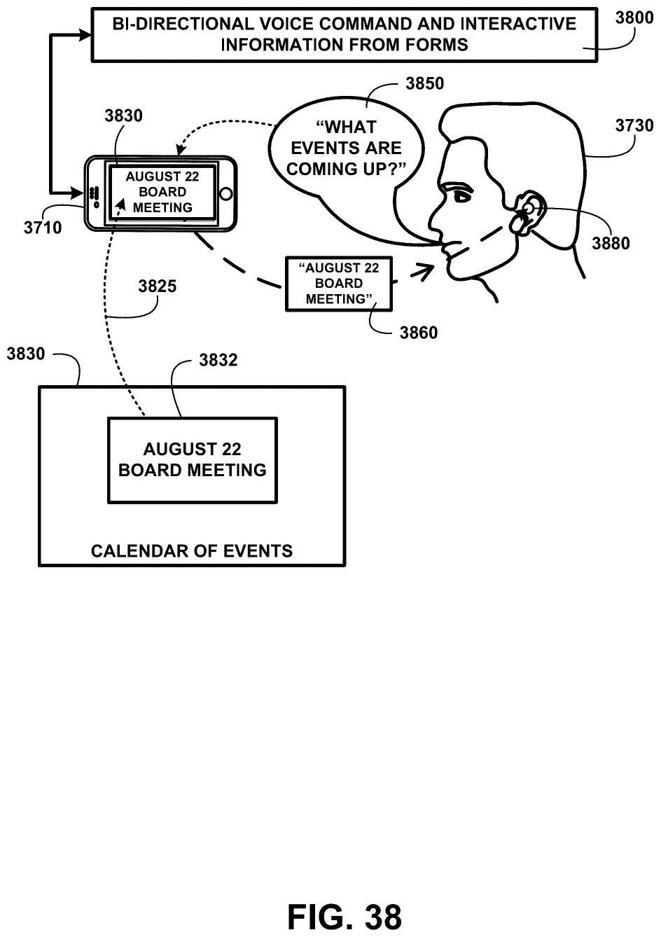

FIG. 38 shows for illustrative purposes only an example of bi-directional voice command and interactive information from forms of one embodiment. FIG. 38 shows bi-directional voice commands and interactive information from forms 3800. The user 3730 makes a verbal query request, “What events are coming up?” 3850 on the user's smartphone 3710. The application displays the user's calendar of events 3830 on the smartphone. The application searches the user's calendar of events 3830 for the next event data 3832. The application displays the user's calendar of events 3830 on the smartphone 3710 “August 22 board meeting” 3825. The application using the text reader transmits an audible message to the user of the next event “August 22 board meeting” 3860. The user 3730 using a hands-free earpiece 3880 hears the application's audible message of one embodiment.

Integration Example with CMI:

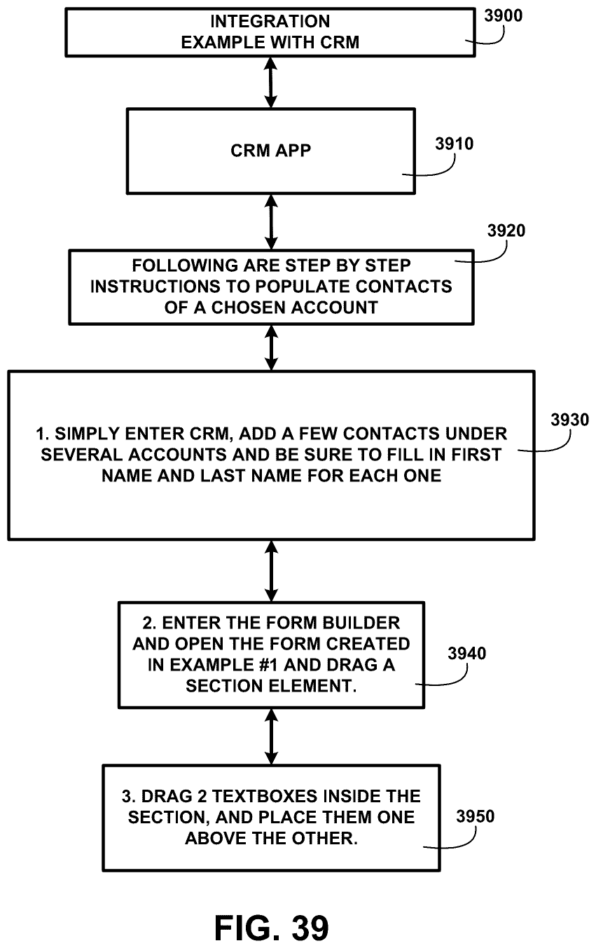

FIGS. 39-49 show for illustrative purposes only an example of integration example with CRM of one embodiment.

Integration Example with CRM:

FIG. 39 shows a block diagram of an overview of an integration example with CRM of one embodiment. FIG. 39 shows an integration example with CRM 3900. The CRM app 3910 is accessed using the integrated CRM platform. The following are step-by-step instructions to populate contacts of a chosen account 3920. Step 1—simply enter CRM, add a few contacts under several accounts, and be sure to fill in a first name and last name for each one 3930. Step 2—enter the form builder open the form created in example #1 and drag a section element 3940. Step 3—drag 2 textboxes inside the section and place them one above the other 3950 of one embodiment.

### Integration CRM Object Settings:

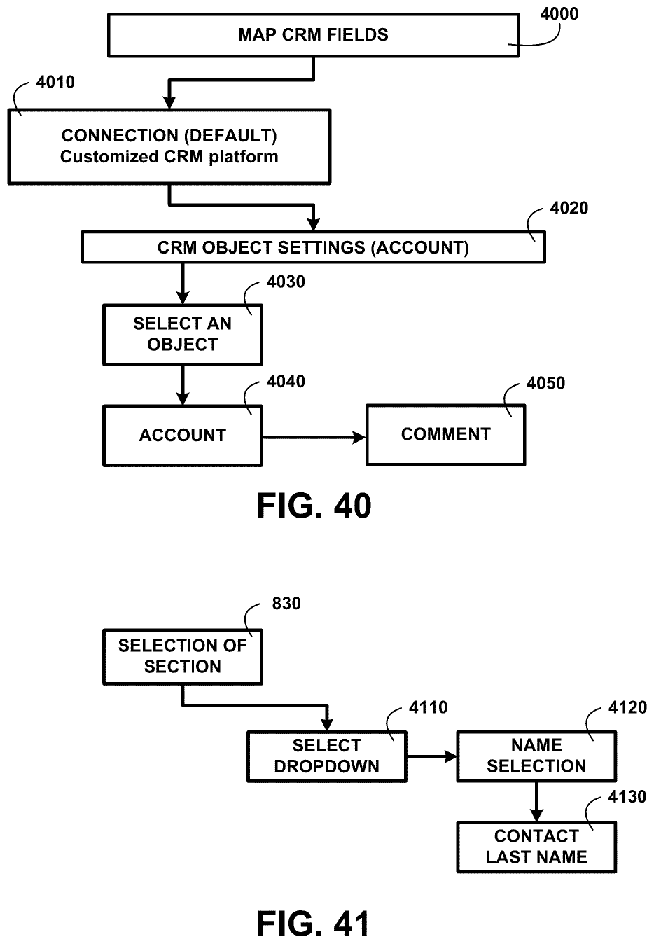

FIG. 40 shows for illustrative purposes only an example of integration CRM object settings of one embodiment. FIG. 40 shows a process to map CRM fields 4000. A user makes a connection (default) at the Customized CRM platform website 4010. The user opens CRM object settings (account) 4020 and proceeds to select an object 4030 in an account 4040 and enter a comment 4050 of one embodiment.

### Integration Setting CRM Section:

FIG. 41 shows for illustrative purposes only an example of integration setting the CRM section of one embodiment. FIG. 41 shows the selection of section 830 displays a choose account name select drop down 4110 for a user to select a name from a section selection 4120 including a contact last name 4130 of one embodiment.

### Integration Setting CRM Fields:

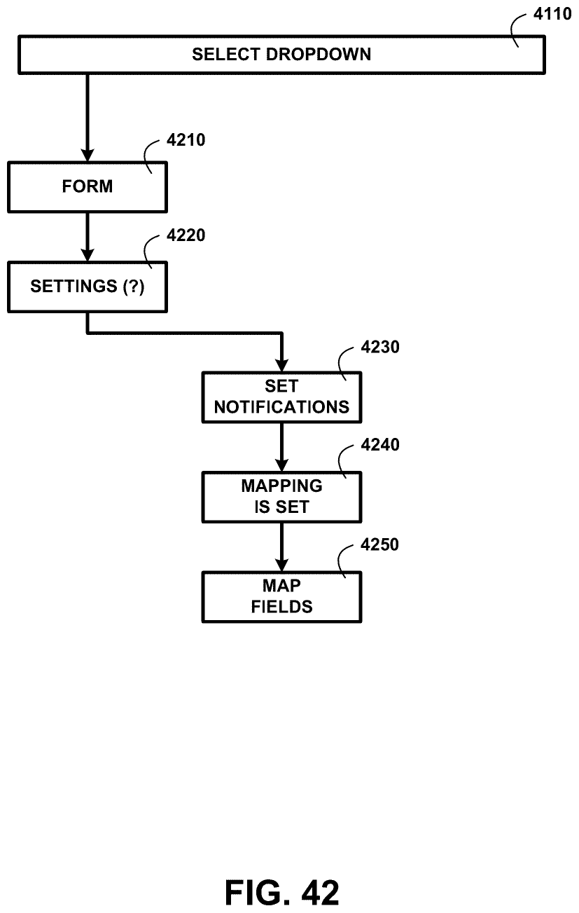

FIG. 42 shows for illustrative purposes only an example of integration setting CRM fields of one embodiment. FIG. 42 shows a webpage where a user can select a choose account name select drop-down 4110 to select an account name. Under the form 4210 a user proceeds to settings 4220 to set notification 4230. Once the notification is entered the mapping is set 4240 in the map fields 4250 of one embodiment.

Integration Get from CRM:

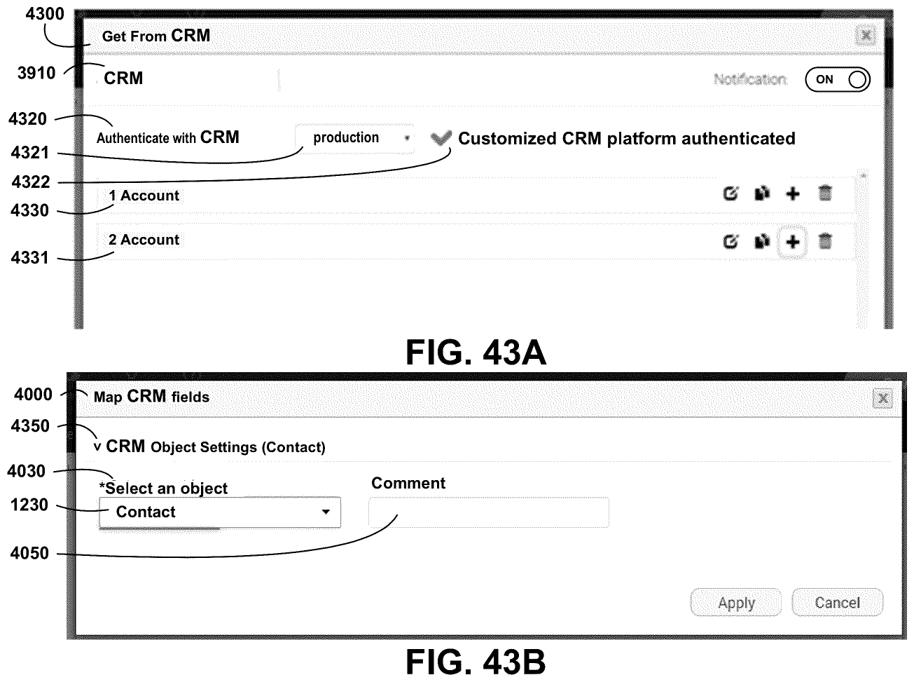

FIG. 43A shows for illustrative purposes only an example of integration get from CRM of one embodiment. FIG. 43A shows a Get from CRM 4300 feature for integrated use with the CRM app 3910. When the CRM app 3910 is selected a process on the customer relationship management platform network 210 of FIG. 2 performs an action to authenticate with CRM 4320 a production 4321 operation. The customer relationship management platform network 210 of FIG. 2 finds the Customized CRM platform authenticated 4322. The user then selects, for example, 1 account 4330 or 2 account 4331 of one embodiment.

### Integration Map CRM Fields:

FIG. 43B shows for illustrative purposes only an example of an integration map of CRM fields of one embodiment. FIG. 43B shows map CRM fields 4000 including CRM object settings (contact) 4350. The select an object 4030 includes the contact 1230 and a comment 4050 entry textbox of one embodiment.

### Integration Map CRM Object Settings:

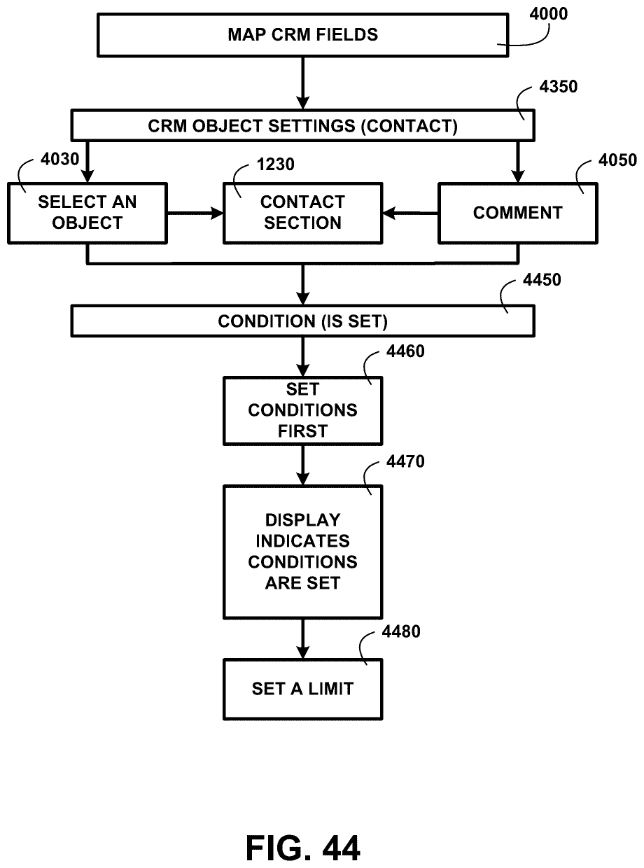

FIG. 44 shows for illustrative purposes only an example of an integration CRM map object settings of one embodiment. FIG. 44 shows a webpage for mapping CRM fields 4000 including CRM object settings (contact) 4350. The user can select an object 4030, for example, the contact section 1230 where the user can enter a comment 4050. The user can see displayed that a condition is set 4450 when the user set conditions first 4460 referring to a first name and the display indicates the condition is set 4470 and the user can set a limit 4480 as a condition of one embodiment.

### Integration CRm Condition:

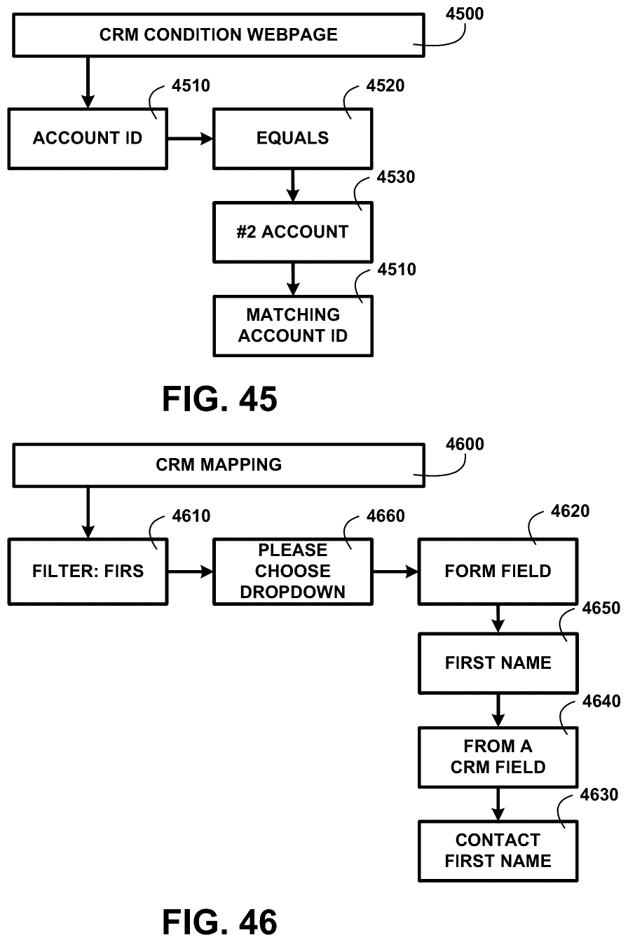

FIG. 45 shows for illustrative purposes only an example of the integration CRM condition of one embodiment. FIG. 45 shows a CRM condition 4500 webpages with an account ID drop down 4510 to select an account that meets a condition in a drop-down, for example, an equals drop down 4520 in a #2 account drop down 4530 and matching account ID drops down 4510 selection of one embodiment.

### Integration CRM Mapping Corresponding Fields:

FIG. 46 shows for illustrative purposes only an example of integration CRM mapping corresponding fields of one embodiment. FIG. 46 shows CRM mapping 4600 including a filter: first 4610 and how it is to show: please choose to drop down 4660 using the drop-down. A form field 4620 first name 4650 selection from a CRM field 4640 contact first name 4630 can be selected as the filter condition of one embodiment.

### Integration CRM Mapping Contact:

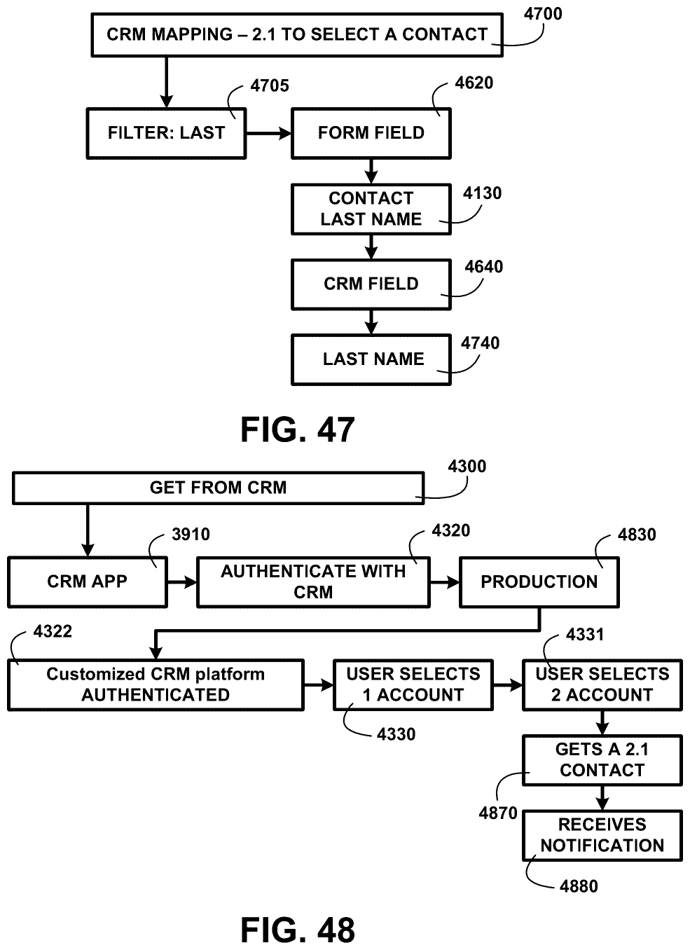

FIG. 47 shows for illustrative purposes only an example of integration CRM mapping contact of one embodiment. FIG. 47 shows a CRM mapping—#2.1 to select a contact 4700 filter: last 4705. A form field 4620 contact last name 4130 can be selected from a CRM field 4640 last name 4740 of one embodiment.

### Integration CRM Get Contact:

FIG. 48 shows for illustrative purposes only an example of integration CRM get the contact of one embodiment. FIG. 48 shows a Get from CRM 4300 operation using the CRM app 3910. The authenticate with CRM 4320 can, for example, use a production drop-down 4830 to obtain a Customized CRM platform authenticated 4322 notice. The user selects 1 account 4330 or 2 account 4331. In this example, the user selects the 2 account 4331 drop down to get a 2.1 contact 4870 to receive a notification: 4880 of one embodiment.

### Integration CRM Email:

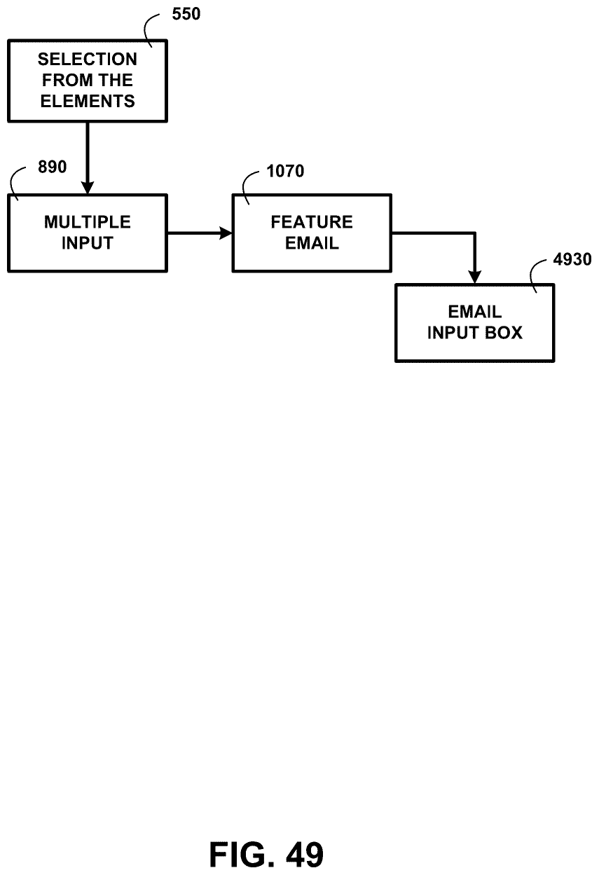

FIG. 49 shows for illustrative purposes only an example of integration CRM email of one embodiment. FIG. 49 shows a user selecting from the elements 550 multiple-input 890 feature email 1070. An email input box 4930 is used by the user to enter an email address. A good indicates the quality of the email entry of one embodiment.

### Portable Document Format Block Condition Elements:

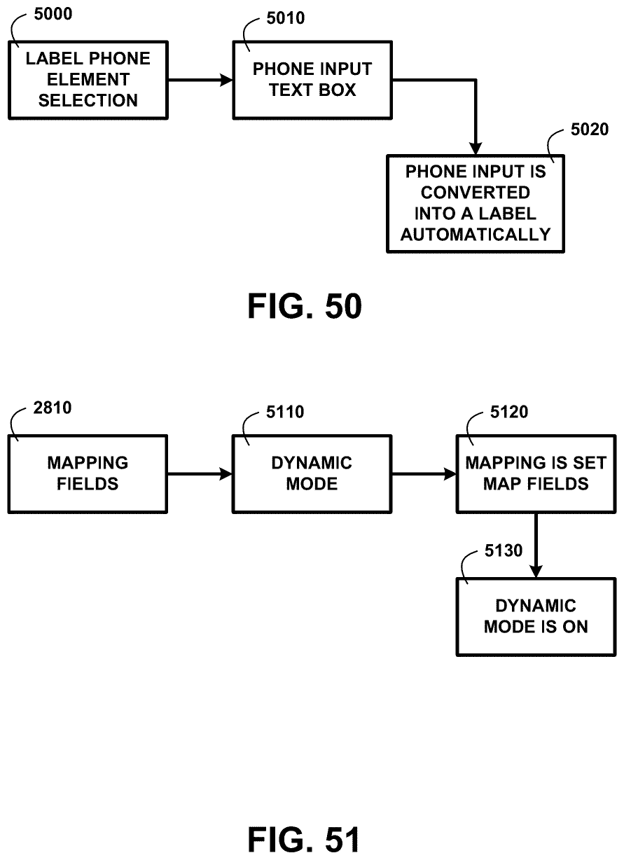

FIGS. 50-60 show for illustrative purposes only an example of portable document format block condition elements of one embodiment.

### Portable Document Format Block Condition Elements:

FIG. 50 shows for illustrative purposes only an example of a portable document format block condition elements of one embodiment. FIG. 50 shows a label phone 5000 element selection where a user enters a phone number in a phone input text box 5010. The phone input is converted into a label automatically 5020 of one embodiment.

### Portable Document Format Block Condition Dynamic Mode:

FIG. 51 shows for illustrative purposes only an example of a portable document format block condition dynamic mode of one embodiment. FIG. 51 shows mapping fields 2810 where dynamic mode is shown on 5110. A notice shows mapping is set to map fields 5120 wherein the mapping is set to confirm that the dynamic mode is on 5130 of one embodiment.

### Portable Document Format Block Condition Portable Document Format Settings:

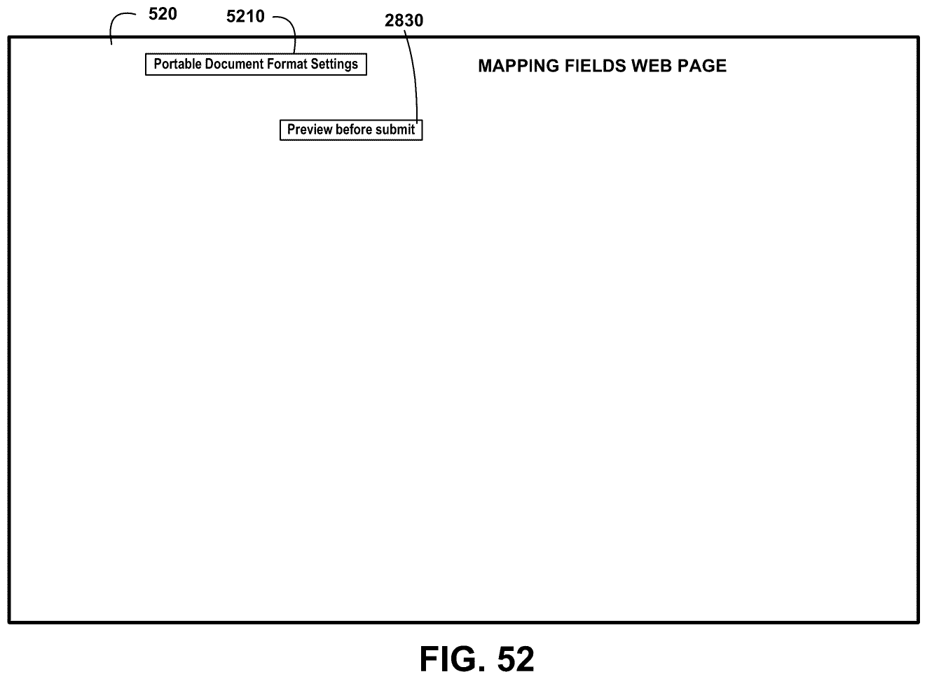

FIG. 52 shows for illustrative purposes only an example of a portable document format block condition portable document format settings of one embodiment. FIG. 52 shows the mapping fields web page 520 for the selection of portable document format settings 5210 with an instruction to preview before submitting 2830 of one embodiment.

### Portable Document Format Block Condition Mapping Fields all Elements:

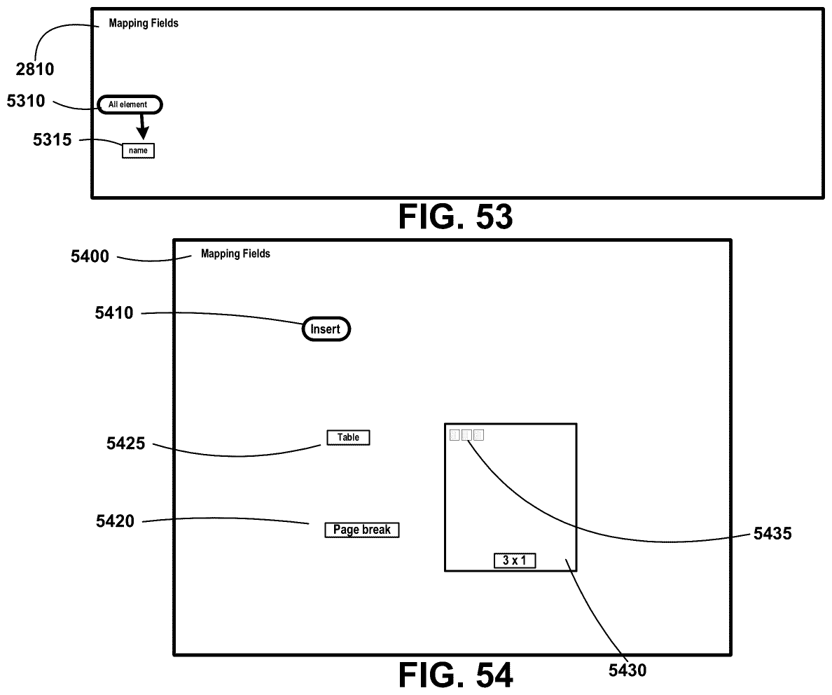

FIG. 53 shows for illustrative purposes only an example of portable document format block condition mapping fields with all elements of one embodiment. FIG. 53 shows mapping fields 2810 where a user can select an all-element drop-down 5310 and select a field including name 5315 of one embodiment.

### Portable Document Format Block Condition Mapping Fields Table:

FIG. 54 shows for illustrative purposes only an example of a portable document format block condition mapping fields table of one embodiment. FIG. 54 shows the mappings field 5400 webpage and an insert 5410 feature selection menu that includes a table 5425 with a menu that includes insertion of a page break 5420. Showing is a table grid 5430 where the user highlights a 3×1 page break 5435 for the table of one embodiment.

### Portable Document Format Block Condition Starting Mapping Fields:

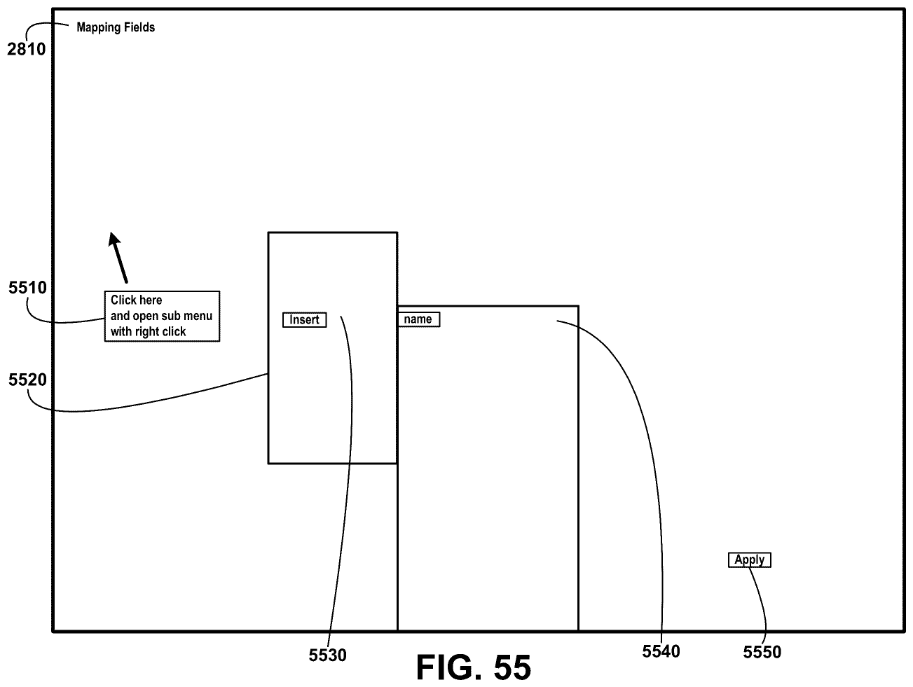

FIG. 55 shows for illustrative purposes only an example of a portable document format block condition starting mapping fields of one embodiment. FIG. 55 shows mapping fields 2810 with an instruction click here and open sub menu with right click 5510. A sub-menu 5520 includes an insert drop-down 5530 and shows a user-selected name 5540 that the user can apply 5550 of one embodiment.

### Portable Document Format Block Condition Mapping Field Name:

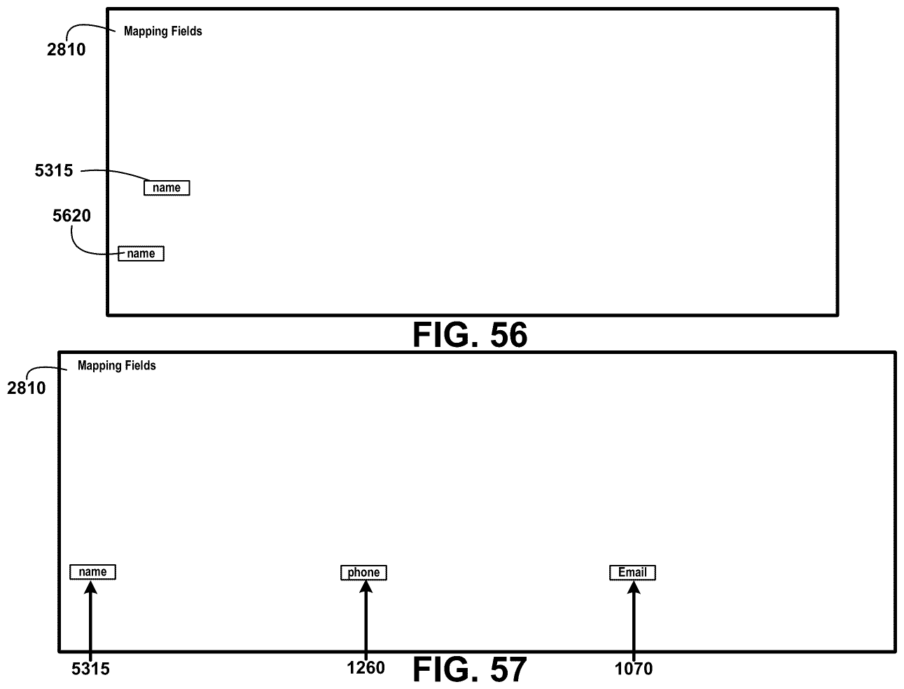

FIG. 56 shows for illustrative purposes only an example of a portable document format block condition mapping field name of one embodiment. FIG. 56 shows the mapping fields 2810 where a name 5315 is displayed and a name insert box 5620 can be entered or automatically inserted from a platform account field of one embodiment.

### Portable Document Format Block Condition Mapping Fields:

FIG. 57 shows for illustrative purposes only an example of a portable document format block condition mapping fields of one embodiment. FIG. 57 shows the mapping fields 2810 where a name entry displays the name 5315, phone 1260, and email 1070 associated with the name entered of one embodiment.

### Portable Document Format Block Condition Mapping Fields Selection:

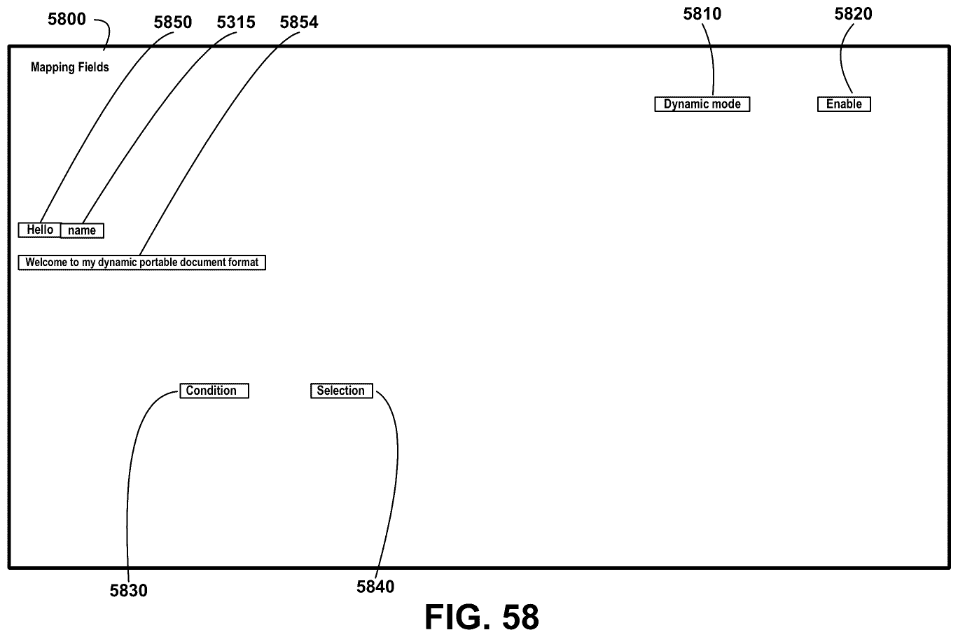

FIG. 58 shows for illustrative purposes only an example of portable document format block condition mapping field selections of one embodiment. FIG. 58 shows a mapping field web page 5800 that a user has set up with a greeting hello 5850, a name 5315, and a salutation welcome to my dynamic portable document format 5854. Dynamic mode is on 5810 and allow on 5820 indicates it will be activated as directed in an entry in a condition drop-down 5830 selection from the condition drop-down sub-menu selection table row table col 5840 of one embodiment.

### Portable Document Format Block Rule Condition Selection:

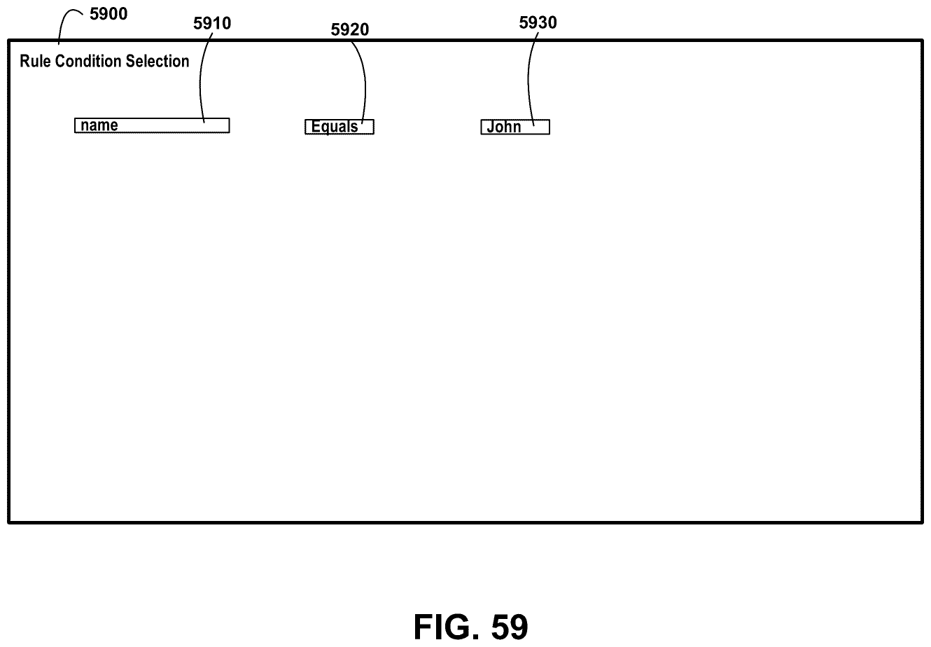

FIG. 59 shows for illustrative purposes only an example of a portable document format block rule condition selection of one embodiment. FIG. 59 shows a rule condition selection 5900 with a name drop-down 5910 and condition drop-down rules, for example, equals 5920 and John 5930 of one embodiment.

### Portable Document Format Block Condition Mapping Fields Dynamic Mode Settings:

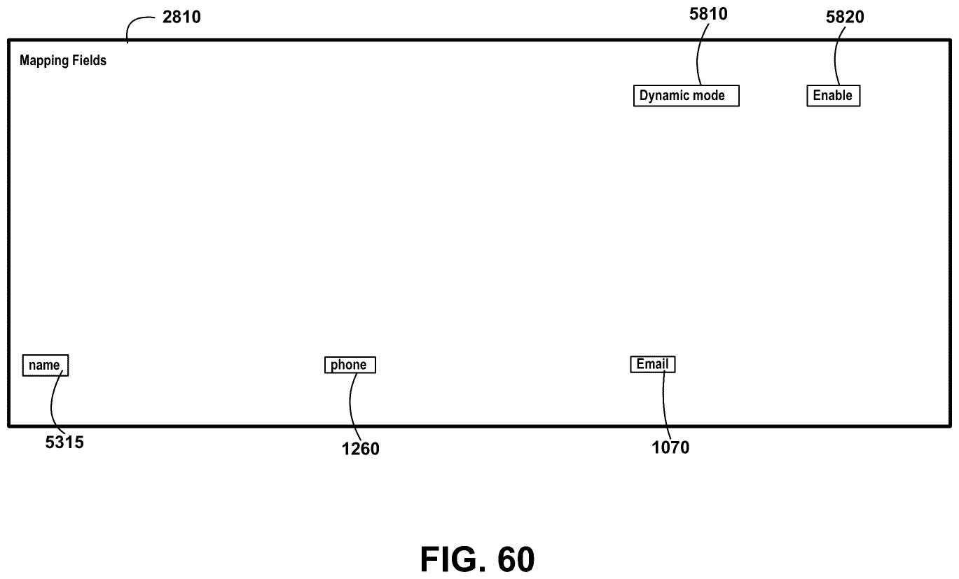

FIG. 60 shows for illustrative purposes only an example of portable document format block condition mapping field dynamic mode settings of one embodiment. FIG. 60 shows mapping fields 2810 with dynamic mode on 5810 and allow on 5820 where the greeting and salutation includes a name 5315, phone 1260, and email 1070 of one embodiment.

### A Sentiment Analysis Feature:

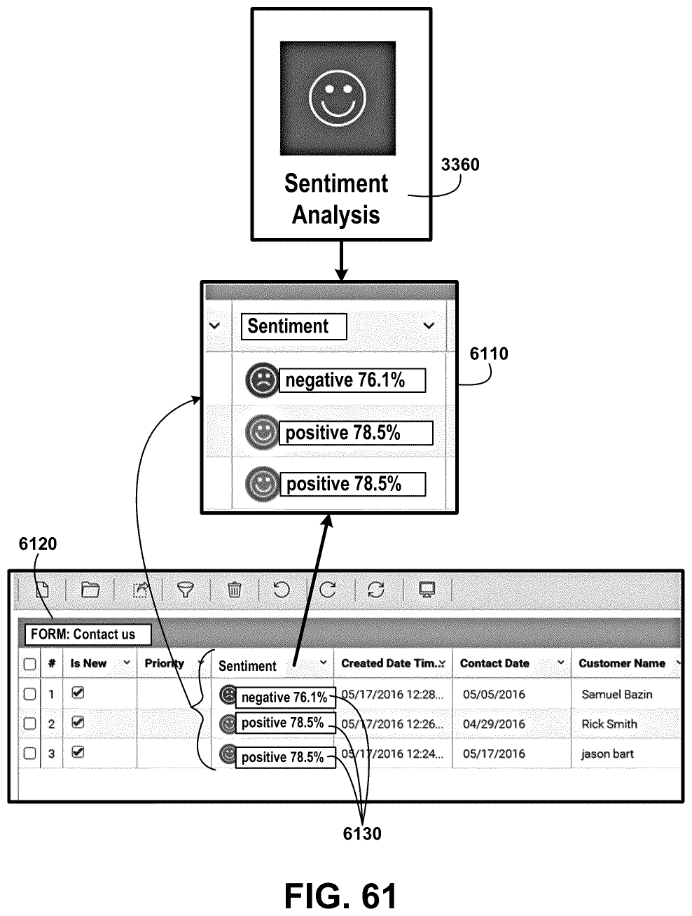

FIG. 61 shows for illustrative purposes only an example of a sentiment analysis feature of one embodiment. FIG. 61 shows a sentiment analysis 3360 feature with a sentiment enlarged view 6110 of results from a form: contact us 6120. The form: contact us 6120 results include sentiments expressed including negative 76.1%, positive 78.5%, and positive 78.5% 6130 of one embodiment.

The present invention launches the first Form Builder employing sentiment analysis for understanding textual responses. Focusing on conversion rate optimization (CRO), the present invention team realized that users need more than a tool to build good-looking forms, they want to improve conversion rates. So, they built an engine that goes over every newly created form, analyzes it, and provides a user with suggestions for changes that would improve conversion rates. If the form has open-ended text fields, the present invention can employ Sentiment Analysis algorithms to analyze the data. So, for example, it can highlight customers at risk and even use its built-in conditional logic to notify those in charge of customer retention or show a predefined message to such users.

### Heat Map Integration:

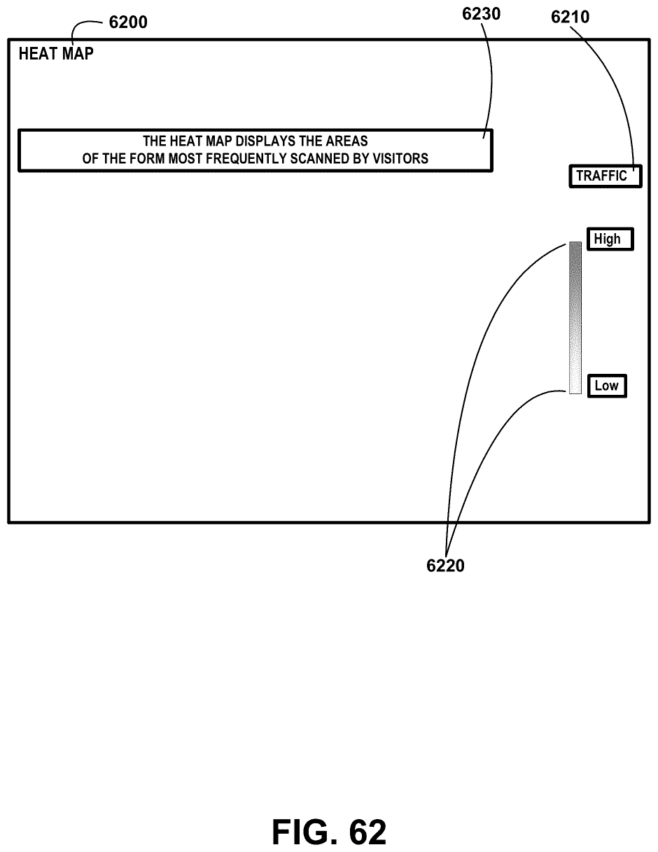

FIG. 62 shows for illustrative purposes only an example of heat map integration of one embodiment. FIG. 62 shows a heat map 6200 displayed. The heat map displays the areas of the form most frequently scanned by visitors 6230 to indicate traffic 6210 concentrations. A color scale showing a low to high heat level corresponding to the form area most frequently scanned by visitors in a graphic format 6220 of one embodiment.

One of the many optimization tools in the present invention is the Heatmap. This feature provides a user with a graphical representation of how user form visitors move along the form. It colors the more “active” parts of the form in warmer colors (yellow, orange, and red) and shows the areas where the users do not go through as much in cold colors (blue and green). The heatmap draws a type of map, where a user can see where form fillers spend more time. It helps a user understand which parts of a user form are the strongest and which are the weakest and places the elements in the user form accordingly.

Integrating a Form Platform into a Form Builder:

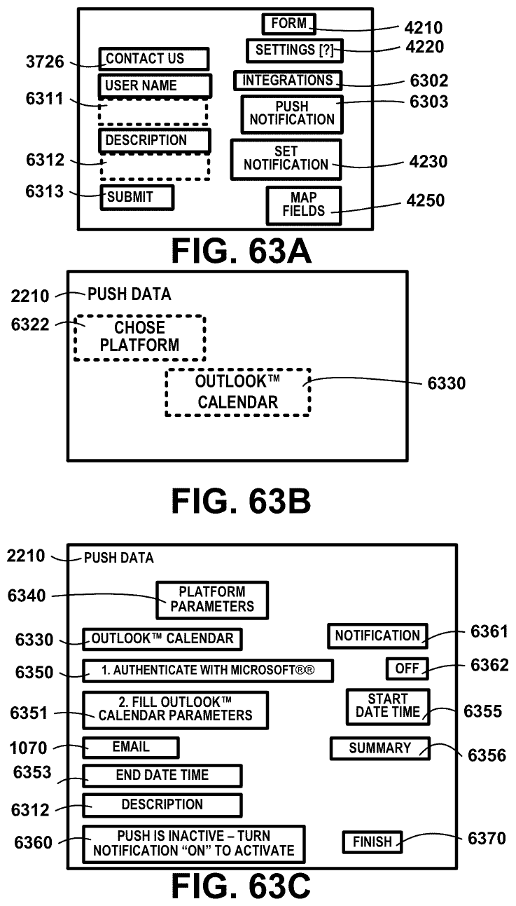

FIG. 63A shows for illustrative purposes only an example of integrating a form platform into a form builder of one embodiment. FIG. 63A shows the form 4210 settings 4220 for integrations 6302 including push notification 6303, set notification 4230, and map fields 4250. The map fields 4250 include contact us 3726, user name 6311, description 6312, and submit 6313 of one embodiment.

Form Builder can integrate multiple applications. These are a variety of calendars/schedulers that can be integrated into a responsive form using the present invention. A user can create a form to integrate with a calendar application that is responsive by manual entry and voice commands.

### Authenticate a Form Platform:

FIG. 63B shows for illustrative purposes only an example of authenticating a form platform of one embodiment. FIG. 63B shows using push data 2210 into a selection made using choose platform 6322, for example, an email client calendar 6330.

An event calendar feature is illustrated with a CRM Event Object. Integration with the CRM Event Object is an online web tool that allows a user to create online forms, landing pages, and CRM forms. The form builder can easily integrate with CRM event objects. Not only does this require no coding skills on a user's part, but the CRM connector is seamless and powerful. The CRM connector not only writes to a CRM event object, but it can also read from it and populate user online form fields instantly. Furthermore, a user can read from multiple objects at a time, with or without dependencies, and query objects based on any value from the user form. An Event Object represents an event in the calendar. In the user interface, event and task records are collectively referred to as activities. Usage Use Event to manage calendar appointments.

### Choosing Form Fields Data to Push to the Form Platform:

FIG. 63C shows for illustrative purposes only an example of choosing form fields data to push to form a platform of one embodiment. FIG. 63C shows push data 2210 for creating platform parameters 6340 in this example for Outlook™ Calendar 6330. One platform parameter is 1. Authenticate with Microsoft®®: authenticated 6350. Then the 2. fill Outlook™ Calendar parameters 6351 selections including email 1070, end datetime 6353, description 6312, start datetime 6355, summary 6356, and finish 6370. Displayed is a notification and instruction that the push is inactive—turn the notification “on” to activate 6360. A notification 6361 area shows a notification activation switch shown in an off 6362 position. A user will turn on the notification toggle and press on “Finish”. Once the form is configured to integrate with Outlook™ Calendar—a user will fill in a form and then a new appointment will be added to the user calendar based on the user's form push configuration of one embodiment.

### An Event Calendar Feature:

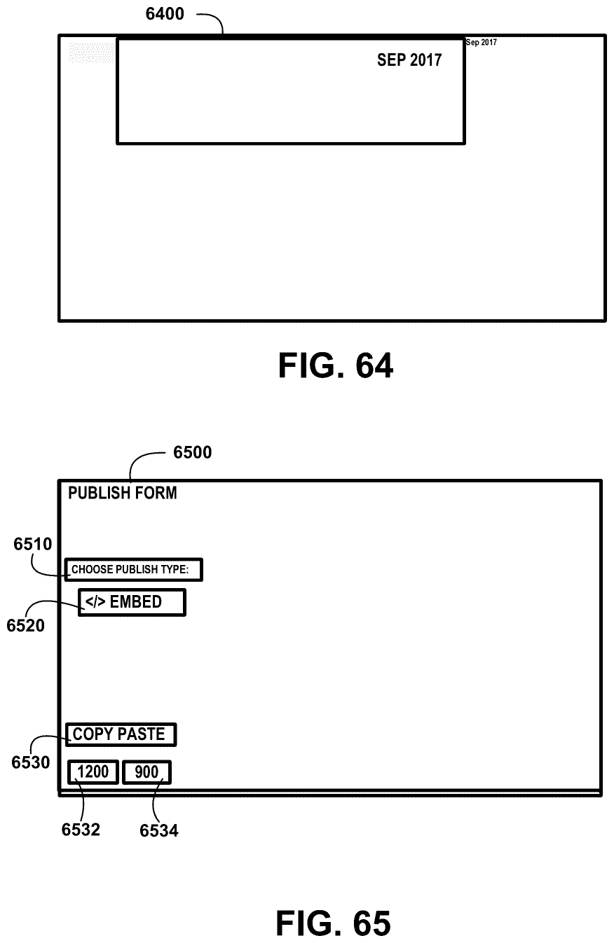

FIG. 64 shows for illustrative purposes only an example of an event calendar feature of one embodiment. FIG. 64 shows Outlook™ Calendar event listings 6400 of one embodiment.

### A Publish Form Feature:

FIG. 65 shows for illustrative purposes only an example of a publish form feature of one embodiment. FIG. 65 shows a publish form 6500 feature. A user can choose to publish type 6510 including </> embed 6520 and copy-paste 6530. The area for a publish form section includes user settings for width: for example, 1200 6532, and height: for example, 900 6534. Other publish features include the publish option: Android APK, and Supporting URL parameters in publish options: Embed, Lightbox, and Feedback of one embodiment.

### A Voice Interactive Calendar and Geolocator:

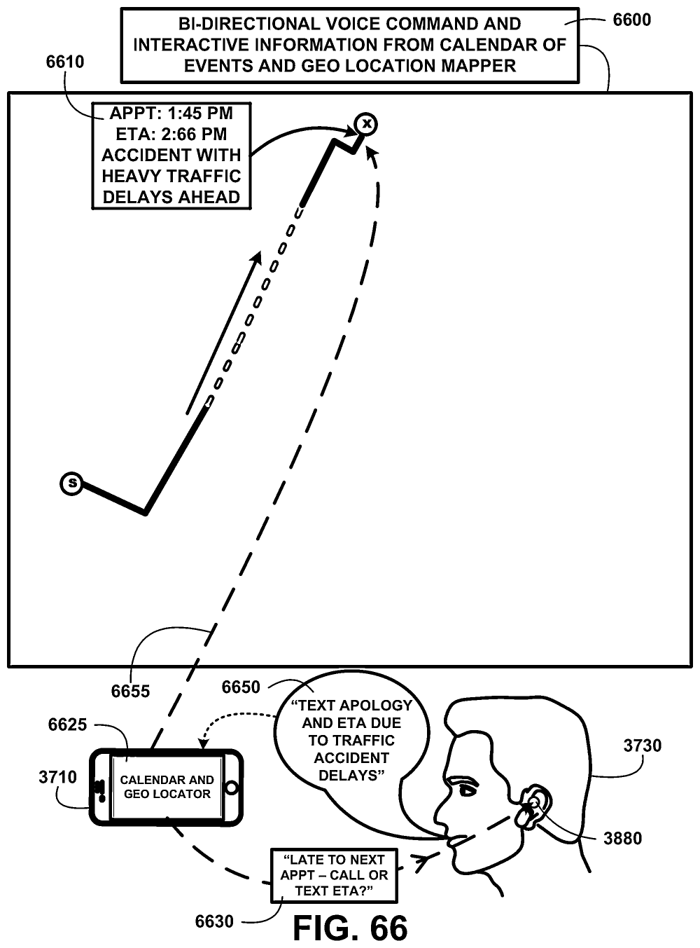

FIG. 66 shows for illustrative purposes only an example of a voice interactive calendar and geo locator of one embodiment. FIG. 66 shows bi-directional voice commands and interactive information from the calendar of events and geo location mapper 6600. The user smart smartphone 3710 with the application installed can display a mapper with information overlays including, for example, appt: 1:45 pm, ETA: 2:66 pm, accident with heavy traffic delays ahead 6610. A network digital processor can calculate the remaining distance to the user's next appointment and estimate arrival time based on projected travel speeds using current traffic conditions. The user's smartphone 3710 displays a calendar and geo locator 6625. The application transmits an audible message “Late to next appt—call or text ETA?” 6630 to the user 3730 who may be driving. The user using a hands-free earpiece hears the application's audible message 3880. The user instructs the application to “text apology and ETA due to traffic accident delays” 6650. The application sends a text to the next appointment location 6655 sending the user-instructed message of one embodiment.

The bi-directional voice command and interactive information from the calendar of events and geo location mapper can assist a user in making appointments. In this example, the voice element notifies the user while driving that his next Appt: 1:45 PM, ETA: 2:10 PM accident with heavy traffic delays ahead from the user's event calendar. On the screen, the geolocator shows where his next appointment is, and the traffic status acquired from local law enforcement notifications, and a calculated ETA based on the distance and reduced speeds.

### Crm Lookup:

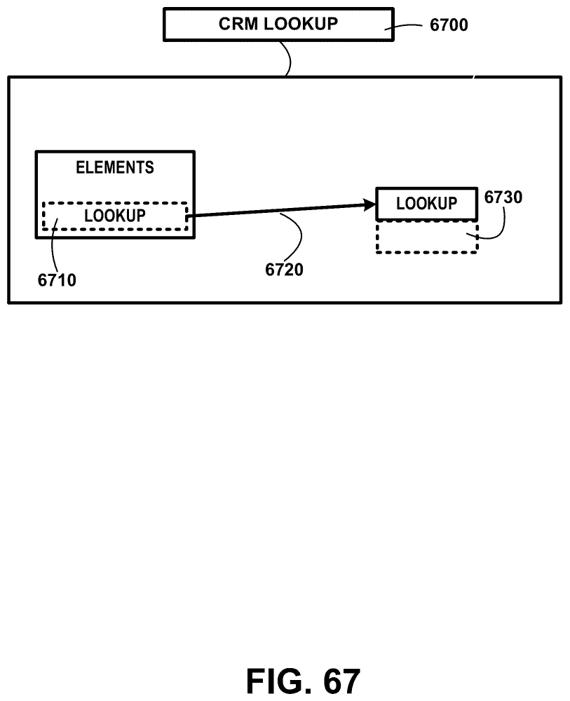

FIG. 67 shows for illustrative purposes only an example of CRM lookup of one embodiment. FIG. 67 shows a CRM lookup 6700 menu selection lookup 6710 the user can press which opens a lookup text box 6720. The user can enter the data into the lookup text box 6730. Another feature includes the Date and Date time format in the Table and the Lookup of one embodiment.

### Advanced Table:

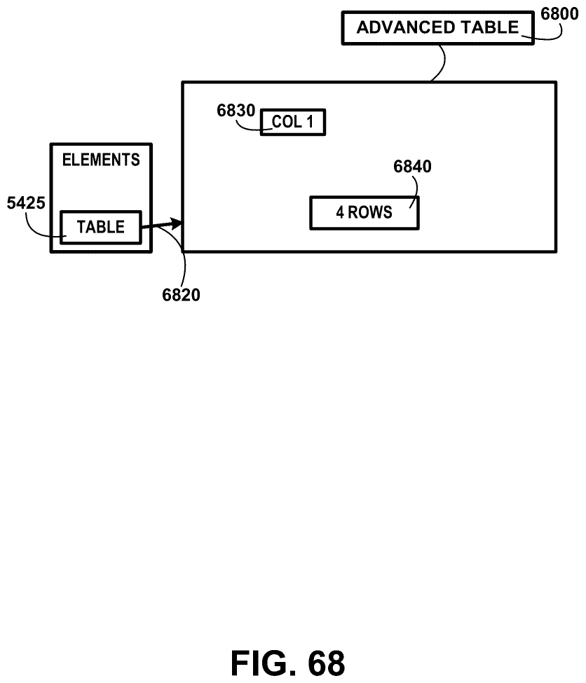

FIG. 68 shows for illustrative purposes only an example of an advanced table of one embodiment. FIG. 68 shows an advanced table 6800 feature to create a table 5425. A table selection opens a table formatting template 6820 for a user to select a column, for example, col 1 6830, and select several rows, for example, 4 rows 6840 of one embodiment.

CRM Table Working with CRM in an organized way. The CRM Table is an element a user can drag from the “Elements Panel” and use in the user form, but it may only be used for working with CRM. Since the present invention allows a Bi-Directional integration with CRM, a user can draw data from CRM to a user table and edit that data, so it is updated in the CRM object. A user can read & write using a table element.

Simple Table. Since CRM works with objects, the table element is built according to it. Once a user drags and drops the table element the user will set its columns and then configure the CRM “Get” integration to populate them. This is the basic use of the table.

Advanced Table. The form builder allows a user to create more complex scenarios. A user can make the table hierarchical, drawing data with parent-child relationships and writing to different objects simultaneously.

Simple Table. When using the Table element to create CRM forms, a user can use the simple table or the advanced table. The “simple table” refers to the most basic table a user can create for working with SF. It is not hierarchical—It has a single level, with which a user can only “Read” data from SF, and a user can do so from only one CRM object. To configure a simple table all a user will need is to change the table's “Basic” settings and set the “Get” integration. The “Advanced table”, in comparison, is more powerful. It refers to a hierarchical table that allows a user to work with multiple CRM objects and allows a user to “Read” from CRM objects as well as “write” to CRM objects.

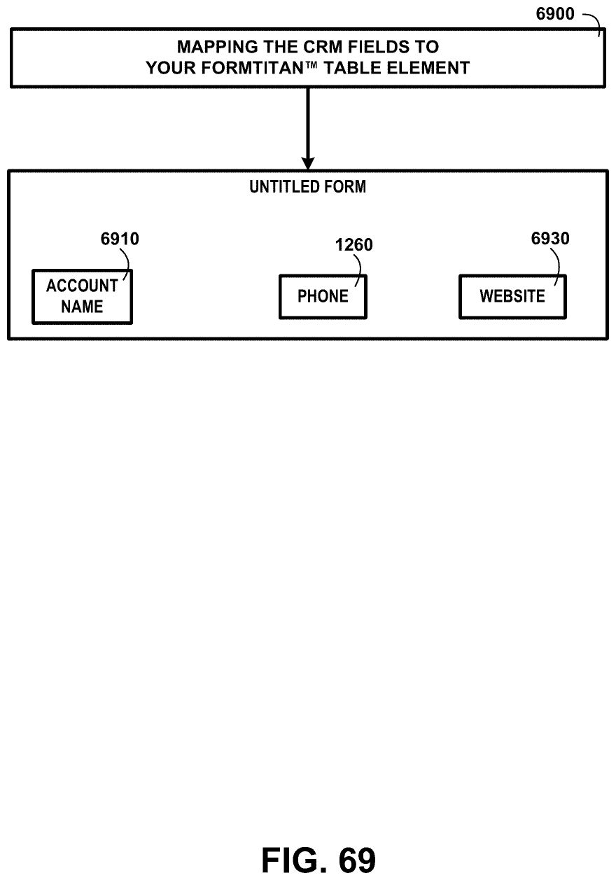

FIG. 69 shows for illustrative purposes only an example of mapping the CRM fields to a user table element of one embodiment. FIG. 69 shows mapping the CRM fields to a user table element 6900. The user can use an untitled form to select an account name 6910, phone 1260, and website 6930. FIG. 69 shows below a corresponding reference list of accounts matching the selected account name 6910, phone 1260, and website 6930 of one embodiment.

Populating user CRM data into a Table with a hierarchy. Mapping the CRM fields to a user hierarchical Table element. The present invention makes it possible to populate the CRM data in a table element. The Table element can be made hierarchical by adding additional levels to it. A grid is initially displayed to a user and shows the results of the first level, for example: account details. The user can then decide to focus on a certain row in the grid and drill down to view the second level (by pressing on an arrow link of the relevant row). For example: The user is shown a list of accounts.

### Adding the Smart V to a User Form:

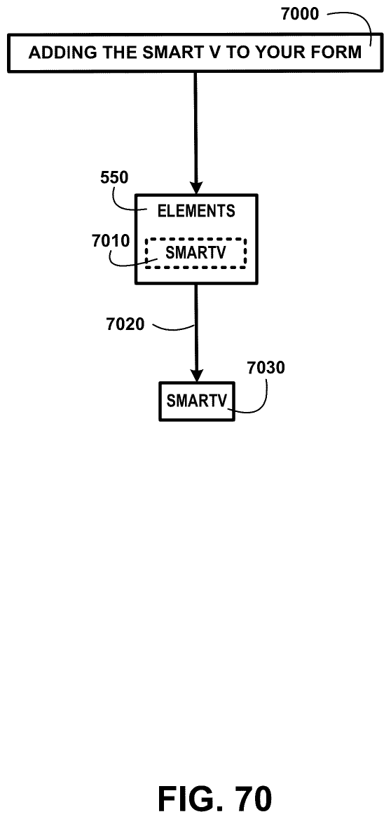

FIG. 70 shows for illustrative purposes only an example of adding the Smart V to a user form of one embodiment. FIG. 70 shows adding the Smart V to a user form 7000. Under element 550 the user can select Smart V 7010. Selecting the Smart V button opens a Smart V text box 7020. The user makes an entry into the Smart V text box 7030. Other features for Smart V include a Registration link in Smart V, Smart V customizations, Smart V logout, Smart V session configurations, Smart V supports special characters, Changing the Smart V window background color, and Date field format in Smart V of one embodiment.

Smart Validation—provides additional security for a user form. SmartV (short for Smart Validation) is a special element that adds a double verification to a user form based on data from CRM. It is two-factor authentication. When a user selects SmartV, a Login window will be created based on the fields chosen. A form filler will not be able to access the user's form. Access will only be granted after 2 steps. First step, the authentication window will appear, and the form fillers will need to identify themselves, by filling in the required data. If this data they provide is found comparable with the data in the user CRM account, an email will be sent to them, containing a secret code.

Second step. In the second step, the form fillers will need to enter the code in the authentication window. Once all data is confirmed—the form will be accessible. Smart V Session Configurations. Shared session—allows a user to set up the Smart V configuration in one form, and then share this configuration with other forms. Allowed Session—allows a user to set a time frame (in minutes) for the Smart V session. Captions—allows a user to customize the text in the verification window. Email Settings—allows a user to customize the email containing the secret code.

### Push the Data to CRM Using a Custom Button:

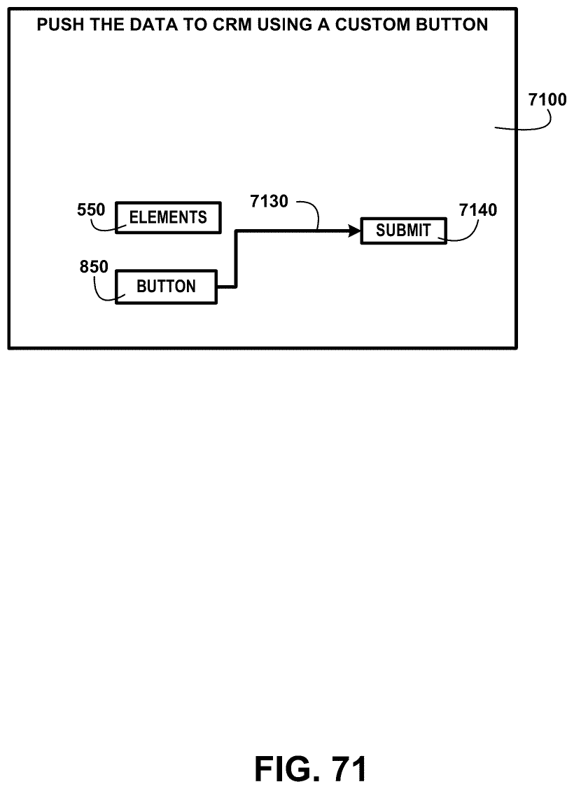

FIG. 71 shows for illustrative purposes only an example of push the data to CRM using a custom button of one embodiment. FIG. 71 shows a feature to push the data to CRM using a custom button 7100. Under elements 550 the user can select button 850 on the menu. The button selection opens an input box 7130. For example, the button selection can create a submit button 7140 for a form of one embodiment.

A CRM Action button can be used for Push functions. Push the data to CRM using a custom button, Custom CRM buttons are buttons designed especially for working with CRM. The Custom CRM buttons are in the “Elements panel” under the “CRM” category and the purpose is to allow users to push the data to CRM without having to submit the form.

### Set CRM Action for Custom Button:

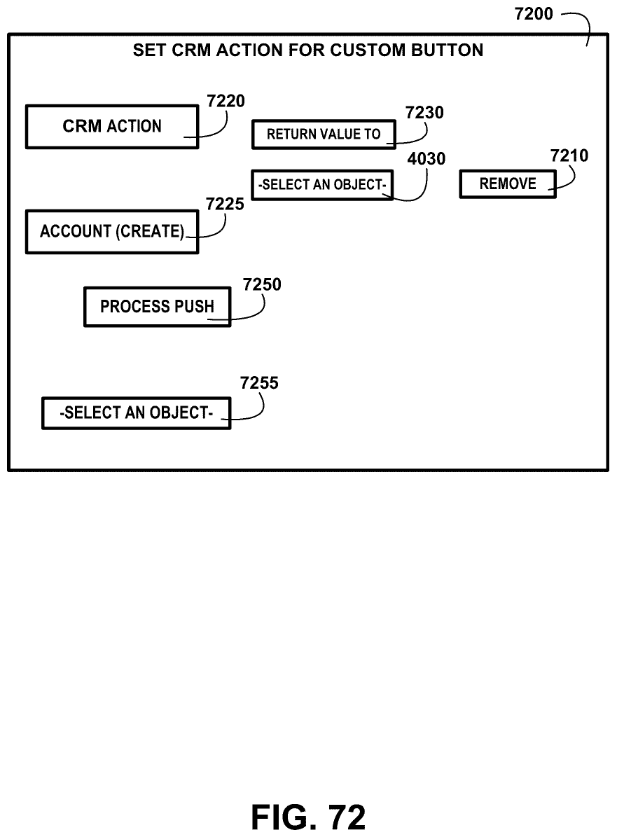

FIG. 72 shows for illustrative purposes only an example of a set CRM action for the custom button of one embodiment. FIG. 72 shows the user can set CRM action for custom button 7200. A set CRM action for the button on the web page shows a CRM action 7220 where a user can select including account (create) 7225, remove 7210, return value to 7230, select an object 4030, process push 7250 and select an object 7255 of one embodiment.

A CRM action button can easily be added to a user form to get/push data at once, without having to submit the form. However, when setting the button to act on a repeated section it applies to all of the data in all of the repeated lines.

Voice recognition can be added to the bi-directional voice command and interactive form building. Recognizing the user's voice when employing the voice element of the form builder feature of the customized customer relationship management platform provides an additional level of security. If a voice analyzer of the customized customer relationship management platform does not match the current voice being received to the voice analysis of the authorized user, then it closes the form builder and proceeds to another security check.

Iris recognition can be added to the customized customer relationship management platform security features. The user for example can use the camera of a smartphone for capturing the user's iris image. The captured iris image is processed against the authorized user iris image stored by the customized customer relationship management platform security features. A positive match processes the request to the form builder, if not no access is provided.

The iris recognition must be passed positively to allow a user to use eye movements to navigate the form using eye commands to create the form and/or fill in the form. The eye commands can move, for example, a textbox element on the form to a user's desired position. The eye command can be used to select a form input element and the voice command to make the input audibly when filling out the form.

Human gestures, like hand movements, can be tracked using a proximity sensor, accelerometer, and gyroscope to, for example, change form pages, zoom in and out, change the form builder feature for the next operation, and other user-desired operations.

Computer vision and video recognition of facial expressions can be captured, for example, using a smartphone camera. The captured facial expressions can be incorporated into the sentiment analysis feature and used separately for navigating a form or feature selection. A raised eyebrow can, for example, be given an operation selection by the user which is stored and can then be used by the user to, for example, visually focus on the submit button then raise an eyebrow to activate a click to submit the form.

A user who has created several forms using the form builder and activates a machine learning feature. The machine learning feature can analyze for each type of form the common elements selected and placement position in the form. The user can then automate an initial form creation to include in the chosen position those common elements. This saves time for the user and reduces the duplication of effort to arrive at the same or similar form layout.

The customized customer relationship management platform application can configure for example a smartphone accelerometer for motion sensing the phone position for example portrait or landscape to activate the mini mode display sizing conversion to fit the phone positioning. The accelerometer may also be used for adjusting augmented reality apps, for example, in a help situation where a user is chatting with an associate and an augmented reality app is allowing the associate to follow the user's selections, positioning of an element and other movements in real-time directly to better assist the user in understanding where they may have been incorrectly using the form builder feature. The accelerometer is also used to measure a user's driving speed to estimate an ETA to a meeting site as described in FIG. 66.

The accelerometer may also be used to activate features. For example, the user can select a smartphone's physical movement, a quick side-to-side shaking movement to activate a publish form feature. The user, for example, could select a top to bottom shaking movement to activate a form submit button.

A magnetometer, for example, in a smartphone senses where a phone is in physical space. It is used in mapping a user's location and travel. The magnetometer is used with an accelerometer and GPS unit to determine where a user is located.

A smartphone digital barometer coupled with a meteorological app can alert a user during travels that may encounter inclement weather changes. This could cause delays in the meeting scheduled. Gathering barometric data on a remote user's location may also explain a remote user's difficulties in a clear connection using the customized customer relationship management platform application as there may be for example lighting storms in the area that are disrupting internet, cellular, or WI-FI communications.

Biometrics can be integrated into the customized customer relationship management platform application to use sensors to provide levels of enhanced security by capturing and validating human-related metrics including Fingerprint recognition, IRIS (eye) scanning, and full facial recognition. Additionally, biometric sensors can be used to collect a user's heart rate and SpO2 (the estimate of arterial oxygen saturation) for use within a vendor's health application form and in sentiment analysis.

Cognitive services can be integrated with the customized customer relationship management platform and application. Cognitive services can include for example Vision-Image-processing algorithms to smartly identify, caption, and moderate user and other pictures; Speech-Convert spoken audio into text, use voice for verification, or add speaker recognition to a user's app; Knowledge-Map complex information and data to solve tasks such as intelligent recommendations and semantic search; Search-Add Bing Search APIs to user apps and harness the ability to comb billions of webpages, images, videos, and news with a single API call; and Language-Allow user apps to process natural language with pre-built scripts, evaluate sentiment and learn how to recognize what users want.

Because the Cognitive Services APIs harness the power of machine learning and bring advanced intelligence into the products without the need to have a team of data scientists on hand. Enhance security with a face. Use the Face API to verify a selfie for smart authentication. Signing in with visual identity verification is becoming an additional security layer for many industries. Microsoft®®'s Face API can compare portraits giving it amazing flexibility in uncontrolled scenarios. Express dramatic moments in an instant. Quickly retrieve surprised, happy, or sad celebrity images out of millions by combining multiple APIs. Search through video frames to pull out the perfect moment for user content. Never let an abundance of untagged footage be a deterrent to a user's ability to serve up contextual content when the user needs it. Engage customers through chat. Bring together cognitive service APIs and Bot frameworks to engage a user audience on a whole new level. Build a bot that embodies a user brand, addresses a user's customers' main questions, and escalates to a human operator if needed.

Allow great voice interactions with speech customization. With the custom speech service, a user can build great voice interactions between user systems and users. Enhance speech recognition using background noise reduction and complex technical word training. Emotion preview with the Emotion API takes a facial expression in an image as an input and returns the confidence across a set of emotions for each face in the image, as well as a bounding box for the face, using the Face API. The computer vision feature returns information about visual content found in an image. Use tagging, descriptions, and domain-specific models to identify content and label it with confidence.

Language understanding preview-language understanding provides simple tools that allow a user to build a user's language models, which allow any application or bot to understand user commands and act accordingly. Speaker recognition of who is speaking. Input audio of the unknown speaker is paired against a group of selected speakers, and in this case, there is a match found, the speaker's identity is returned. Cognitive services employ Artificial Intelligence (AI) and can include integrating 3rd party applications including for example Microsoft®® AI Platform Services that compose intelligent applications, customized to a user's organization's availability, security, and compliance requirements. Infrastructure Services and tools backed by best-of-breed infrastructure enterprise-grade security, availability, compliance, and manageability. Tools can include, for example, leveraging a set of comprehensive tools and frameworks to build, deploy, and operationalize AI products and services at scale.

Integrating 3^{rd} party applications can include cloud computing including Azure® cloud platform, Azure® securityRely on a trusted cloud security foundation, Azure® global infrastructure Achieve global reach and support local compliance, Featured Explore, Virtual MachinesProvision Windows and Linux virtual machines in seconds, Windows Virtual DesktopDeliver a virtual desktop experience to any device at cloud scale, Azure® SQL Database Managed relational SQL Database as a service, App ServiceQuickly create powerful cloud apps for web and mobile, Azure® Cosmos DBGlobally distributed, multi-model database for any scale, Machine LearningOpen and elastic AI development spanning the cloud and the edge, Azure® Kubernetes Service (AKS) Simplify the deployment, management, and operations of Kubernetes, FunctionsProcess events with serverless code, Cognitive ServicesAdd smart API capabilities to allow contextual interactions, and Blockchain WorkbenchConnect a user's blockchain to the cloud without the heavy lifting.

Integrating 3^{rd} party applications can include applications using artificial intelligence capabilities including Cognitive ServicesAdd smart API capabilities to allow contextual interactions, Azure® Bot ServiceIntelligent, serverless bot service that scales on demand, Azure® DatabricksFast, easy, and collaborative Apache Spark-based analytics platform, Machine LearningOpen and elastic AI development spanning the cloud and the edge, Cognitive Services—Search APIsHarness the ability to comb billions of webpages, images, videos, and news with a single API call, Cognitive Services—Language APIsProcess natural language with pre-built scripts, evaluate sentiment, and learn to recognize intent, Cognitive Services—Vision APIsUse Image-processing algorithms to smartly identify, caption and moderate user pictures, Cognitive Services—Speech APIsConvert speech to text or text to speech, translate text or audio, or add speaker recognition to a user app, and Cognitive Services—Knowledge APIsMap information and data in order to solve complex tasks.

Integrating 3^{rd} party applications can include Analytics Gather, store, process, analyze, and visualize data of any variety, volume, or velocity, SQL Data WarehouseElastic data warehouse as a service with enterprise-class features, Azure® DatabricksFast, easy, and collaborative Apache Spark-based analytics platform, HDInsightProvision cloud Hadoop, Spark, R Server, HBase, and Storm clusters, Data FactoryHybrid data integration at enterprise scale, made easy, Machine Learning Open and elastic AI development spanning the cloud and the edge, Stream Analytics Real-time data stream processing from millions of IoT devices, Data Lake Analytics Distributed analytics service that makes big data easy, Azure® Analysis ServicesEnterprise-grade analytics engine as a service, and Event HubsReceive telemetry from millions of devices.

Integrating 3^{rd} party applications can include Compute Access cloud compute capacity and scale on demand—and only pay for the resources users use, Virtual MachinesProvision Windows and Linux virtual machines in seconds, Virtual Machine Scale SetsManage and scale up to thousands of Linux and Windows virtual machines, Azure® Kubernetes Service (AKS) Simplify the deployment, management, and operations of Kubernetes, FunctionsProcess events with serverless code, Service FabricDevelop microservices and orchestrate containers on Windows or Linux, App ServiceQuickly create powerful cloud apps for web and mobile, Container InstancesEasily run containers on Azure® without managing servers, BatchCloud-scale job scheduling and compute management, and Azure® Batch AlEasily experiment and train user deep learning and AI models in parallel at scale.

Integrating 3^{rd} party applications can include Containers Develop and manage user containerized applications faster with integrated tools, Azure® Kubernetes Service (AKS) Simplify the deployment, management, and operations of Kubernetes, Container InstancesEasily run containers on Azure® without managing servers, Service FabricDevelop microservices and orchestrate containers on Windows or Linux, Container Registry Store and manage container images across all types of Azure® deployments, App ServiceQuickly create powerful cloud apps for web and mobile, Web App for ContainersEasily deploy and run containerized web apps that scale with a user business, and BatchCloud-scale job scheduling and compute management.

Integrating 3^{rd} party applications can include Databases Support rapid growth and innovate faster with secure, enterprise-grade, and fully managed database services, Azure® Cosmos DBGlobally distributed, multi-model database for any scale, Azure® SQL DatabaseManaged relational SQL Database as a service, Azure® Database for My SQLManaged My SQL® database service for app developers, Azure® Database for PostgreSQLManaged PostgreSQL® database service for app developers, Azure® Database for MariaDBManaged MariaDB database service for app developers, SQL Server on Virtual MachinesHost enterprise SQL Server apps in the cloud, SQL Data WarehouseElastic data warehouse as a service with enterprise-class features, Azure® Database Migration ServiceSimplify on-premises database migration to the cloud, and Redis® CachePower applications with high-throughput, low-latency data access.

Integrating 3^{rd} party applications can include Developer Tools Developer Tools Build, manage, and continuously deliver cloud applications—using any platform or language, Visual Studio®, the powerful and flexible environment for developing applications in the cloud, Visual Studio CodeA powerful, lightweight code editor for cloud development, SDKsGet the SDKs and command-line tools a user needs, Azure® DevOpsServices for teams to share code, track work, and ship software, CLIsBuild, deploy, diagnose, and manage multi-platform, scalable apps and services, Azure® PipelinesContinuously build, test, and deploy to any platform and cloud, Azure® Lab ServicesSet up labs for classrooms, trials, development and testing, and other scenarios, Azure® DevTest LabsQuickly create environments using reusable templates and artifacts, and Developer tool integrationsUse the development tools a user can know—including Eclipse, IntelliJ, and Maven—with Azure®.

Integrating 3^{rd} party applications can include DevOps Deliver innovation faster with simple, reliable tools for continuous delivery, Azure® DevOpsServices for teams to share code, track work, and ship software, Azure® PipelinesContinuously build, test, and deploy to any platform and cloud, Azure® BoardsPlan, track, and discuss work across user teams, Azure® ReposGet unlimited, cloud-hosted private Git repos for a user project, Azure® ArtifactsCreate, host, and share packages with a user team, Azure® Test PlansTest and ship with confidence with a manual and exploratory testing toolkit, Azure® DevTest LabsQuickly create environments using reusable templates and artifacts, and DevOps tool integrationsUse user favorite DevOps tools with Azure®.

Integrating 3^{rd} party applications can include Identity Manage user identities and access to protect against advanced threats across devices, data, apps, and infrastructure, Azure® Active DirectorySynchronize on-premises directories and allow single sign-on, Azure® Active Directory B2CConsumer identity and access management in the cloud, Azure® Active Directory Domain ServicesJoin Azure® virtual machines to a domain without domain controllers, and Azure® Information ProtectionBetter protect user sensitive information—anytime, anywhere.

Integrating 3^{rd} party applications can include Integration Seamlessly integrating on-premises and cloud-based applications, data, and processes across a user enterprise, Logic AppsAutomate the access and use of data across clouds without writing code, Service BusConnect across private and public cloud environments, API ManagementPublish APIs to developers, partners, and employees securely and at scale, Event GridGet reliable event delivery at massive scale.

Integrating 3^{rd} party applications can include the Internet of Things Bringing IoT to any device and any platform, without changing a user infrastructure, IoT HubConnect™, monitor and managing billions of IoT assets, IoT EdgeExtend cloud intelligence and analytics to edge devices, IoT CentralExperience the simplicity of SaaS for IoT, with no cloud expertise required, IoT solution acceleratorsCreate fully customizable solutions with templates for common IoT scenarios, Azure® SphereSecurely connect MCU-powered devices from the silicon to the cloud, Time Series InsightsExplore and analyze time-series data from IoT devices, Azure® MapsSimple and secure location APIs provide geospatial context to data, FunctionsProcess events with serverless code, and Event GridGet reliable event delivery at massive scale.

Integrating 3^{rd} party applications can include Management and Governance Simplify, automate, and optimize the management and compliance of user cloud resources, Microsoft® Azure® portalBuild, manage, and monitor all Azure® products in a single, unified console, Cloud Shell Streamline Azure® administration with a browser-based shell, Azure® AdvisorYour personalized Azure® best practices recommendation engine, Azure® BackupSimple and reliable server backup to the cloud, Cost ManagementOptimize what a user spends on the cloud, while maximizing cloud potential, Azure® PolicyImplement corporate governance and standards at scale for Azure® resources, Azure® MonitorHighly granular and real-time monitoring data for any Azure® resource, Azure® Site RecoveryOrchestrate protection and recovery of private clouds, and SchedulerRun user jobs on simple or complex recurring schedules.

Integrating 3^{rd} party applications can include Media Deliver high-quality video content anywhere, any time, and on any device, Media ServicesEncode, store, and stream video and audio at scale, EncodingStudio grade encoding at cloud scale, Azure® Media PlayerA single layer for all user playback needs, Live and On-Demand StreamingDeliver content to virtually all devices with scale to meet business needs, Media AnalyticsUncover insights from video files with speech and vision services, Content ProtectionSecurely deliver content using AES, PlayReady, Widevine, and Fairplay, Video IndexerUnlock video insights.

Integrating 3^{rd} party applications can include Microsoft® Azure® Stack Microsoft® Azure® Stack. Microsoft® Azure® Stack is an extension of Azure®—bringing the agility and innovation of cloud computing to user on-premises environment and enabling the only hybrid cloud that allows a user to build and deploy hybrid applications anywhere.

Integrating 3^{rd} party applications can include Migration Simplify and accelerate user migration to the cloud, Azure® MigrateEasily discovers, assess, right-size, and migrate user on-premises VMs to Azure®, Azure® Site RecoveryOrchestrate protection and recovery of private clouds, Azure® Database Migration ServiceSimplify on-premises database migration to the cloud, Data BoxSecure, a ruggedized appliance for Azure® data transfer, and Cost ManagementOptimize what a user spends on the cloud while maximizing cloud potential.

Integrating 3^{rd} party applications can include Mobile Build and deploy cross-platform and native apps for any mobile device, Mobile AppsBuild and host the backend for any mobile app, Notification HubsSend push notifications to any platform from any back end, Visual Studio® App CenterShip apps faster by automating application lifecycles, XamarinCreate cloud-powered mobile apps faster, Azure® MapsSimple and secure location APIs provide geospatial context to data, and API AppsEasily build and consume Cloud APIs.

Integrating 3^{rd} party applications can include Networking Connect cloud and on-premises infrastructure and services to provide user customers and users the best possible experience, Virtual NetworkProvision private networks, optionally connect to on-premises datacenters, Load BalancerDeliver high availability and network performance to user applications, Application GatewayBuild secure, scalable, and highly available web front ends, VPN GatewayEstablish secure, cross-premises connectivity, DNS Hosting of a user DNS domain, Content Delivery NetworkEnsure secure, reliable content delivery with broad global reach, Azure® DDoS ProtectionProtect user applications from Distributed Denial of Service (DDoS) attacks, Traffic ManagerRoute incoming traffic for high performance and availability, and Azure® Front Door ServiceScalable, security-enhanced delivery point for global, microservice-based web applications.

Integrating 3^{rd} party applications can include enterprise protection from advanced threats across hybrid cloud workloads, security management and allow advanced threat protection across hybrid cloud workloads, control of keys and other secrets, security, scalable, and highly available web front ends, protection of sensitive information—anytime, anywhere, secure, cross-premises connectivity, on-premises directories and allow single sign-on, protection for applications from distributed denial of service (DDoS) attacks, and advanced threat protection, detection and investigation of advanced attacks on-premises and in the cloud.

Integrating 3^{rd} party applications can include massively scalable cloud storage application platforms for user data, apps, and workloads, object storage for unstructured data, rarely accessed data, storage for apps according to traffic, storage for standard SMB 3.0 protocol, secured disk options supporting virtual machines, scalable data lake storage, data transfer, and other storage resources.

Integrating 3^{rd} party applications can include applications to deploy, and scale powerful web applications quickly and efficiently, create and deploy mission-critical web apps at scale, publish APIs to developers, partners, and employees securely and at scale, secure content delivery, reliable content delivery with broad global reach, managed search-as-a-service, real-time web functionalities and other application. Integrating 3^{rd} party applications can include cognitive services with apps, websites, and bots with intelligent algorithms to see, hear, speak, understand, and interpret a user's needs through natural methods of communication.

### HL7 EHR Cross-Platform Application:

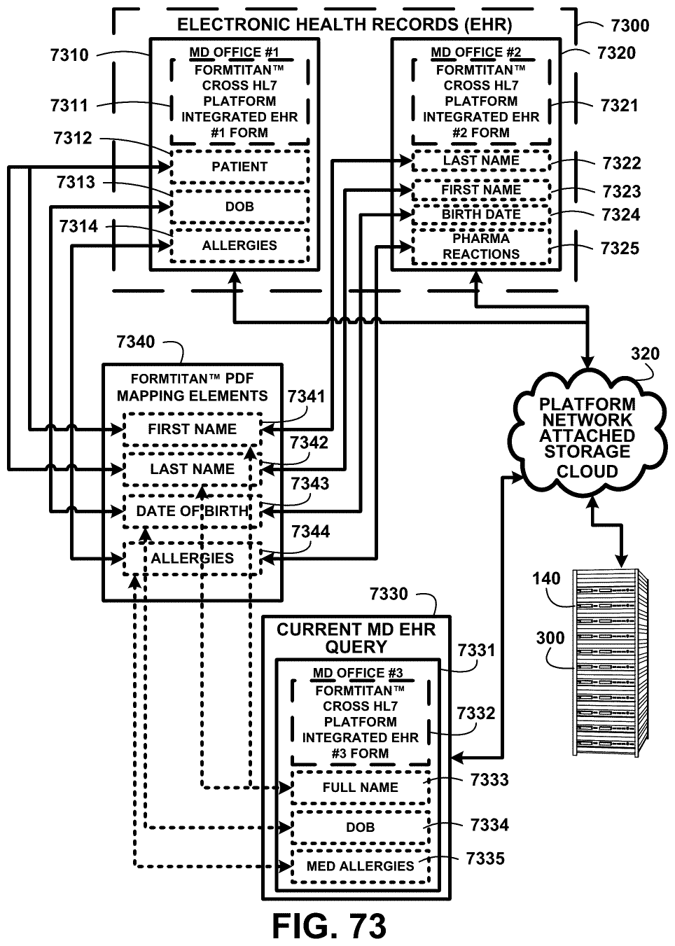

FIG. 73 shows for illustrative purposes only an example of an HL7 EHR cross-platform application of one embodiment. FIG. 73 shows the cross-platform integration 140 an application for HL7 electronic health records (EHR) using custom-created forms from three different medical offices. An MD office #1 7310 cross HL7 platform integrated EHR #1 form 7311 includes patient data, for example, patient 7312, DOB 7313, and allergies 7314. An MD office #2 7320 cross HL7 platform integrated EHR #2 form 7321 includes the same patient data however listed under different titles and in a different sequence, for example, last name 7322, first name 7323, birth date 7324 and pharma reactions 7325.

A current MD EHR query 7330 for the electronic health records for the same patient data is made by MD office #3 7331. MD office #3 7331 has created a cross-HL7 platform integrated EHR #3 form 7332. The cross HL7 platform integrated EHR #3 form 7332 from the MD office #3 7331 includes the same patient data however listed under different titles and in a different sequence, for example, full name 7333, DOB 7334, and medical allergies 7335. The current MD EHR query 7330 would normally not be able to automatically transfer the patient data to a non-form as the listing titles would not match. The MD office #3 staff would have to download the other forms and manually enter the patient data from the non-forms.

In this exampled instance since all of the forms were created using the current MD EHR query 7330 routed through the platform network attached storage cloud 320 and can use the customized customer relationship management platform network 300 network server to access the electronic health records (EHR) 7300. The customized customer relationship management platform network 300 network server can perform a search for the existing EHR forms records. The network server using the portable document format mapping elements 7340 used when the two existing cross HL7 platform integrated EHR #1 form 7311 and cross HL7 platform integrated EHR #2 form 7321 were created can determine the matching portable document format mapping elements 7340, for example, first name 7341, last name 7342, date of birth 7343 and allergies 7344. The data from the existing matching records can be assigned to the portable document format mapping elements 7340 used to create the cross-HL7 platform integrated EHR #3 form 7332.

The retrieval of matching EHR record data and automatic assignment and entry into corresponding portable document format mapping elements 7340 of a cross HL7 platform integrated EHR form saves time and potential typographic errors for a medical office. The EHR data can include other patient information including driver's license, address, SSN where applicable, other patient ID data, health insurance provider, and other information included in the patient EHR that the current MD needs to provide the patient with appropriate health care treatment of one embodiment.

Dropdown2 form settings element:

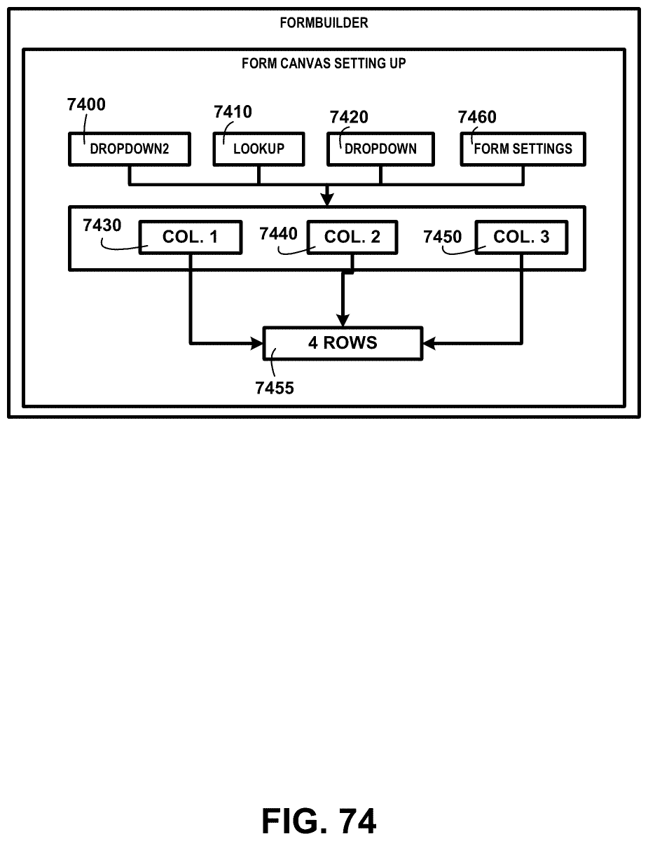

FIG. 74 shows for illustrative purposes only an example of a dropdown2 form settings element of one embodiment. FIG. 74 shows a form builder webpage for adding a Form settings 7460 that can include a DropDown2 7400 additional dropdown element. In this example, the DropDown2 7400 additional dropdown element includes a Lookup 7410 search element and a DropDown 7420 selection element. A form canvas is being set up to include Col. 1 7430, Col. 2 7440, Col. 3 7450, and with 4 rows 7455 of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed:

1. An online form builder platform operating on a remote computer server, comprising:
an online customizable graphical user interface coupled to the computer server having drag and drop visualization tools for a form builder user configured to create interactive components on a website for a website user, wherein the interactive components include at least one dynamic portable document format component, at least one automatic portable document format component, and at least one manual portable document format component;
a dynamic mapping tool coupled to at least one portable document format component having dynamic data fields, wherein the mapping tool is configured to allow the form builder user to create dynamically accessible data fields within at least one dynamic portable document format;
an automatic mapping tool coupled to at least one automatic portable document format component automatically having data fields, wherein the mapping tool is configured to allow the form builder user to create automatically accessible data fields within at least one automatic portable document format;
a manual mapping tool coupled to at least one manual portable document format component having data fields, wherein the mapping tool is configured to allow the form builder user to create manually accessible data fields within at least one manual portable document format;
a database integration module coupled to the remote computer server and a third-party cloud-based relational database configured to integrate bi-directional data to and from the dynamic, automatic, and manual data fields of the visualization tools and the dynamically accessible data fields of at least one portable document format component in real-time and based on conditional predetermined rules created by the form builder user;
a portable document format creator coupled to the mapping tool configured to create a final dynamic and manual portable document format based on input from the website user into the interactive components and the bi-directional data; and
wherein the automatic portable document format is further configured to automatically generate a final automatic portable document format representing a replicated HTML, version of the interactive form.

2. The online form builder platform operating on a remote computer server of claim 1, further comprising a customizable smart validation device configured to provide end users with at least one login for accessing information associated with data from the third-party customer relationship management platform as an alternative login to an administrative login of the third-party customer relationship management platform.

3. The online form builder platform operating on a remote computer server of claim 1, further comprising a push/pull feature configurable by the website user to automatically pull data from the third-party cloud-based relational database and enter it into predetermined data fields of the interactive components.

4. The online form builder platform operating on a remote computer server of claim 1, further comprising a push/pull feature configurable by the form builder user to automatically push data entered by the form builder user from at least one interactive website form to the third-party cloud-based relational database.

5. The online form builder platform operates on a remote computer server of claim 1, further comprising biometric form elements including a biometric recognition element configured to identify a form builder user.

6. The online form builder platform operating on a remote computer server of claim 1, wherein the dynamic mapping tool includes a converter to convert an image into a responsive customized portable document format template.

7. The online form builder platform operating on a remote computer server of claim 1, wherein the dynamic mapping tool includes interactive customized portable document format mapping elements to create an HTML, interactive customized portable document format form.

8. An online form builder platform operating on a remote computer server, comprising:
an online customizable graphical user interface coupled to the computer server having drag and drop visualization tools for a form builder user configured to create interactive components on a website for a website user, wherein the interactive components include at least one dynamic portable document format component, at least one automatic portable document format component, and at least one manual portable document format component;
a dynamic mapping tool coupled to at least one portable document format component having dynamic data fields, wherein the mapping tool is configured to allow the form builder user to create dynamically accessible data fields within the at least one dynamic portable document format;
an automatic mapping tool coupled to the at least one automatic portable document format component automatic having data fields, wherein the mapping tool is configured to allow the form builder user to create automatically accessible data fields within the at least one automatic portable document format;
a manual mapping tool coupled to the at least one manual portable document format component having data fields, wherein the mapping tool is configured to allow the form builder user to create manual accessible data fields within the at least one manual portable document format;
a database integration module coupled to the remote computer server and a third-party cloud-based relational database configured to integrate bi-directional data to and from the dynamic, automatic, and manual data fields of the visualization tools and the dynamically accessible data fields of the at least one portable document format component in real-time and based on conditional predetermined rules created by the form builder user;
a digital signatures component of the form builder configured to collect signatures to allow a user to collect user data using a responsive online form, and then have a portable document format document generated based on the signature entry, with the signature data in it;
a portable document format creator coupled to the mapping tool configured to create a final dynamic and manual portable document format based on input from the website user into the interactive components and the bi-directional data; and
wherein the automatic portable document format is further configured to automatically generate a final automatic portable document format representing a replicated HTML, version of the interactive form.

9. The online form builder platform operating on a remote computer server of claim 8, further comprising a customizable smart validation device configured to provide end users with at least one login for accessing information associated with data from the third-party customer relationship management platform as an alternative login to an administrative login of the third-party customer relationship management platform.

10. The online form builder platform operating on a remote computer server of claim 8, further comprising a push/pull feature configurable by the website user to automatically pull data from the third-party cloud-based relational database and enter it into predetermined data fields of the interactive components.

11. The online form builder platform operating on a remote computer server of claim 8, further comprising a push/pull feature configurable by the form builder user to automatically push data entered by the form builder user from at least one interactive website form to the third-party cloud-based relational database.

12. The online form builder platform operating on a remote computer server of claim 8, further comprising biometric form elements including a biometric recognition element configured to identify a form builder user.

13. The online form builder platform operating on a remote computer server of claim 8, wherein the dynamic mapping tool includes a converter to convert an image into a responsive customized portable document format template.

14. The online form builder platform operating on a remote computer server of claim 8, wherein the dynamic mapping tool includes interactive customize portable document format mapping elements to create an HTML, interactive customize portable document format form.

15. An online form builder platform operating on a remote computer server, comprising:
an online customizable graphical user interface coupled to the computer server having drag and drop visualization tools for a form builder user configured to create interactive components on a website for a website user, wherein the interactive components include at least one dynamic portable document format component, at least one automatic portable document format component, and at least one manual portable document format component;
a dynamic mapping tool coupled to the at least one portable document format component having dynamic data fields, wherein the mapping tool is configured to allow the form builder user to create dynamically accessible data fields within the at least one dynamic portable document format;
an automatic mapping tool coupled to the at least one automatic portable document format component automatic having data fields, wherein the mapping tool is configured to allow the form builder user to create automatically accessible data fields within the at least one automatic portable document format;
a manual mapping tool coupled to the at least one manual portable document format component having data fields, wherein the mapping tool is configured to allow the form builder user to create manual accessible data fields within the at least one manual portable document format;
a database integration module coupled to the remote computer server and a third-party cloud-based relational database configured to integrate bi-directional data to and from the dynamic, automatic, and manual data fields of the visualization tools and the dynamically accessible data fields of the at least one portable document format component in real-time and based on conditional predetermined rules created by the form builder user;
wherein the bi-directional form data includes application creation user and end-user controls for getting and pushing data between the third-party customer relationship management platform and the form before submission of the form;
a digital signatures component of the form builder configured to collect signatures to allow a user to collect user data using a responsive online form, and then have a portable document format document generated based on the signature entry, with the signature data in it;
an encryption feature wherein a user has a portable document format attached to the user emails encrypted, wherein the user selects a data field to be used as a password;
a portable document format creator coupled to the mapping tool configured to create a final dynamic and manual portable document format based on input from the website user into the interactive components and the bi-directional data; and
wherein the automatic portable document format is further configured to automatically generate a final automatic portable document format representing a replicated HTML, version of the interactive form.

16. The online form builder platform operating on a remote computer server of claim 15, further comprising an Iris recognition component of customized customer relationship management platform security features, wherein a website user uses a camera of a smartphone to capture the user iris image to store on the online form builder platform, wherein an iris image is processed against the authorized user iris image stored by the customized customer relationship management platform security features and a positive match processes the request to the form builder, if not no access is provided;

17. The online form builder platform operating on a remote computer server of claim 15, further comprising a customizable smart validation device configured to provide end users with at least one login for accessing information associated with data from the third-party customer relationship management platform as an alternative login to an administrative login of the third-party customer relationship management platform.

18. The online form builder platform operating on a remote computer server of claim 15, further comprising a push/pull feature configurable by the website user to automatically pull data from the third-party cloud-based relational database and enter it into predetermined data fields of the interactive components.

19. The online form builder platform operating on a remote computer server of claim 15, further comprising a push/pull feature configurable by the form builder user to automatically push data entered by the form builder user from at least one interactive website form to the third-party cloud-based relational database.

20. The online form builder platform operating on a remote computer server of claim 15, wherein the dynamic mapping tool includes a converter to convert an image into a responsive customized portable document format template.
